(19) United States
(12) Patent Application Publication
(10) Pub. No.: US 2008/0072288 A1
(43) Pub. Date: Mar. 20, 2008

(54) INFORMATION PROCESSING APPARATUS, TERMINAL APPARATUS, INFORMATION PROCESSING METHOD, INFORMATION PROCESSING PROGRAM, AND COMPUTER-READABLE INFORMATION RECORDING MEDIUM

(76) Inventor: Yohko OHTANI, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/938,094

(22) Filed: Nov. 9, 2007

Related U.S. Application Data
(62) Division of application No. 11/078,550, filed on Mar. 14, 2005.

(30) Foreign Application Priority Data
Mar. 16, 2004 (JP) 2004-074961
Mar. 19, 2004 (JP) 2004-081477

(51) Int. Cl. G06F 21/00

(52) U.S. Cl. 726/2

(57) ABSTRACT

An information processing apparatus acting as a client of a user managing server which manages user information as an item value of user information management items, includes a group setting page providing part providing a group setting page for setting a group in said information processing apparatus, which group is such that, whether or not a certain user belongs to the group is prescribed by whether or not user information of the user managed by said user information managing server satisfies a requirement concerning as to whether or not a predetermined item value is stored in the predetermined user information management items.

### CROSS-REFERENCE TO RELATED APPLICATIONS

This application is a divisional Application of, and claims the benefit of priority under 35 U.S.C. § 120 from, U.S. application Ser. No. 11/078,550, filed Mar. 14, 2005, which claims the benefit of priority under 35 U.S.C. § 119 from Japanese Patent Applications Nos. 2004-074961 and 2004-081477, filed on Mar. 16, 2004 and Mar. 19, 2004, respectively. The entire contents of each of the above applications are incorporated herein by reference.

### BACKGROUND OF THE INVENTION

### Field of the Invention

The present invention relates to an information processing apparatus, such as an information device having an information processing function as a main function, an electric device having an information processing function as an auxiliary function, or such; a terminal apparatus such as a personal computer; an information processing method, an information processing program and an information recording medium such as a CD-ROM. As a specific example of the information device having the information processing function as a main function, a personal computer may be cited. As a specific example of the electric device having the information processing function as an auxiliary function, an image forming apparatus such as a copier, a printer, a scanner, a facsimile machine, a composite machine, a fusion machine or such for which, recently, the information processing function is highly developed, may be cited.

Recently, a composite machine, a fusion machine or such acting as a copier, a printer, a scanner and a facsimile machine by a single machine has been available commercially. The composite machine or the fusion machine has hardware such as an image pick-up part, a printing part, a communication part, an operation and display part, and also, four types of software corresponding to the copying function, the printing function, the scanning function and the facsimile function, respectively. Then, as a result of switching thereamong, the machine functions as any of the copier, the printer, the scanner and the facsimile machine. When acting as the copier or the printer, the machine prints out an image on a printing paper sheet or such, while, when acting as the scanner or the facsimile machine, the machine reads an image from an original. When the composite machine or the fusion machine acts as the facsimile machine, it transmits or receives image information to or from another apparatus via a telephone line or such.

Japanese Laid-open Patent Application No. 2002-84383 discloses such an art.

### SUMMARY OF THE INVENTION

The composite machine or the fusion machine has a function for requiring ‘user information’. For example, when the machine acts as a facsimile machine, the user information such as a mail address, a facsimile telephone number or such is required. In the composite machine or the fusion machine, commonly, a function of managing the user information is provided with. However, if the machine has a function of obtaining the user information from a ‘user information managing server’ managing the user information, convenience can be further improved. As the user information managing server, an LDAP (lightweight directory access protocol) server may be cited.

In the LDAP, a person or an organization is treated as an ‘object’. Information of each particular object is stored in an entry therefor, and is managed. In the entry, ‘object class’ which is information concerning a type of the object; an ‘attribute’ which is information concerning a nature of the object or such is stored. The attribute includes ‘attribute type’ such as c (country); o (organization); ou (unit in the organization); cn (full name); sn (family name); givenName (first name); mail (electronic-mail address); facsimileTelephoneNumber (facsimile telephone number) or such, and an ‘attribute value’ such as c: Japan; o: Ricoh; ou: research and development section; cn; TARO SUZUKI; sn: SUZUKI; givenName: TARO or such. Since the entries are hierarchies by the object classes, an identification name (DN) of each entry is made of relative identification names (RDN) of the entry originating from one attribute (identification attribute) of the entry arranged according to the order of the layers of the hierarchy.

Various requests and responses are relatively exchanged between an LDAP client and an LDAP server. According to LDAP, authentication operation such as bind, unbind or such, query operation such as search, compare or such, updating operation such as add, delete, modify or such, are prepared. For example, when search operation is requested (search request) from the LDAP client to the LDAP server, a search result (search response) is returned to the LDAP client from the LDAP server in response.

Along with high development of the information processing function of the composite machine, fusion machine or image forming apparatus, the machine comes to have a function of carrying out authentication processing for a user, in many cases. Specific practical modes of the authentication processing may be classified into a ‘local authentication’ in which the composite machine, fusion machine or image forming apparatus itself carries out authentication processing for a user who uses the same machine; and an NT authentication or a LDAP authentication in which an authentication server such as an NT server or an LDAP server carries out authentication processing for a user who uses the composite machine, fusion machine of image forming apparatus.

When a single image forming apparatus has a function of carrying out these three types of authentication processing, i.e., local authentication, NT authentication and LDAP authentication, user authentication information of a user who uses this machine includes three types of authentication information, i.e., local authentication information, NT authentication information and LDAP authentication information. In this case, it is necessary to give relation among the three types of authentication information for a same user. That is, if no relation is given thereamong, the user information of the same user may be divided into three systems, i.e., information concerning local authentication information, information concerning NT authentication information, and information concerning LDAP authentication information. If so, accounting information of the same user is divided to different systems, usage limitation information of the same user is set separately in different systems or such, and thus, an inconvenient situation may occur. Therefore, a system of giving relation among a plurality of types of user authentication information of the same user is needed.

Thus, a first object of the present invention is to provide a system by which relation is given among a plurality of types of authentication information of a user who uses an information processing apparatus such as an image forming apparatus.

Further, along with high development of the information processing function of the composite machine, fusion machine or image forming apparatus, the machine comes to have a function of carrying out usage limitation processing for a user, in many cases. When the usage limitation processing is carried out, usage limitation may be set for ‘each user’. Specifically, usage of a function A is permitted for a user A while usage of a function B is permitted for a user B. However, in some case, setting of the usage limitation for ‘each group’ may be convenient in which, a group A is permitted to use a function A while a group B is permitted to use a function B. For this purpose, the composite machine, fusion machine or image forming apparatus should have a function of setting groups.

Thus, a second object of the present invention is to provide a system by which setting of groups of users or such who use an information processing apparatus such as the composite machine, fusion machine or image forming apparatus can be carried out.

According to a first aspect of the present invention, an information processing apparatus acting as a client of a user managing server which manages user information as an item value of a user information management item, includes: a group setting page providing part providing a group setting page for setting a group in the information processing apparatus, which group is such that, whether or not a user belongs to the group is determined by whether or not user information of the user managed by the user information managing server satisfies a requirement concerning as to whether or not a predetermined item value is stored in the predetermined user information management item of the user information of the user.

In this configuration, a group of users, user information of which is managed in the user managing server can be set in the information processing apparatus.

According to a second aspect of the present invention, the information processing apparatus according to the first aspect of the present invention may further include: an authentication setting page providing part providing an authentication setting page for making a setting in the information processing apparatus such that authentication of a user who uses the information processing apparatus should be made to be carried out by the user information managing server.

In this configuration, further, it is possible to make a setting in the information processing apparatus to cause the user managing server to carry out authentication of a user who uses the information processing apparatus.

According to a third aspect of the present invention, the information processing apparatus according to the first or the second aspect of the present invention may further include: a usage limitation setting page providing part providing a usage limitation setting page for making a user's usage limitation setting for each group in the information processing apparatus.

In this configuration, further, it is possible to make a setting of usage limitation of a user who users the information processing apparatus, in the information processing apparatus, for each group.

According to a fourth aspect of the present invention, in the information processing apparatus according to any one of the first through third aspects of the present invention, the group setting page providing part provides the group setting page such that the group defining requirement may be set by character inputting operation.

In this configuration, it is possible to carry out group defining requirement setting operation by character input operation.

According to a fifth aspect of the present invention, in the information processing apparatus according to any one of the first through third aspects of the present invention, the group setting page providing part provides the group setting page such that the group defining requirement may be set by operation of selecting from the user information management items and operation of selecting an item value thereof.

In this configuration, it is possible to carry out the requirement setting operation by user information management item selection operation and item value selection operation, and thus, it is possible to carry out the requirement setting easily.

According to a sixth aspect of the present invention, in the information processing apparatus according to any one of the first through third aspects of the present invention, the group setting page providing part provides the group setting page such that the requirement may be set by operation of selecting from the user information management items, operation of selecting an item value, and operation of selecting from among AND, OR and NOT.

In this configuration, it is possible to carry out the requirement setting operation by user information management item selection operation, item value selection operation and AND, OR or NOT selection operation, and thus, it is possible to carry out the requirement setting for the requirement including AND, OR or NOT, easily.

According to a seventh aspect of the present invention, in the information processing apparatus according to any one of the first through third aspects of the present invention, the group setting page providing part provides the group setting page such that the operation of the group may be carried out by operating of an icon which represents the group.

In this configuration, it is possible to apply an icon operating manner for icons representing the groups, and thus, it is possible to carry out group operation in a sensuously (in particular, visually) understandable manner.

According to an eighth aspect of the present invention, in the information processing apparatus according to any one of the first through seventh aspects of the present invention, in the group setting page, combining operation may be carried out in which a plurality of groups are combined into one group.

According to a ninth aspect of the present invention, in the information processing apparatus according to any one of the first through eighth aspects of the present invention, in the group setting page, dividing operation may be carried out in which one group is divided into a plurality of groups.

According to an tenth aspect of the present invention, in the information processing apparatus according to any one of the first through ninth aspects of the present invention, in the group setting page, reference operation may be carried out in which users belonging to the group are referred to.

According to an eleventh aspect of the present invention, in the information processing apparatus according to any one of the first through tenth aspects of the present invention ¥, in the group setting page, copy operation may be carried out in which the group is copied.

According to a twelfth aspect of the present invention, in the information processing apparatus according to any one of the first through eleventh aspects of the present invention, in the group setting page, deletion operation may be carried out in which the group is deleted.

According to a thirteenth aspect of the present invention, in the information processing apparatus according to any one of the first through twelfth aspects of the present invention, the group may be described by XML, and may be set in the information processing apparatus.

According to a fourteenth aspect of the present invention, in the information processing apparatus according to any one of the first through thirteenth aspects of the present invention, the user information managing server may be an LDAP server.

According to a fifteenth aspect of the present invention, the information processing apparatus according to any one of the first through fourteenth aspects of the present invention may be an image forming apparatus.

According to a sixteenth aspect of the present invention, an information processing method carried out by an information processing apparatus acting as a client of a user managing server which manages user information as an item value of a user information management item, includes: a group setting page providing step of providing a group setting page for setting a group in the information processing apparatus, which group is such that, whether or not a user belongs to the group is determined by whether or not user information of the user managed by the user information managing server satisfies a requirement concerning as to whether or not a predetermined item value is stored in the predetermined user information management item of the user information of the user.

In this configuration, it is possible to set a group of users, whose user information is managed in the user information managing server, in the information processing apparatus.

According to a seventeenth aspect of the present invention, the information processing method according to the sixteenth aspect of the present invention, may further include an authentication setting page providing step of providing an authentication setting page for making a setting in the information processing apparatus such that authentication of a user who uses the information processing apparatus is made to be carried out by the user information managing server.

In this configuration, it is possible to make a setting in the information processing apparatus to cause the user information managing server to carry out authentication of a user who uses the information processing apparatus.

According to an eighteenth aspect of the present invention, the information processing method according to any one of the sixteenth and seventeenth aspects of the present invention, may further include a usage limitation setting page providing step of providing a usage limitation setting page for making a user's usage limitation setting for each group, in the information processing apparatus.

In this configuration, it is possible to set, for each group, usage limitation of users who use the information processing apparatus, in the information processing apparatus.

According to a nineteenth aspect of the present invention, an information processing program including instructions to cause a computer to execute respective instructions of the information processing method according to any one of the sixteenth through eighteenth aspects of the present invention.

According to a twentieth aspect of the present invention, a computer readable information recording medium stores therein the information processing program according to the nineteenth aspect of the present invention.

Thus, according to the first through twentieth aspects of the present invention, it becomes possible to set groups of users or such who use the information processing apparatus.

According to a twenty-first aspect of the present invention, an information processing apparatus includes: a designating page providing part providing a designating page for designating a plurality of types of authentication information for a user using the information processing apparatus; and an entry creating part creating an entry in which the plurality of types of authentication information designated in the designating page are stored.

In this configuration, it is possible to give relation among the plurality of types of authentication information for the same user by creating an entry in which the plurality of types of authentication information for the same user are stored.

According to a twenty-second aspect of the present invention, an information processing apparatus includes: a designating page providing part providing a designating page for designating a plurality of entries in which authentication information for a user who uses the information processing apparatus is stored; and an entry creating part combining the plurality of entries designated in the designating page and creating an entry in which the plurality of authentication information for the user who uses the information processing apparatus are stored.

In this configuration, it is possible to give relation among the plurality of types of authentication information for the same user by creating an entry in which the plurality of types of authentication information for the same user are stored as a result of combining a plurality of entries in which the plurality of types of authentication information for the same user are stored, respectively.

According to a twenty-third aspect of the present invention, an information processing apparatus includes: a registration page providing part providing a registration page for registering a setting such as to automatically create an entry for storing therein a plurality of types of authentication information for a user who uses the information processing apparatus; and an entry creating part automatically creating the entry for storing therein the plurality of types of authentication information for the user who uses the information processing apparatus, based on the setting registered in the registration page.

In this configuration, it is possible to give relation among the plurality of types of authentication information for the same user by storing the plurality of types of authentication information for the same user in the automatically created entry provided for storing therein a plurality of types of authentication information for the same user

According to a twenty-fourth aspect of the present invention, in the information processing apparatus according to any one of the twenty-first through twenty-third aspects of the present invention, in the entry created by the entry creating part, accounting information of the user may be stored.

In this configuration, it is possible that management of accounting information of the same user is made to be carried out in the same entry.

According to a twenty-fifth aspect of the present invention, in the information processing apparatus according to the twenty-second aspect of the present invention, in the entry created by the entry creating part, as an accounting amount for the user, an amount obtained as a result of accounting amounts stored in the respective ones of the plurality of entries designated in the designating page being added together may be stored.

In this configuration, it is possible that the accounting amount obtained after the combining becomes a total of the accounting amounts of the respective entries before being combined.

According to a twenty-sixth aspect of the present invention, in the information processing apparatus according to any one of the twenty-first through twenty-third aspects of the present invention, in the entry created by the entry creating part, usage limitation information for the user may be stored.

In this configuration, it is possible that management of usage limitation information of the same user is made to be carried out in the same entry.

According to a twenty-seventh aspect of the present invention, in the information processing apparatus according to twenty-second aspect of the present invention, in the entry created by the entry creating part, as the usage limitation information for the user, one taking over from limitation information stored in at least one of the plurality of entries designated in the designating page may be stored.

In this configuration, it is possible that the usage limitation information obtained after the combining becomes one taking over from the usage limitation information before the combining.

According to a twenty-eighth aspect of the present invention, in the information processing apparatus according to any one of the twenty-first through twenty-third aspects of the present invention, in the entry created by them entry creating part, an authentication result for the user obtained as a result of authentication processing being carried out based on the authentication information may be stored.

According to a twenty-ninth aspect of the present invention, in the information processing apparatus according to the twenty-eighth aspect of the present invention, when execution of authentication processing for the user to be carried out based on the authentication information is not allowed, it may be determined whether or not the authentication of the user is passed, based on an authentication result of authentication processing having been carried out for the same user.

In this configuration, even when user authentication processing to be executed with the use of authentication information cannot be carried out due to device failure, network failure or such, user authentication can be made to be passed based on an authentication result of user authentication processing already executed with the same authentication information.

According to a thirtieth aspect of the present invention, in the information processing apparatus according to any one of the twenty-first through twenty-ninth aspects of the present invention, a configuration may be provided such that, when the user who uses the information processing apparatus logs-in in the apparatus, a specific one from among the plurality of types of authentication information stored in the entry concerning the user should be input to the information processing apparatus without regard to actually which one of the plurality of types of authentication information stored in the entry concerning the user is applied for authentication processing for the user.

In this configuration, since authentication information to be input to the information processing apparatus when a user who uses the information processing apparatus logs-in, is limited to a specific one, a management load of the user who uses the information processing apparatus for managing the authentication information can be effectively reduced.

According to a thirty-first aspect of the present invention, in the information processing apparatus according to any one of the twenty-first through thirtieth aspects of the present invention, in the entry created by the entry creating part, as the plurality of types of authentication information, at least authentication information applied when the information processing apparatus itself carries out authentication processing for the user and authentication information applied when the information processing apparatus causes a server to carry out authentication processing for the user may be stored.

According to a thirty-second aspect of the present invention, in the information processing apparatus according to any one of the twenty-first through thirtieth aspects of the present invention, in the entry created by the entry creating part, as the plurality of types of authentication information, at least authentication information applied when the information processing apparatus causes a first server to carry out authentication processing for the user and authentication information applied when the information processing apparatus causes a second server other than the first server to carry out authentication processing for the user may be stored.

According to a thirty-third aspect of the present invention, the information processing apparatus according to any one of the twenty-first through thirty-first aspects of the present invention may be an image forming apparatus.

According to a thirty-fourth aspect of the present invention, an information processing method includes: a designating page providing step of providing a designating page for designating a plurality of types of authentication information for a user using the information processing apparatus; and an entry creating part of creating an entry in which the plurality of types of authentication information designated in the designating page are stored.

In this configuration, it is possible to give relation among the plurality of types of authentication information for the same user by creating an entry in which a plurality of types of authentication information for the same user are stored.

According to a thirty-fifth aspect of the present invention, an information processing method includes: a designating page providing step of providing a designating page for designating a plurality of entries in each of which authentication information for a user who uses the information processing apparatus is stored; and an entry creating step of combining the plurality of entries designated in the designating page and creating an entry in which the plurality of types of authentication information for the user who uses the information processing apparatus are stored.

In this configuration, it is possible to give relation among the plurality of types of authentication information for the same user by creating an entry in which a plurality of types of authentication information for the same user are stored as a result of combining a plurality of entries in which the plurality of types of authentication information for the same user are stored, respectively.

According to a thirty-sixth aspect of the present invention, an information processing method includes: a registration page providing step of providing a registration page for registering a setting such as to automatically create an entry for storing therein a plurality of types of authentication information for a user who uses the information processing apparatus; and an entry creating step of automatically creating the entry for storing therein the plurality of types of authentication information for the user who uses the information processing apparatus, based on the setting registered in the registration page.

In this configuration, it is possible to give relation among the plurality of types of authentication information for the same user by storing the plurality of types of authentication information for the same user in the automatically created entry provided for storing therein a plurality of types of authentication information for the same user

According to a thirty-seventh aspect of the present invention, in the information processing method according to any one of the thirty-fourth through thirty-sixth aspects of the present invention, when the user who uses the information processing apparatus logs-in in the apparatus, a specific one from among the plurality of types of authentication information stored in the entry concerning the user should be input to the information processing apparatus without regard to actually which one of the plurality of authentication information stored in the entry concerning the user may be applied for authentication processing for the user.

In this configuration, since authentication information to be input to the information processing apparatus when a user who uses the information processing apparatus logs-in, is limited to a specific one, a management load of the user who uses the information processing apparatus, for managing the authentication information can be effectively reduced.

According to a thirty-eighth aspect of the present invention, in the information processing method according to any one of the thirty-fourth through thirty-seventh aspects of the present invention, the information processing apparatus may be an image forming apparatus.

According to a thirty-ninth aspect of the present invention, an information processing program includes instructions causing a computer to carry out respective steps of the information processing method according to any one of the thirty-fourth through thirty-eighth aspects of the present invention,

According to a fourteenth aspect of the present invention, a computer readable information recording medium stores therein the information processing program according to the thirty-ninth aspect of the present invention.

According to a forty-first aspect of the present invention, a terminal apparatus acting as a terminal of an information processing apparatus includes: a designating page providing part providing a designating page for designating a plurality of types of authentication information for a user using the information processing apparatus, wherein: the terminal apparatus causes an entry to be created, in the information processing apparatus, in which entry the plurality of authentication information designated in the designating page are stored.

In this configuration, it is possible to give relation among the plurality of types of authentication information for the same user by creating an entry in which a plurality of types of authentication information for the same user are stored.

According to a forty-second aspect of the present invention, a terminal apparatus acting as a terminal of an information processing apparatus includes: a designating page providing part providing a designating page for designating a plurality of entries in each of which authentication information for a user who uses the information processing apparatus is stored, wherein: the terminal apparatus causes the plurality of entries designated in the designating page to be combined, and causes an entry to be created in the information processing apparatus, in which entry a plurality of authentication information for the same user who uses the information processing apparatus are stored.

In this configuration, it is possible to give relation among the plurality of types of authentication information for the same user by creating an entry in which the plurality of types of authentication information for the same user are stored as a result of combining the plurality of entries in which the plurality of types of authentication information for the same user are stored, respectively.

According to a forty-third aspect of the present invention, a terminal apparatus acting as a terminal of an information processing apparatus includes: a registration page providing part providing a registration page for registering a setting such as to automatically create an entry for storing therein a plurality of types of authentication information for a user who uses the information processing apparatus, wherein: the terminal apparatus causes the entry to be automatically created in the information processing apparatus, for storing therein the plurality of types of authentication information for the user who uses the information processing apparatus, based on the setting registered in the registration page.

In this configuration, it is possible to give relation among the plurality of types of authentication information for the same user by storing the plurality of types of authentication information for the same user in the automatically created entry provided for storing therein a plurality of types of authentication information for the same user

According to a forty-fourth aspect of the present invention, in the terminal apparatus according to any one of the forty-first through forty-third aspects of the present invention, the information processing apparatus may be an image forming apparatus.

According to a forty-fifth aspect of the present invention, an information processing method executed by a terminal apparatus acting as a terminal of an information processing apparatus, includes: a designating page providing step of providing a designating page for designating a plurality of types of authentication information for a user using the information processing apparatus, wherein: the terminal apparatus causes an entry to be created, in the information processing apparatus, in which entry the plurality of types of authentication information designated in the designating page are stored.

In this configuration, it is possible to give relation among the plurality of types of authentication information for the same user by creating an entry in which a plurality of types of authentication information for the same user are stored.

According to a forty-sixth aspect of the present invention, an information processing method executed by a terminal apparatus acting as terminal of an information processing apparatus, includes: a designating page providing step of providing a designating page for designating a plurality of entries in which authentication information for a user who uses the information processing apparatus, wherein: the terminal apparatus causes the plurality of entries designated in the designating page to be combined, and causes an entry to be created in the information processing apparatus, in which entry the plurality of authentication information for the user who uses the information processing apparatus are stored.

In this configuration, it is possible to give relation among a plurality of types of authentication information for the same user by creating an entry in which the plurality of types of authentication information for the same user as a result of combining a plurality of entries in which the plurality of types of authentication information for the same user are stored, respectively.

According to a forty-seventh aspect of the present invention, an information processing method executed by a terminal apparatus acting as a terminal of an information processing apparatus, includes: a registration page providing step of providing a registration page for registering a setting such as to automatically create an entry for storing therein a plurality of types of authentication information for a user who uses the information processing apparatus, wherein: the terminal apparatus causes the entry to be automatically created in the information processing apparatus, for storing therein the plurality of types of authentication information for the user who uses the information processing apparatus, based on the setting registered in the registration page.

In this configuration, it is possible to give relation among the plurality of types of authentication information for the same user by storing the plurality of types of authentication information for the same user in the automatically created entry provided for storing therein the plurality of types of authentication information for the same user.

According to a forty-eighth aspect of the present invention, in the information processing method according to any one of the forty-fifth through forty-seventh aspects of the present invention, the information processing apparatus may be an image forming apparatus.

According to a forty-ninth aspect of the present invention, an information processing program includes instructions for causing a computer to execute the respective steps of the information processing method according to any one of the forty-fifth through forty-eighth aspects of the present invention.

According to a fiftieth aspect of the present invention, a computer readable information recording medium stores therein the information processing program according to the forty-ninth aspect of the present invention.

Thus, according to the twenty-first through fiftieth aspects of the present invention, it is possible to give relation among a plurality of types of authentication information of a user who uses an information processing apparatus such as an image forming apparatus.

### BRIEF DESCRIPTION OF THE DRAWINGS

Other objects and further features of the present invention will become more apparent from the following detailed description when read in conjunction with the accompanying drawings:

FIG. 1 shows a fusion machine in any of first and second embodiments according to the present invention;

FIG. 2 shows a hardware configuration diagram of the fusion machine shown in FIG. 1;

FIG. 3 shows an outer appearance of the fusion machine shown in FIG. 1;

FIG. 4 shows an operation panel;

FIG. 5 shows an address book;

FIG. 6 shows a data structure of user information;

FIG. 7 shows a system configuration diagram illustrating user information obtaining processing;

FIG. 8 shows a sequence diagram illustrating user information obtaining processing;

FIG. 9 shows a page transition diagram illustrating user information registration/change operation;

FIG. 10 shows a page transition diagram illustrating user information obtaining processing;

FIG. 11 shows user information obtained from an LDAP server;

FIG. 12 shows a page transition diagram following the same shown in FIG. 10;

FIG. 13 shows a system configuration diagram of the fusion machine shown in FIG. 1;

FIG. 14 shows a functional block diagram of an SCS and a UCS of the fusion machine shown in FIG. 1;

FIG. 15 shows a page transition diagram concerning an authentication setting page;

FIG. 16 shows a page transition diagram concerning a usage limitation setting page;

FIG. 17 shows a page transition diagram concerning an group setting page;

FIG. 18 shows a page illustrating copy operation;

FIG. 19 shows a page illustrating delete operation;

FIG. 20 shows a page illustrating reference operation;

FIG. 21 shows a sequence diagram concerning display processing of the usage limitation setting page shown in FIG. 20;

FIG. 22 shows the group setting page;

FIG. 23 shows a page transition diagram concerning adding operation;

FIG. 24 shows a page transition diagram concerning relation operation;

FIG. 25 shows a page transition diagram concerning delete operation;

FIG. 26 shows a page transition diagram concerning move operation;

FIG. 27 shows a group hierarchy structure set in the group setting page shown in FIG. 22;

FIG. 28 shows XML data of groups set in the group setting page shown in FIG. 22;

FIG. 29 shows a flow chart of a requirement creating processing;

FIG. 30 illustrates combining processing and dividing processing;

FIG. 31 shows a sequence diagram of authentication processing and usage limitation processing;

FIG. 32 shows a flow chart of usage limitation information creating processing;

FIG. 33 shows a sequence diagram of processing for applying a group as a destination;

FIG. 34 shows an information processing apparatus;

FIG. 35 shows a system configuration diagram of a fusion machine in a second embodiment according to the twenty-first through fiftieth aspects of the present invention;

FIG. 36 shows an authentication setting page according to the present invention;

FIG. 37 shows a conceptual diagram of an entry provided for storing therein three types of authentication information;

FIG. 38 shows a conceptual diagram of an entry in which three types of authentication information will be stored;

FIG. 39 shows an entry creating page for creating the entry shown in FIG. 37;

FIG. 40 shows a sequence diagram of authentication processing (local authentication);

FIGS. 41 and 42 show a sequence diagrams of authentication processing (LDAP authentication);

FIG. 43 shows an entry creating page for creating the entry shown in FIG. 37;

FIGS. 44 and 45 show entry lists of the fusion machine;

FIG. 46 shows an entry creating page for creating the entry shown in FIG. 38;

FIG. 47 shows a sequence diagram of authentication processing (local authentication);

FIGS. 48 and 49 show sequence diagrams of authentication processing (LDAP authentication);

FIG. 50 shows a PC (personal computer) corresponding to an embodiment of the present invention;

FIG. 51 shows a PC body;

FIG. 52 shows an HDD; and

FIG. 53 shows a system configuration diagram of the fusion machine.

### DETAILED DESCRIPTION OF THE PREFERRED EMBODIMENTS

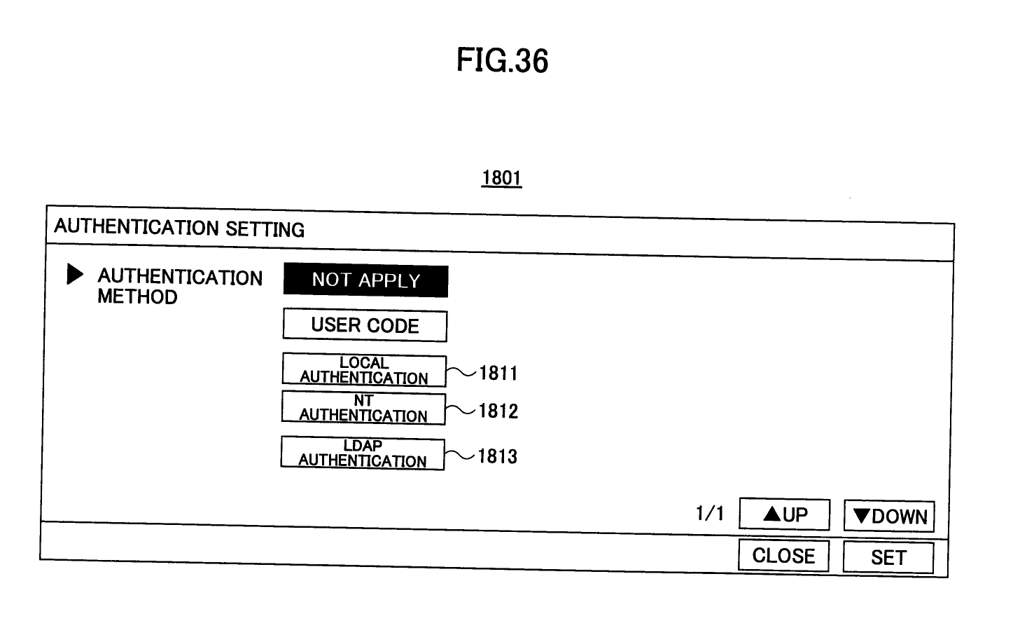

FIG. 34 shows an information processing apparatus 11 in one embodiment of the present invention. The information processing apparatus 11 shown includes a various types of hardware 21, various types of software 22 and a starting-up part 23.

The hardware 21 includes an information processing part such as a CPU, a ROM, a RAM, an HDD, and so forth; a communication part such as a MODEM, a NIC, and so forth; and an operation and display part such as a mouse, a display device and so forth.

The software 22 includes various applications 31 and various platforms 32. The platforms include a module carrying out control concerning the information processing part, a module carrying out an agent function concerning the communication part, a module carrying out control concerning the operation and display part, a module concerning management of user information, and a module carrying out control concerning system management. These programs are parallelly executable for process units under control of an OS (operating system) such as UNIX (registered trademark).

The starting-up part 23 is first executed when power is turned on in the information processing apparatus 11. Thereby, the OS such as UNIX is started up, and the applications 31 and platforms 32 are started up. These programs are stored in the HDD or a memory card, are read therefrom, and are started up in the RAM.

As an example of the information processing apparatus 11, an information device having an information processing function as a main function, or an electric device having an information processing function as an auxiliary function. As the information device, a personal computer may be cited. As the electric device, an image forming apparatus such as a copier, a printer, a scanner, a facsimile machine, a composite machine, a fusion machine or such, for which the information processing function is highly improved recently, may be cited. Next, a fusion machine 101 as a specific example of the information processing apparatus 11 is described.

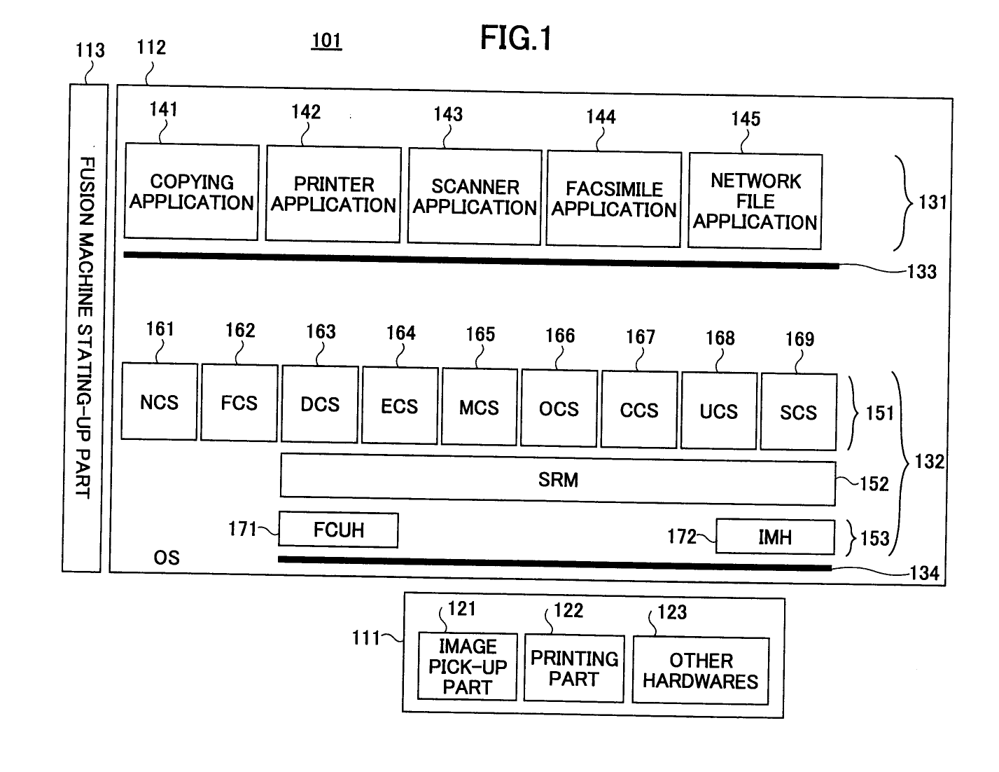

FIG. 1 shows the fusion machine 101 according to any one of first and second embodiments of the present invention. The fusion machine 101 shown includes various types of hardware 111, various types of software 112 and a fusion machine starting-up part 113. The fusion machine 101 can function as any one of a copier, a printer, a scanner and a facsimile machine, as mentioned above.

The hardware 111 includes, as shown, an image pick-up part 121, a printing part 122 and others 123.

The image pick-up part 121 functions to read an image (image data) from an original, and is applied when the fusion machine 101 acts as a copier or a facsimile machine. The image pick-up part 121 may be of a type for a monochrome image or a type for a color image. The image pick-up part includes an original setting part or such as a mechanism for handling a draft or an original.

The printing part 122 functions to print an image (image data) onto a printing medium such as a printing paper sheet, and is applied when the fusion machine 101 acts as a copier, a printer or a facsimile machine. The printing part 122 may be of a type for a monochrome image or a type for a color image. The printing part 122 is of an electrophotographic type, and includes a photosensitive body, an electric charger, an exposing device, a developing device, a transfer device, a fixing device and so forth. The printing part 122 also includes, as a mechanism for handling printing paper sheets and so forth, a paper feeding part, a paper ejecting part, a printing paper conveying mechanism, and so forth.

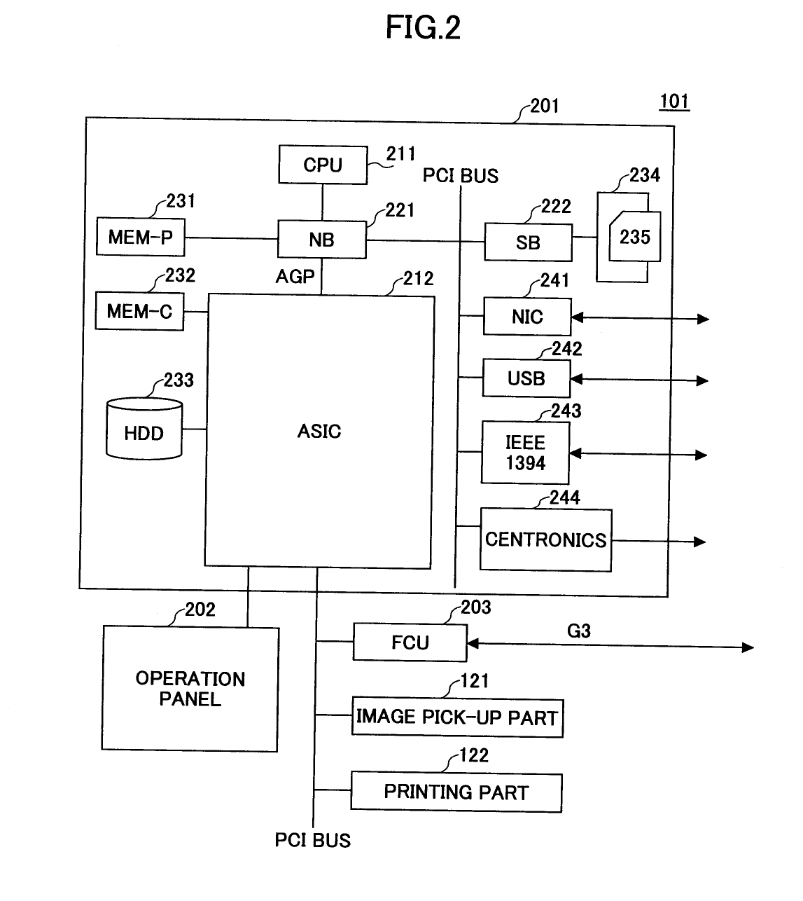

The other hardware 123 is described with reference to FIG. 2 later.

The software 112 includes various applications 131 and various platforms 132. These programs are executed in parallel for process units by an OS (operating system) such as a UNIX (registered trademark).

The applications 131 are software for executing information processing unique to functions of each of the copier, printer, scanner, facsimile machine and so forth. The applications 131 include a copy application 141 for a copying operation, a printer application 142 for a printing function, a scanner application 143 for a scanning function, a facsimile application 144 for a facsimile function and a network file application 145 for handling a network file. The network file application 145 includes a Web browser for browsing HTML documents or such, a Web server software for dispatching HTML documents, and so forth.

The platforms 132 are software for executing information processing concerning processing requests given by the applications 131. An application program interface (API) 133 which receives processing requests by functions previously defined is applied for receiving the processing requests from the applications 131. An engine interface 134 is applied for actually executing the contents of the requests. The platforms 132 include various control services 151, a system resource manger 152 and various handlers 153.

The control services 151 interpret the processing requests from the applications 131, and create acquisition requests for the hardware 111 according to the interpreted results. The control services 151 include a network control service (NCS) 161, a facsimile control service (FCS) 162, a delivery control service (DCS) 163, an engine control service (ECS) 164, a memory control service (MCS) 165, an operation panel control service (OCS) 166, a certification control service (CCS) 166, a user directory control service (UCS) 168, and a system control service (SCS) 169.

A process of the NCS 161 executes an agent function for carrying out data communication through a communication network or such. A process of the FCS 162 provides an API for carrying out image data communication, image data reading, image data printing or such as facsimile functions. A process of the DCS 163 carries out control concerning dispatch of document data stored in the fusion machine 101. A process of the ECS 164 carries out control concerning an engine part such as the image pick-up part 121, the printing part 122 and so forth. A process of the MCS 165 carries out control concerning memories for image data storage, image data processing or such, and a hard disk drive. A process of the OCS carries out control concerning the operation panel. A process of the CCS 167 carries out authentication processing and accounting processing. A process of the UCS 168 carries out control concerning user information management. A process of the SCS 169 carries out control concerning system management.

The system resource manager (SRM) 152 carries out control for carrying out arbitration of the acquisition requests, and, carrying out the request contents according to the arbitration result. In details, a process of the SRM 152 determines whether or not the hardware 111 concerning the acquisition request is available (whether or not any collision occurs with another acquisition request), and, when available, this matter is notified of to each process of the control service 151. Further the process of the SRM creates a schedule for using the hardware 111 concerning the acquisition requests, and carries out control of executing the request contents according to the schedule.

The handlers 153 manage the hardware 111 according to the arbitration results. The handlers 153 include a facsimile control handler (FCUH) 171 and an image memory handler (IMH) 172. The FCUH 171 manages a facsimile control unit. The IMH 172 designates memories for respective processes, and manages the thus-designated memories.

The fusion machine starting-up part 113 is executed when power supply is started in the fusion machine 101. Thereby, the OS such as UNIX is started up, and the applications 131 and the platforms 132 are started up. These programs are stored in the hard disk drive or a memory card, are read out therefrom, and are started up in the memories.

FIG. 2 shows a hardware configuration diagram of the fusion machine 101 shown in FIG. 1. The hardware 111 of the fusion machine 101 includes a controller 201, the operation panel 202, the facsimile control unit (FCU) 203, the image pick-up part 121 and the printing part 122. The respective parts other than the image pick-up part 121 and the printing part 122 correspond to the other hardware 123.

The controller 201 includes a CPU 211, an ASIC 212, an NB (north bridge) 221, a SB (south bridge) 222, an MEM-P (system memory) 231, a MEM-C (local memory) 232, the HDD (hard disk drive) 233, a memory card slot 234, the NIC (network interface controller) 241, a USB device 242, an IEEE 1394 device 243 and a centronics device 244.

The CPU 211 is an IC for executing various types of information processing, and executes the applications 131 or the platforms 132 in parallel for process units with the use of the OS such as UNIX. The ASIC 212 is an IC for image processing. The NB 221 is a bridge for connecting the CPU 211 with the ASIC 212. The SB 222 is a bridge for connecting with peripheral devices. The ASIC 212 and the NB 221 are connected together via an AGP (accelerated graphics port).

The MEM-P 231 is a memory connected with the NB 221. The MEM-C 232 is a memory connected with the ASIC 212. The HDD 233 is a storage connected with the ASIC 212, and is applied for image data storage, document data storage, program storage, font data storage, form data storage, or such. The memory card slot 234 is a slot connected to the SB 222, and is applied to set (insert) a memory card 235 therein.

The NIC 241 is a controller for carrying out data communication with the use of a MAC address or such via the communication network or such. The USB device 242 is a device providing a serial port conforming to the USB standard. The IEEE 1394 device is a device providing a serial port conforming to the IEEE 1394 standard. The centronics device 244 is a device providing a parallel port conforming to the centronics standard. The NIC device 241, the USB device 242, the IEEE 1394 device 243 and the centronics device 244 are connected to the NB 221 and SB 222 via a PCI (peripheral component interconnect) bus.

The operation panel 202 is hardware (operation part) for an operator to input information/instructions to the fusion machine 101 and also, is hardware (display part) for the operator to obtain an output from the fusion machine 101. The operation panel 202 is connected to the ASIC 212. The FCU 203, the image pick-up part 121 and the printing part 122 are connected to the ASIC 212 via the PCI bus.

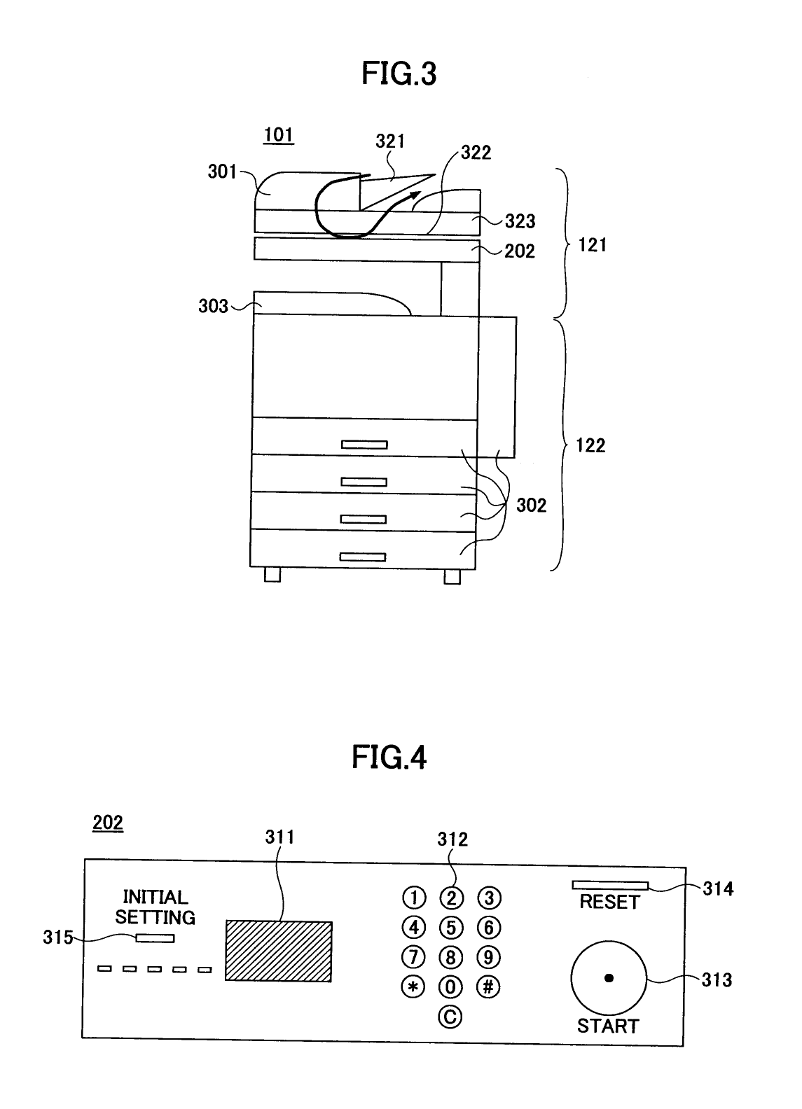

FIG. 3 shows an exterior appearance of the fusion machine 101. In FIG. 3, an actual position of the image pick-up part 121, an actual position of the printing part 122 and an actual position of the operation panel 202 are shown. Further, in FIG. 3, an original setting part 301 on which an original is set, a paper feeding part 302 used for feeding printing paper sheets or such, and a paper ejecting part 303 to which printing paper sheets or such are ejected are shown. The original setting part 301 is included in the image pick-up part 121, and the paper feeding part 302 and the paper ejecting part 303 are included in the printing part 122.

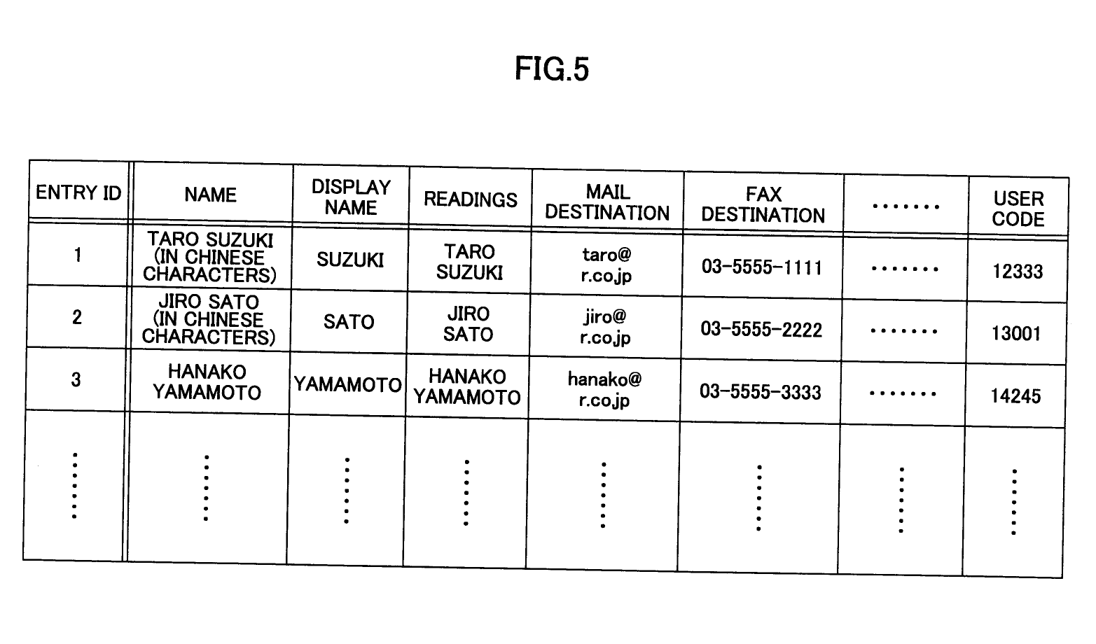

As shown in FIG. 4, the operation panel 202 includes a touch panel 311, ten keys 312, a start button 313, a reset button 314 an initial setting button 315.

The touch panel 311 is hardware for a user to input information/instructions with finger touch operation (touch operation part), and also, is hardware from which output is obtained by a user in a form of page display (image display part). The ten keys 312 are hardware with which numerical input is carried out with key operation. The start button 313 is hardware with which start operation is carried out with button pressing operation. The reset button 314 is hardware with which resetting operation is carried out with button pressing operation. The initial setting button 315 is hardware with which an initial setting page is displayed with button pressing operation.

When an original is set in the original setting part 301, the fusion machine 101 reads an image from the original with the use of the image pick-up part 121 in response to the start button 133 being pressed. When acting as a copier, the fusion machine 101 prints the image onto a printing paper sheet or such with the use of the printing part 122. On the other hand, when the fusion machine 101 acts as a facsimile machine, the image is transmitted to another apparatus via a telephone line, a communication network or such, with the use of the FCU 203 and the NIC 241. As mentioned above, the printing paper sheets or such are fed to the paper feeding part 302, while, to the paper ejecting part 303, the printing paper sheets or such are ejected after images are produced thereon by the printing function.

The original setting part 301 includes an ADF (automatic draft feeder) 321, a flat bed 322, and a flat bed cover 323. The paper feeding part 302 includes four paper feeding trays and one manual paper feeding tray. The paper ejecting part 303 includes one paper ejecting tray.

The ADF 321 is configured to allow a plurality of original paper sheets to be set therein. When the original is set in the ADF 321, the fusion machine 101 reads an image of the original with the use of the image pick-up part 121 when the start button 313 is pressed. In detail, when a plurality of paper sheets of original are set in the ADF 321, the plurality of paper sheets are conveyed, sheet by sheet, as indicated by an arrow shown, when the start button 313 is pressed, and the image pick-up part 121 reads images, one by one, from the original thus conveyed thereto, sheet by sheet.

On the flat bed 322, the original is set in a manner in which the obverse side thereof faces downward. When the original is set in the flat bed 322, the fusion machine 101 reads an image of the original with the use of the image pick-up part 121 when the start button 313 is pressed. In detail, when the original is set in the flat bed 322 in the manner in which the obverse side thereof faces downward, the image pick-up part 121 reads an image from the original, which the image pick-up part 121 faces through the transparent flat bed 322, when the start button 313 is pressed.

A first embodiment according to the above-mentioned first through twentieth aspects of the present invention is described in detail.

User information of the fusion machine 101 shown in FIG. 1 is described first.

In the fusion machine 101 shown in FIG. 1, user information is stored in the HDD 233 by means of the UCS 168, and also, is used by the scanner application 143, the facsimile application 144, or such. This is because, when the fusion machine 101 functions as the scanner or the facsimile machine, the user information such as a mail (electronic mail) address, a facsimile telephone number or such is required. The fusion machine 101 uses the user information managed by the UCS 168, and thus, can carries out image forming processing (such as processing for functioning as the facsimile machine) as transmitting an image to another apparatus with the use of a communication network, a telephone line or such.

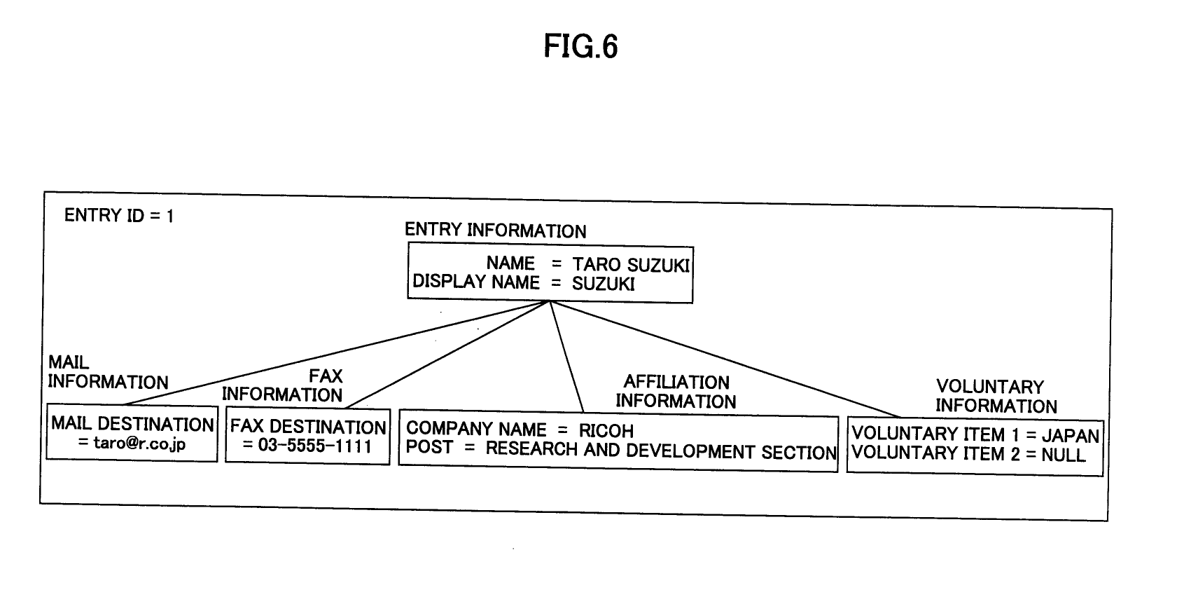

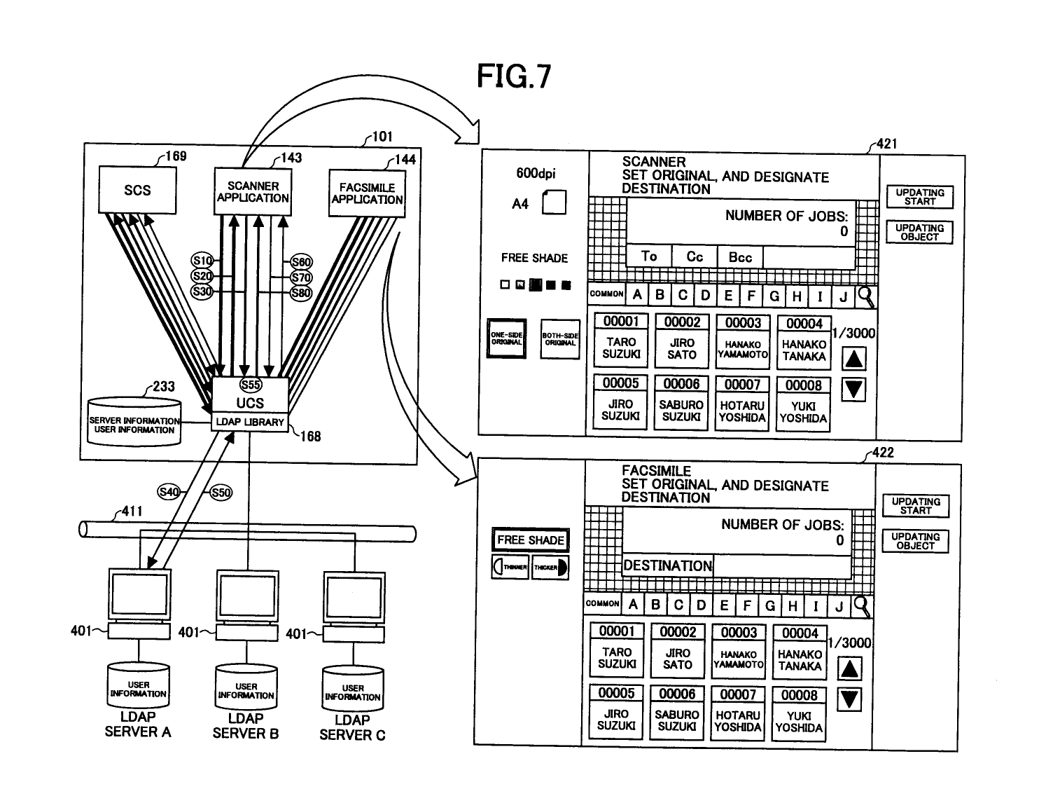

In the fusion machine 101, the user information is managed by the UCS 168 in a form of an address book such as that shown in FIG. 5. That is, a user (entry) is managed with the use of an user ID (entry ID), and the user information is managed in a form of item values of management items such as ‘name’, ‘display name’ ‘reading’, ‘mail destination’, ‘FAX destination’ or such. A data structure of the user information of each user has a tree structure as shown in FIG. 6. That is, the management items ‘name’ and ‘display name’ are treated as parent items, and management items ‘mail destination’, ‘FAX destination’ and so forth are treated as child items. The user information of one user is stored in one entry together. However, the user information may be managed among a plurality of entries.

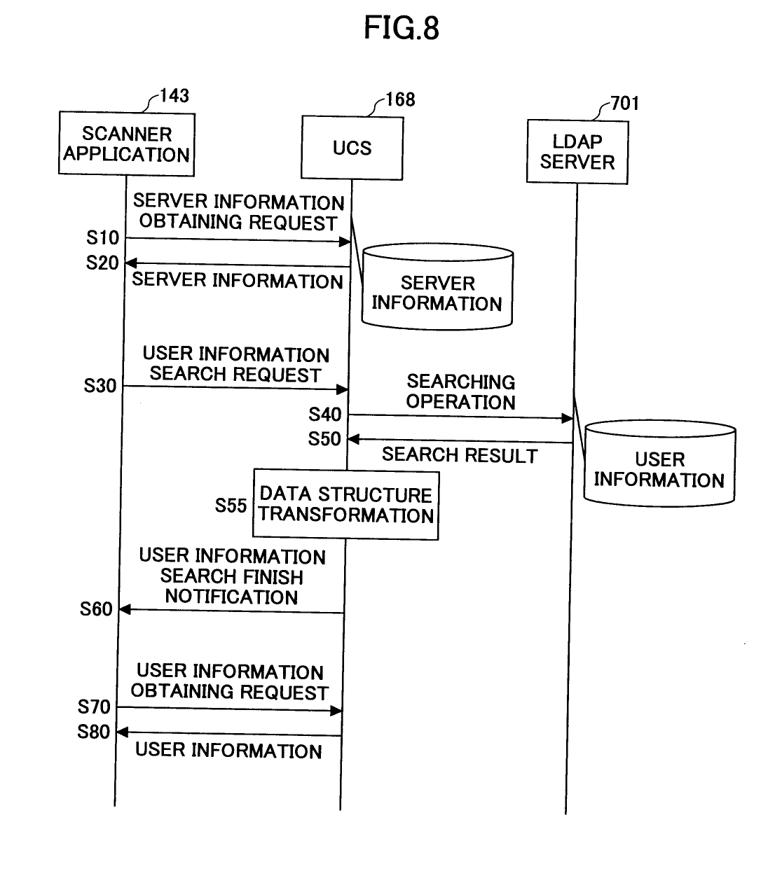

The fusion machine 101 can obtain the user information from the LDAP server with the use of the UCS 168. The user information thus obtained with the use of the UCS 168 is stored in the HDD 233 or such, and is managed by the UCS 168. There, as shown in FIG. 7, the fusion machine 101 is connected with three LDAP servers 401 (LDAP servers A, B and C) via a communication network 411 such as a LAN, and can obtain the user information from the LDAP servers 401.

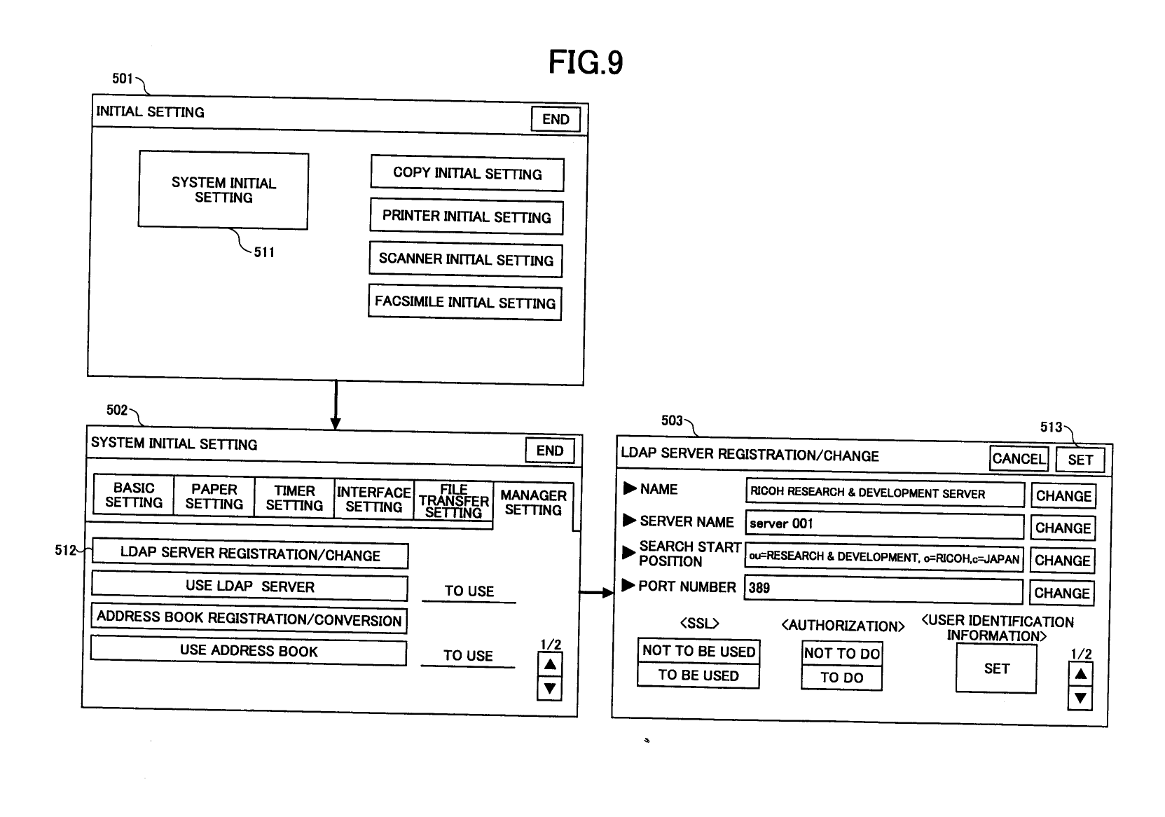

This process is described with reference to FIGS. 7 and 8. FIGS. 7 and 8 are a system diagram and a sequence diagram, respectively, for illustrating the user information obtaining processing.

As shown in FIG. 7, the scanner application 143 or the facsimile application 144 displays a scanner operation page 421 or a facsimile operation page 422 on the touch panel 311 (FIG. 4) as shown in FIG. 7. When an operation triggering a start of server information obtaining processing is input via the operation page, the scanner application 143 or such transmits a server an information obtaining request to the UCS 168 (S10). In response thereto, the UCS 168 provides the server information to the scanner application 143 or such (S20) as shown in FIG. 8.

The fusion machine 101 can store the server information (LDAP server information) in the HDD 233 or such and manages it with the use of the UCS 168, for the purpose of obtaining the user information from the server (LDAP server). The server information is stored in the HDD 233 or such and is managed for each server. Management items of the server information are ‘server name’, ‘port number’, ‘IP address’ and so forth.

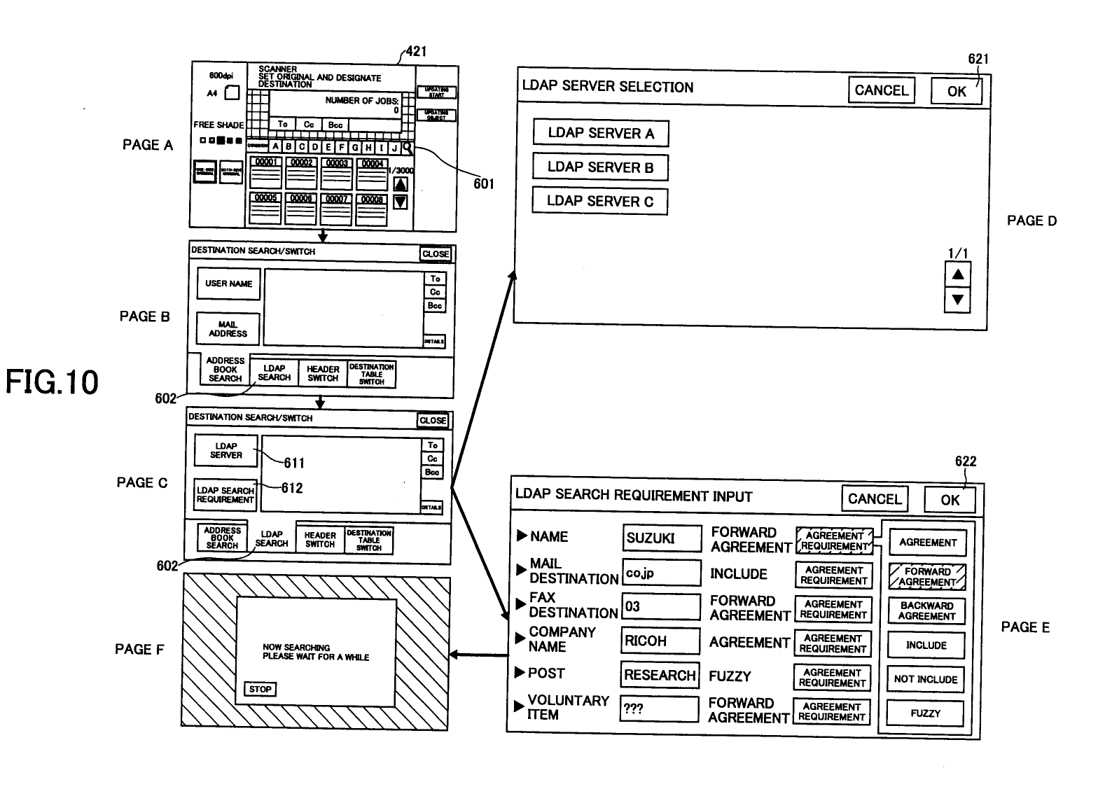

The fusion machine 101 can register or change the server information. This process is described with reference to FIG. 9. FIG. 9 shows a page transition diagram for illustrating the server information registering/changing operation. An initial setting page 501 is displayed on the touch panel 311 (FIG. 4) when the initial setting button 315 (FIG. 4) is touched. When a system initial setting button 511 is touched on the initial setting page 501, a system initial setting page 502 is displayed instead. When a LDAP server registering/changing button 512 is touched on the system initial setting page 502, an LDAP server registering/changing page 503 is displayed instead. When server information is input and a setting button 513 is touched by a user on the LDAP server registering/changing page 503, the server information is registered/changed. These setting pages are displayed on the touch panel 311 (FIG. 4) by means of the function of the SCS 169.

When an operation triggering a start of user information obtaining processing is input after the processing of S10 and the processing of S20 are carried out, the scanner application 143 or such transmits a user information search request to the UCS 168 (S30). In response thereto, the UCS 168 makes a request to cause the LDAP server 401 to carry out search operation (S40). In response thereto, the LDAP server 401 returns a search result to the UCS 168 (S50). In response thereto, the UCS 168 transmits a user information search finish notification to the scanner application 143 or such (S60). Then, the scanner application 143 or such transmits a user information obtaining request to the UCS 168 (S70). In response thereto, the UCS 168 actually provides the user information to the scanner application 143 or such (S80) obtained in Step S50 mentioned above.

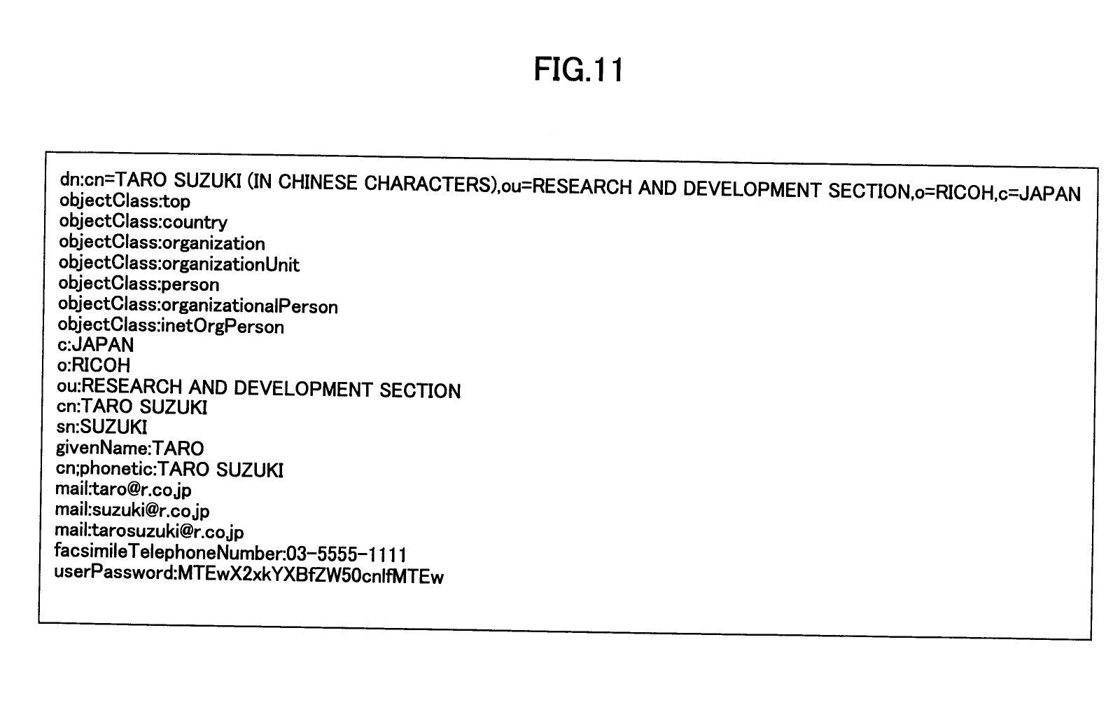

This process is further described with reference to FIG. 10. FIG. 10 shows a page transition diagram for illustrating the user information obtaining processing.

A page A is a scanner operation page 421. When a loupe button 601 is pressed on the scanner operation page 421, a page B is displayed next on the touch panel instead. When an LDAP search button 602 is touched on the page B, a page C is displayed next. When an LDAP server selecting button 611 is touched on the page C, a page D is then replaced with. When the LDAP server is selected on the page D, and an OK button 621 is touched, a page E is then replaced with. When an LDAP search requirement is input and an OK button 622 is touched, a page F is replaced with, and soon, relevant user information thus retrieved is displayed. An operation of touching the OK button on the page D corresponds to the operation triggering a start of the server information obtaining processing, and operation of touching the OK button 622 on the page E corresponds to the operation triggering a start of the user information obtaining processing (search processing).

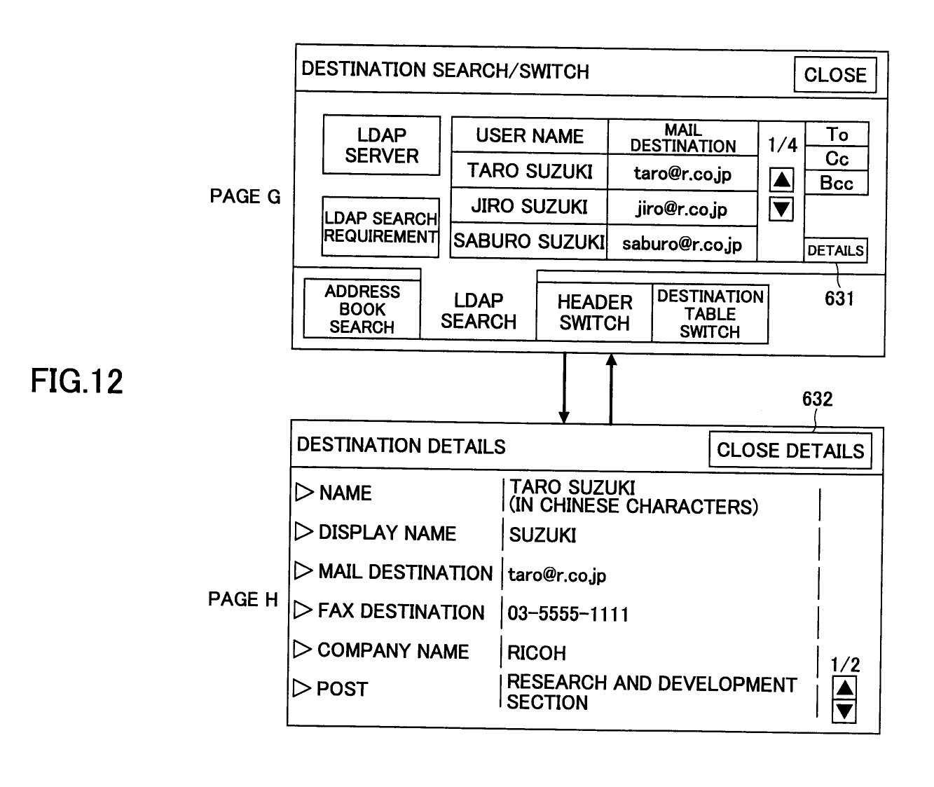

FIG. 11 shows the user information obtained from the LDAP server 401 by the UCS 168 as a result of the search operation being carried out, which is then returned to the UCS 168 (S50) by the LDAP server 401. Specific items obtained as the user information include ‘an’, ‘sn’, ‘giveName’, ‘mail’, ‘facsimileTelephoneNumber’, and so forth, as shown. This is because the LDAP server 401 manages the user information as the item values (attribute values) of the management items (attributes) such as ‘an’, ‘sn’, ‘giveName’, ‘mail’, ‘facsimileTelephoneNumber’, and so forth. It is noted that, actually, different from FIG. 11, characters other than ASCII characters such as of the capitalized words are described in an encoded form in a Base 64 format.

In the fusion machine 101, during the processing of S50 and the processing of S60 (FIGS. 7 and 8), a data structure of the user information thus obtained from the LDAP server 401 by means of the UCS 168 is transformed into a data structure shown in FIG. 6, from that shown in FIG. 11, by means of the UCS 168 (S55). At this time, the UCS 168 replaces the items of the user information thus obtained from the LDAP server 401 with management items of the user information. This is because, the management items in the fusion machine 101 are different from those in the LDAP server 401. For example the item ‘mail address’ is managed by the LDAP server 401 as the item value of the management item ‘mail’, while, the same item is managed by the fusion machine 101 as the item value of the management item ‘mail destination’ (FIGS. 5 and 6).

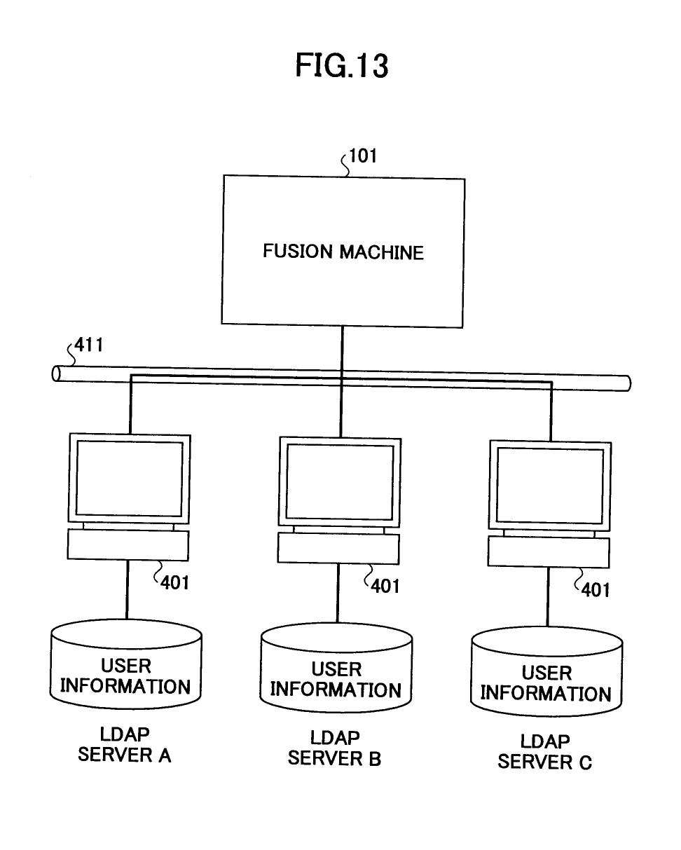

FIG. 12 shows a page transition diagram following the same shown in FIG. 10. A page G appears as a replacement of the page F shown in FIG. 10.

On the page G, the user information provided (S80) to the scanner application 143 or such from the UCS 168 is displayed. When a user SUZUKI TARO is touched and a detail button 631 is touched on the page G, a page appears next as a replacement, as shown in FIG. 12. On the page H, details of user information of the user SUZUKI TARO provided (S80) to the scanner application 143 or such by the UCS 168 are displayed. Then, when a close details button 632 is touched on the page H, the page G again appears as a replacement. The user information thus displayed on the page G or page H is user information which is the search result obtained from the LDAP server 401 as a result of the response being given to the UCS 168 from the LDAP server 401, that is, the user information obtained by the UCS 168 from the LDAP server 401. However, the user information obtained from the LDAP server 401 is once processed (transformed) before being displayed as mentioned above. That is, as mentioned above, the items of the user information obtained from the LDAP server 401 are replaced by the management items of the user information for the fusion machine 101. For example, the item ‘mail’ of the user information obtained from the LDAP server 401 is replaced by the management item ‘mail destination’ of the user information for the fusion machine 101.

Next, user authentication in the fusion machine 101 is described according to the first embodiment of the present invention (according to the first through twentieth aspects of the present invention).

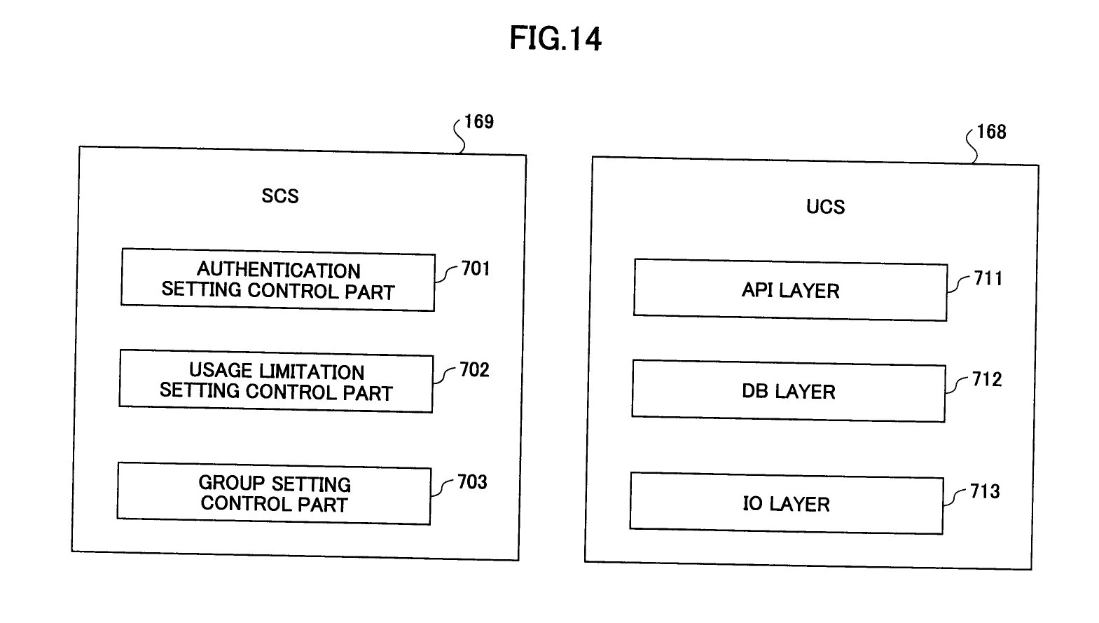

FIG. 13 shows a system configuration diagram concerning the fusion machine 101 shown in FIG. 1. According to the first embodiment, the fusion machine 101 is connected with three LDAP servers (LDAP servers A, B and C) via the network 411, and can function as a client of the LDAP servers 401 (LDAP client).

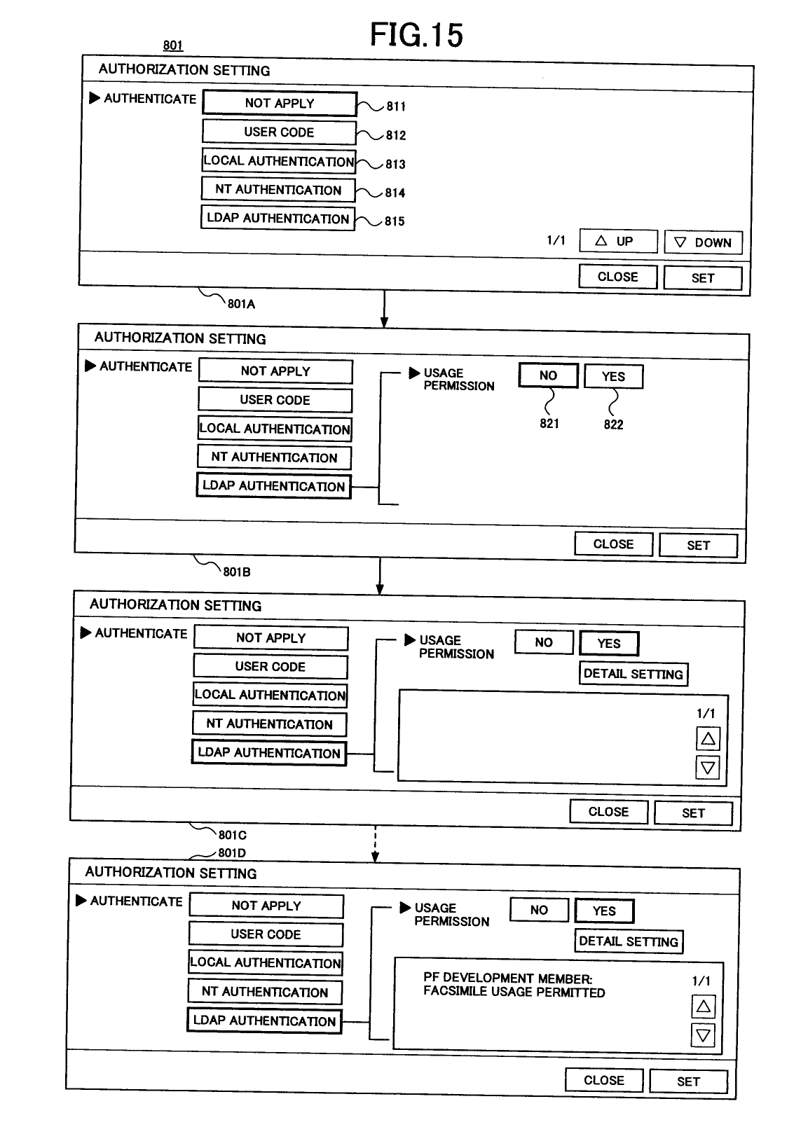

FIG. 14 shows a functional block diagram concerning the SCS 169 and UCS 168 of the fusion machine 101. The SCS 169 includes an authentication setting control part 701, a usage limitation setting control part 702 and a group setting control part 703. The UCS 168 includes an API (application program interface) layer 711, a DB (database) layer 712 concerning a function as a database, an IO (input/output) layer 713 acting as an interface with internal devices and so forth. The authentication setting control part 701, the usage limitation setting control part 702 and the group setting control part 703 of the SCS 169 have functions to display an authentication setting page, a usage limitation setting page and a group setting page, described later, respectively. These setting pages are displayed on the touch panel 311, and various setting operations on these setting pages are achieved by finger touch operation or such applied to the touch panel 311 by a user when these setting pages are displayed.

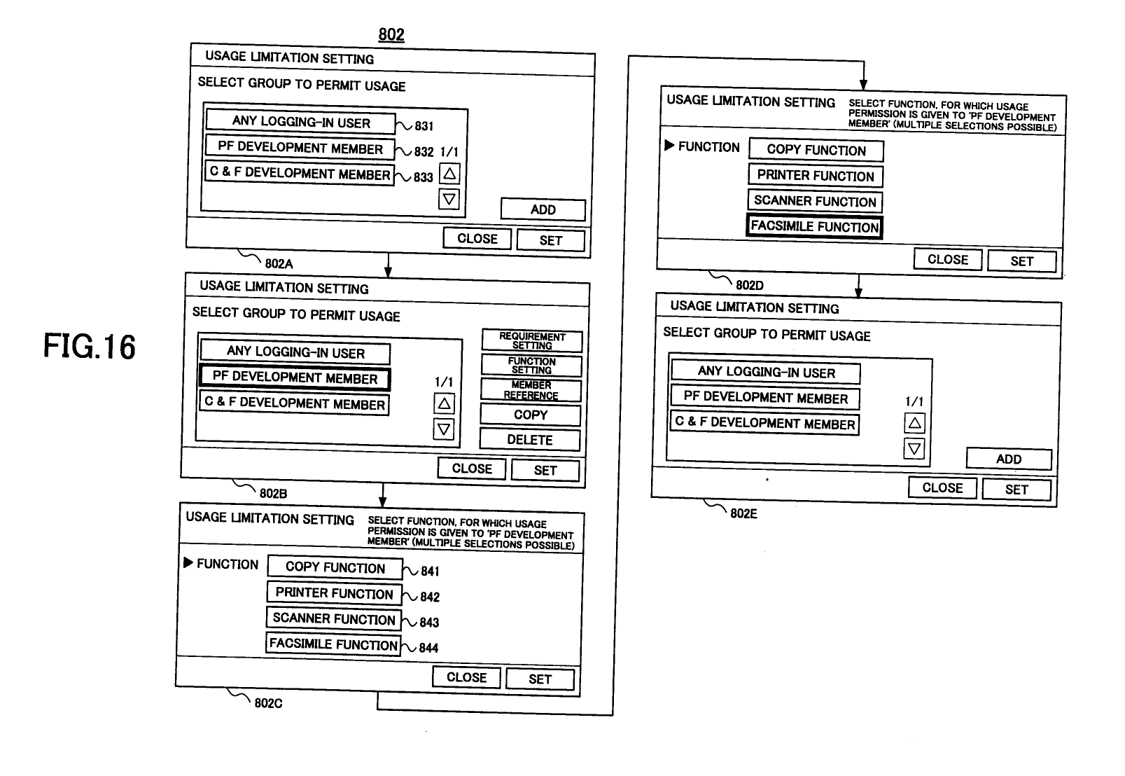

FIG. 15 shows a page transition diagram concerning the authentication setting page 801. The authentication setting page is a setting page prepared for the purpose that a setting concerning authentication processing for a user who uses the fusion machine 101 is made in the fusion machine 101. A series of pages of the authentication setting page 801 are identified by respective alphabetic suffixes.

A button 811 is a button for making a setting that no authentication is carried out for a user who uses the fusion machine 101, in the fusion machine 101. A button 813 is a button for making a setting in the fusion machine 101 such as to carry out authentication of a user who uses the fusion machine by the fusion machine 101 itself. A button 814 is a button for making a setting in the fusion machine 101 such as to cause an NT server to carry out authentication of a user who uses the fusion machine 101. A button 815 is a button for making a setting in the fusion machine 101 such as to cause an LDAP server to carry out authentication of a user who uses the fusion machine 101.

When the button 815 is touched on the authentication setting page 801A shown in FIG. 15, an authentication setting page 801B appears as a replacement. When a set button is touched on the authentication setting page 801B, the setting such as to cause the LDAP server 401 to carry out authentication of a user who uses the fusion machine 101 is made in the fusion machine 101. This processing is carried out mainly by the authentication setting control part 701 of the SCS 169. Information as to which LDAP server is applied as one to be caused to carry out authentication processing, and LDAP information of the LDAP server to be thus applied are previously set.

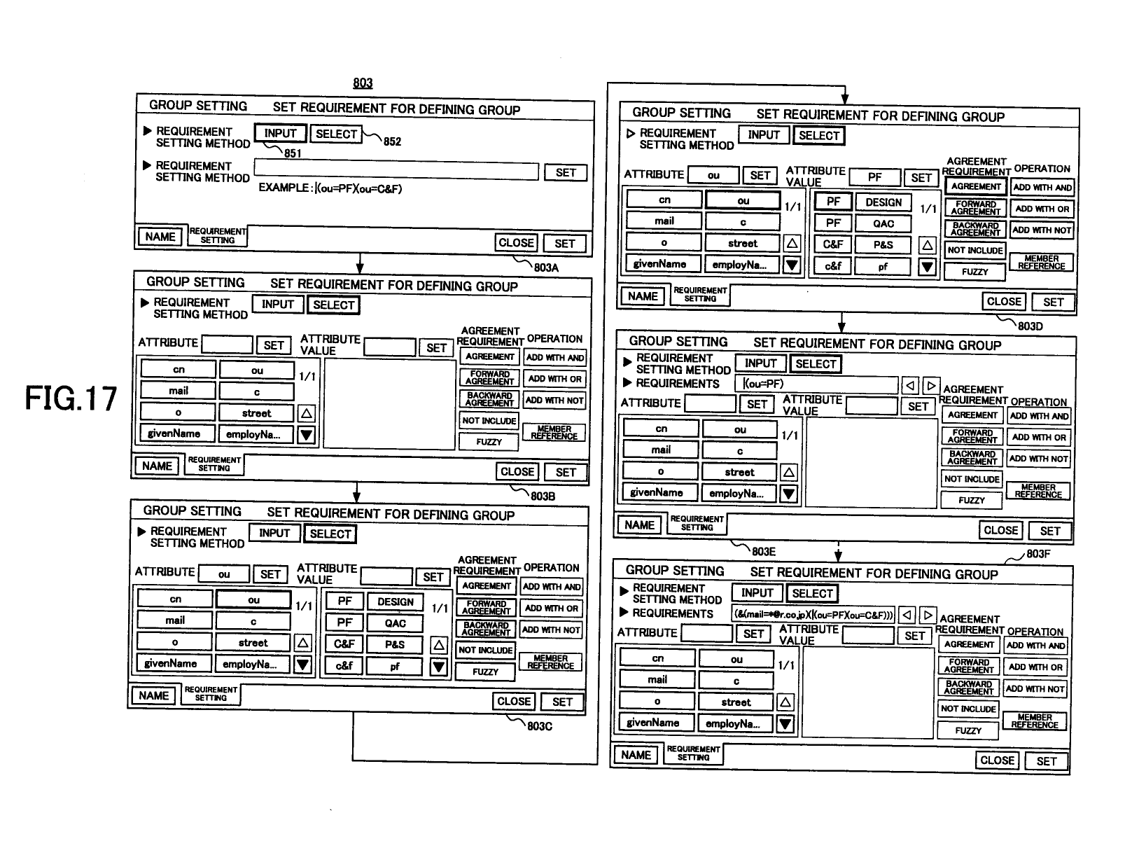

FIG. 16 is a page transition diagram of the usage limitation setting page 802. The usage limitation setting page 802 is a setting page for making a setting for usage limitation for a user who uses the fusion machine 101. A series of pages of the usage limitation setting page 802 are distinguished by alphabetical suffixes. It is noted that, hereinafter, when the contents shown in FIG. 15 are described, this matter is shown in parentheses.

A button 821 (FIG. 15) is a button for not making a setting of usage limitation cancellation (or not making a setting of usage permission) in the fusion machine 101 for a user who uses the fusion machine 101, in a case where a setting such as to cause the LDAP server to carry out authentication of a user who uses the fusion machine 101 is made in the fusion machine 101. A button 822 (FIG. 15) is a button for making a setting of usage limitation cancellation (or making a setting of usage permission) in the fusion machine 101 for a user who uses the fusion machine 101, in a case where a setting such as to cause the LDAP server to carry out authentication of a user who uses the fusion machine 101 is made in the fusion machine 101.

A button 832 of FIG. 16 is a button for making a setting for usage limitation cancellation/not cancellation (usage permission/not permission) for ‘PF development members’, in a lump, in the fusion machine 101. Thereby, it becomes possible to make a setting for usage limitation cancellation/not cancellation (usage permission/not permission) for the PF development group in a lump, in the fusion machine 101. A button 833 is a button for making a setting for usage limitation cancellation/not cancellation (usage permission/not permission) for ‘C & F development members’ in a lump in the fusion machine 101. Thereby, it becomes possible to make a setting for usage limitation cancellation/not cancellation (usage permission/not permission) for the C & F development group in a lump, in the fusion machine 101.

A button 841 of FIG. 16 is a button for making a setting in the fusion machine 101 such as to give the PF development members a usage permission for the copy function of the fusion machine 101. A button 842 is a button for making a setting in the fusion machine 101 such as to give the PF development members a usage permission for the printing function of the fusion machine 101. A button 843 is a button for making a setting in the fusion machine 101 such as to give the PF development members a usage permission for the scanner function of the fusion machine 101. A button 844 is a button for making a setting in the fusion machine 101 such as to give the PF development members a usage permission for the facsimile function of the fusion machine 101.

When the button 822 is touched on the authentication setting page 801B (FIG. 15), the authentication setting page 801C appears as a replacement (FIG. 15). When a detail setting button is touched on the authentication setting page 801C, a usage limitation setting page 802A of FIG. 16 appears as a replacement. When the button 832 is touched on the usage limitation setting page 802A, a usage limitation setting page 802B appears as a replacement. When a function setting button is touched on the usage limitation setting page 802B, a usage limitation setting page 802C appears as a replacement. When the button 844 is touched on the page, a usage limitation setting page 802D appears as a replacement. When a set button is touched on the usage limitation setting page 802D, a usage limitation setting page 802E appears as a replacement. When a set button is touched on the usage limitation setting page 802E, the authentication setting page 801D appears as a replacement (FIG. 15). When a set button is touched on the authentication setting page 801D, a setting to give the PF development members a usage permission for the facsimile function of the fusion machine 101 is made in the fusion machine 101. Thus, the setting for usage limitation cancellation (usage permission) of the facsimile function of the fusion machine 101 is made for the PF development group in a lump in the fusion machine 101. This processing is mainly carried out by the usage limitation setting control part 702 of the SCS 169.

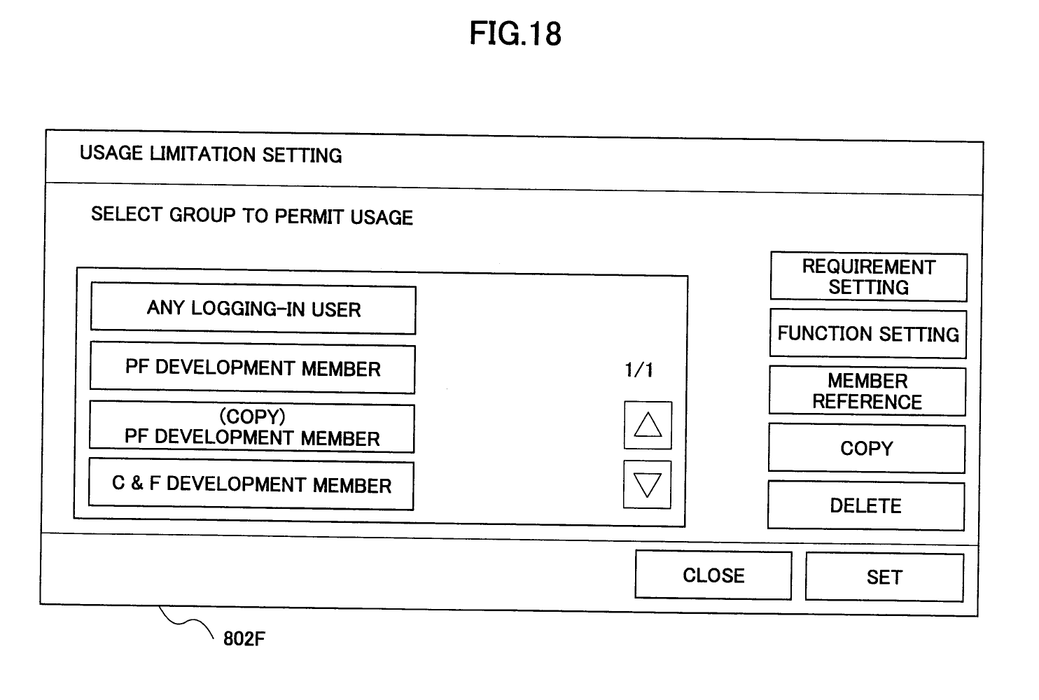

FIG. 17 shows a page transition diagram of the group setting page 803. The group setting page 803 is a setting page for setting groups of users for which the user information is managed by in the LDAP server 401, in the fusion machine 101. A series of pages of the group setting page 803 are distinguished by alphabetical suffixes. When the contents of FIG. 15 or 16 are described, this matter is shown in parentheses, hereinafter.

As mentioned above, the group seating page 803 is used to set groups of users whose user information is managed by the LDAP server 401. The PF development group and the C & F development group appearing on the usage limitation setting page 802 (FIG. 16) correspond to examples of the groups thus set, and include the PF development members and the C & F development members, respectively.

With the use of the group setting page 803, a group can be set in such a manner that, whether or not a user is a group member is defined by whether or not a requirement, as to whether or not a predetermined attribute value in a predetermined attribute item is set in the user information of the user managed by the LDAP server 401, is satisfied. For example, the requirement may be set in such a manner that ou=PF, meaning that whether or not an attribute PF is set in the attribute ou, for example. Alternatively, the requirement may be set in such a manner that ou=C & F, meaning that whether or not an attribute C & F is set in the attribute ou, for example. Alternatively, the requirement may be set in such a manner that |(ou=PF) (ou=C & F), meaning that whether or not the attribute PF is set in the attribute ou, or whether or not the attribute C & F is set in the attribute ou, for example. Alternatively, the requirement may be set in such a manner that & (ou=PF) (mail=*r.co.jp), meaning that whether or not the attribute PF is set in the attribute ou, and also, whether or not an attribute value ‘r.co.jp’ is stored after the attribute ‘mail’. For each group set on the group setting page 803, whether or not a user belongs to a certain group is determined by whether or not the user information of the user meets the requirement such as that mentioned above defined for the group.

A button 851 of FIG. 17 is a button for displaying a group setting page 803, as the above-mentioned group setting page 803 such that setting operation for the requirement as mentioned above is carried out with character input operation. A button 852 is a button for displaying a group setting page 803, as the above-mentioned group setting page 803 such that setting operation for the requirement as mentioned above is carried out with displayed item selecting operation in this case.

When an add button is touched on the usage limitation setting page 802A or 802E (FIG. 16), a group setting page 803A of FIG. 17 appears as a replacement. On the group setting page 803A, setting operation for the requirement as mentioned above for defining the group can be achieved by character input operation. When a button 852 is touched on the group setting page 803A, a group setting page 803B appears as a replacement. On the group setting page 803B, setting operation for the requirement as mentioned above can be achieve by displayed item selecting operation.

Group setting pages 803B, C and D of FIG. 17 show a process in which the requirement setting operation for setting the requirements ou=PF meaning that whether or not the attribute value PF is stored in the attribute ou, is achieved by attribute selecting operation and attribute value selecting operation. When ‘ou’ of ‘attribute’ on the group setting page 803B is touched, a group setting page 803C appears as a replacement. When ‘PF’ of ‘attribute value’ is touched on the group setting page 803C, and also, ‘agreement’ of ‘agreement requirement’ is touched on the page, a group setting page 803D appears as a replacement.

Group setting pages 803D, E and F of FIG. 17 following the above-mentioned pages, show a process in which the requirement setting operation for setting the requirements (& (mail=*@r.co.jp) (|(ou=PF) (ou=C & F)) is finally achieved by attribute selecting operation, attribute value selecting operation, and ‘AND, OR, NOT’ selecting operation. On the group setting page 803D, ‘add with OR’ of ‘operation’ is touched, and as a result, finally a group setting page 803E appears as a replacement. Then, as a result of the same operation being repeated, a group setting page 803F finally appears as a replacement.

It is noted that, for example, the operation with the use of the ‘add with AND’ button mentioned above means operation for adding a new requirement item with the use of a logical operation of AND. Similarly, the operation with the use of the ‘add with OR’ button or the add with NOT’ button mentioned above means operation for adding a new requirement item with the use of a logical operation of OR or NOT, accordingly.

When a ‘set’ button is touched on any of the group setting pages 803A, D, E and F, the usage limitation setting page 802A or 802E (FIG. 16) appears as a replacement. Then, when a ‘set’ button is touched on the usage limitation setting page 802A or 802E, the authentication setting page 801D (FIG. 15) appears as a replacement. When a ‘set’ button is touched on the authentication setting page 801D, a group for which, whether or not a user is a group member is determined by whether or not the requirement as to whether or not a predetermined attribute value is stored in a predetermined attribute item of the user information of the user managed by the LDAP server is met, is set in the fusion machine 101. This processing is mainly carried out by the group setting control part 703 of the SCS 169.

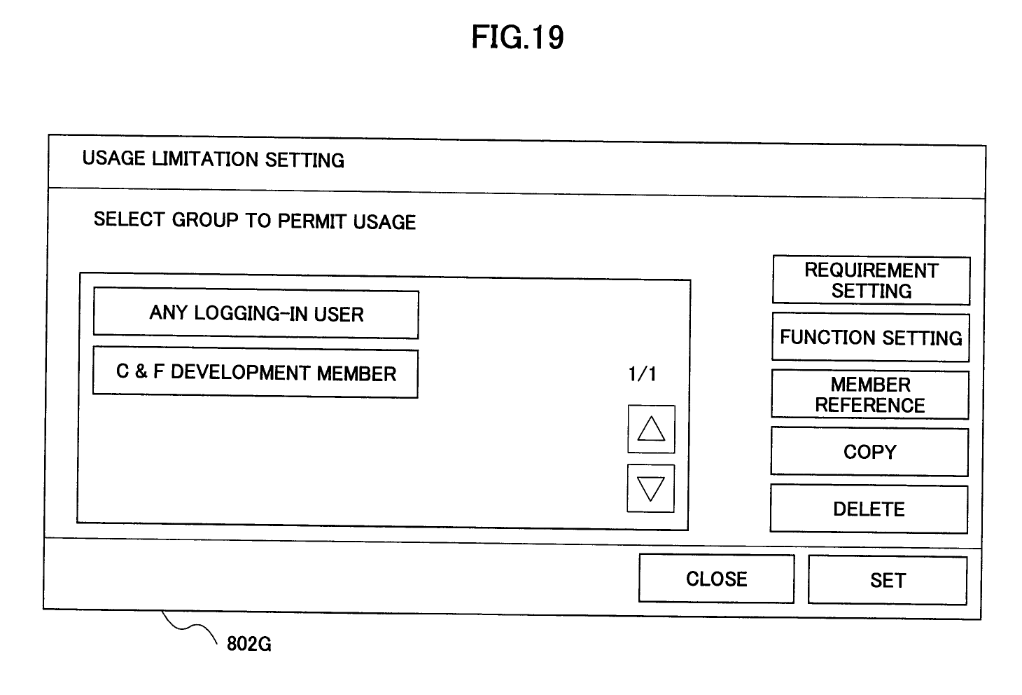

FIG. 18 shows a page for illustrating copy operation for copying a group. When a ‘PF development member’ button is touched on the usage limitation setting page 802A of FIG. 16, the usage limitation setting page 802B appears as a replacement. Then, when a copy button is touched on the usage limitation setting page 802B, a usage limitation setting page 802F of FIG. 18 appears as a replacement. Thus, the ‘PF development group’ is copied as shown in FIG. 18. The copy operation is applied for a case where another group is created taking over from the requirement of one group. For example, a ‘PF development USC group’ is set which group includes UCS members included in the PF development members.

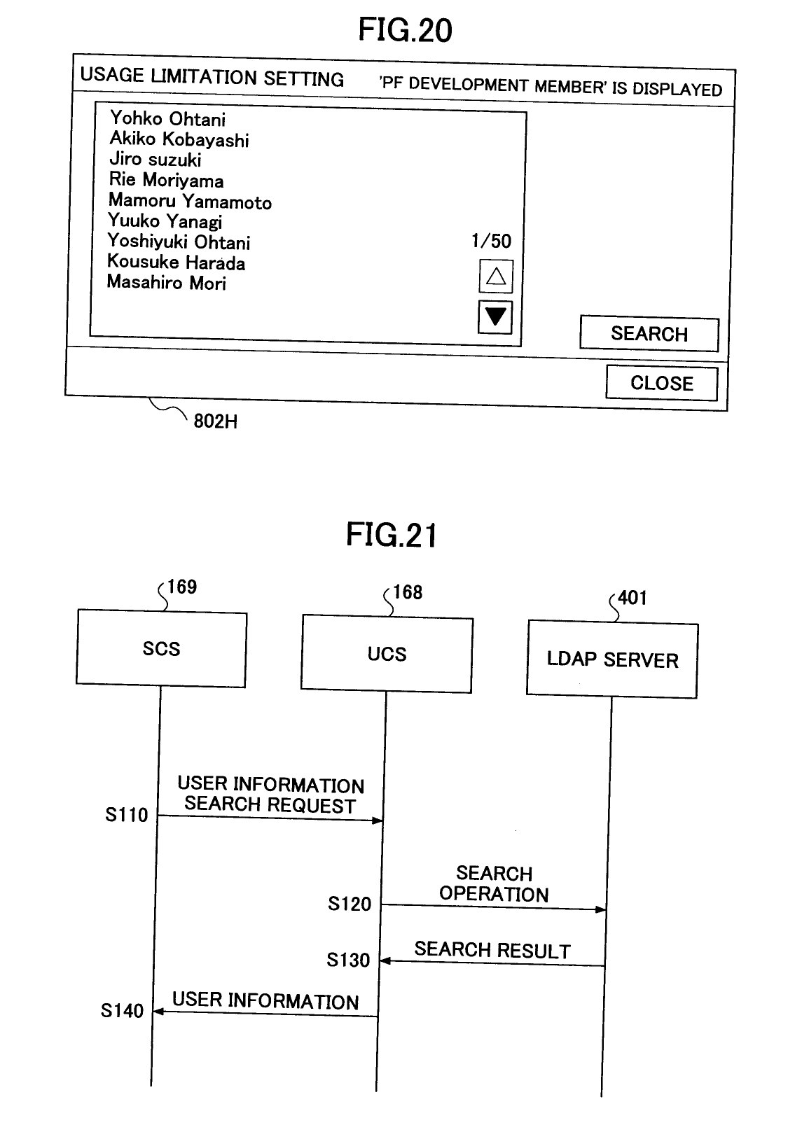

FIG. 19 shows a page for illustrating delete operation for deleting a group. When a ‘PF development member’ button is touched on the usage limitation setting page 802A of FIG. 16, the usage limitation setting page 802B appears as a replacement. Then, when a delete button is touched on the usage limitation setting page 802B, a usage limitation setting page 802G of FIG. 19 appears as a replacement. Thus, the ‘PF development group’ is deleted as shown in FIG. 19.

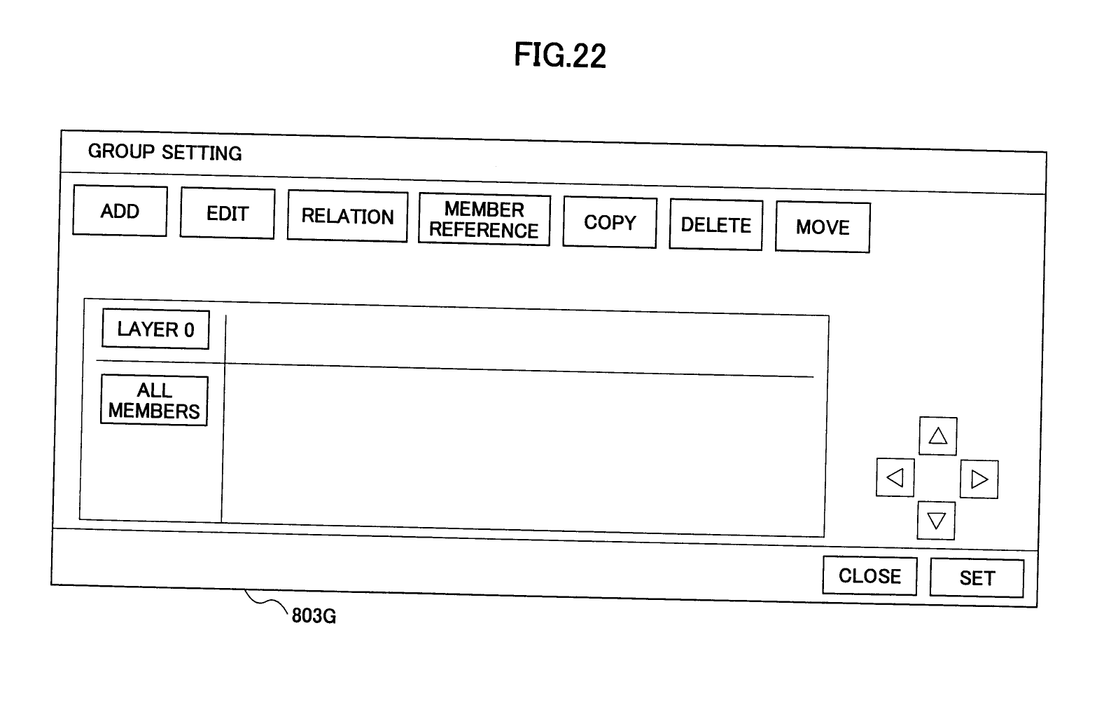

FIG. 20 shows a page for illustrating reference operation for referring to users belonging to a group. When a ‘PF development member’ button is touched on the usage limitation setting page 802A of FIG. 16, the usage limitation setting page 802B appears as a replacement. Then, when a member reference button is touched on the usage limitation setting page 802B, a usage limitation setting page 802H of FIG. 20 appears as a replacement. Thus, the users who belong to the ‘PF development group’ can be referred to as shown in FIG. 20.

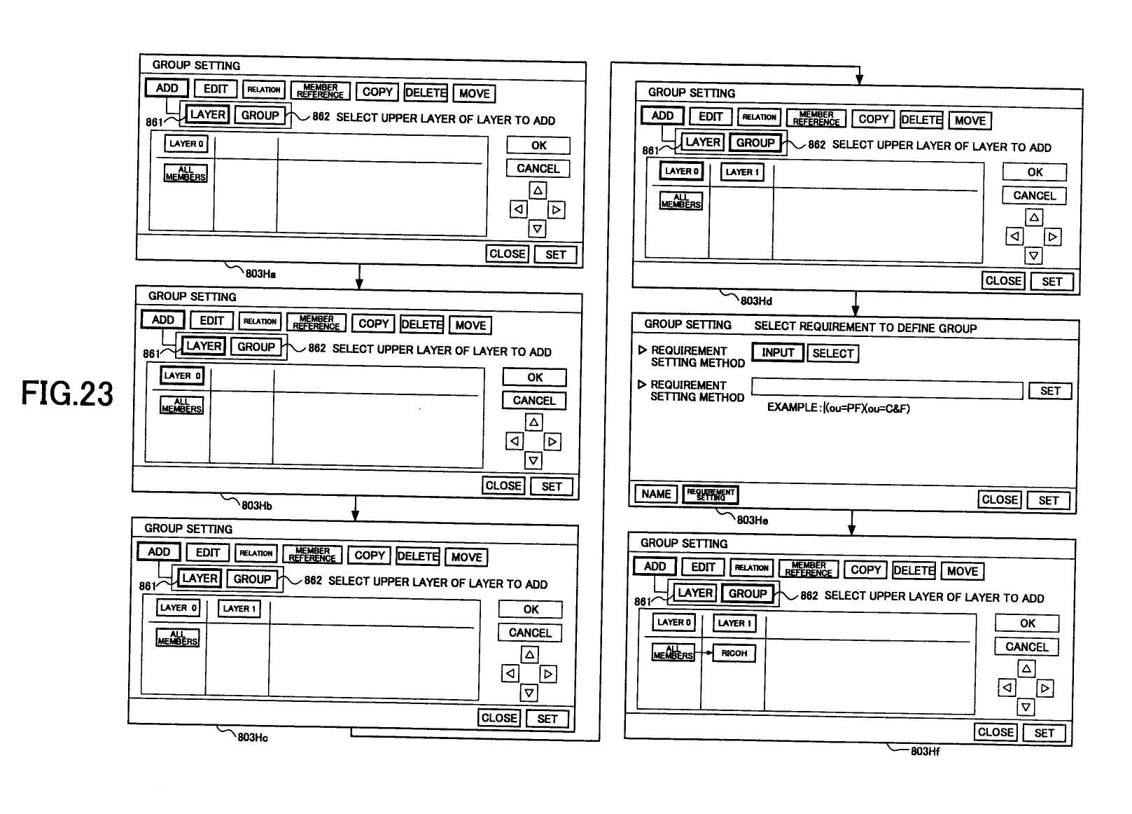

FIG. 21 shows a sequence diagram concerning display processing of the usage limitation setting page 802H shown in FIG. 20. When the ‘PF development member’ button is touched on the usage limitation setting page 802A of FIG. 16, the usage limitation setting page 802B appears as a replacement. Then, when the member reference button is touched on the usage limitation setting page 802B, a user information search request is transmitted to the UCS 168 from the SCS 169 (S110). In response thereto, from the UCS 168 to the LDAP server 401, a request is made for causing the LDAP server 401 to carry out search operation (S120). In response thereto, the LDAP server 401 returns a search result to the UCS 168 (S130). In response thereto, the UCS 168 provides user information thus obtained to the SCS 169 (S140). In response thereto, the above-mentioned usage limitation setting page 802H appears as a replacement. As the LDAP search requirement (filter), an LDAP search requirement such that the PF development members may be searched for is applied in this case. That is, the requirement for determining the PF development members set on the group setting page 803 is applied.

The SCS 169 can provide, as the group setting page 803, a group setting page 803 such that, operation of a group is achieved by icon operation of group icons, and icon operation of layer icons. As a result, it is possible to provide the group setting page 803 in which a hierarchical structure of groups is applied. The group icon represents a group, while the layer icon represents a layer included in the hierarchical structure of groups.

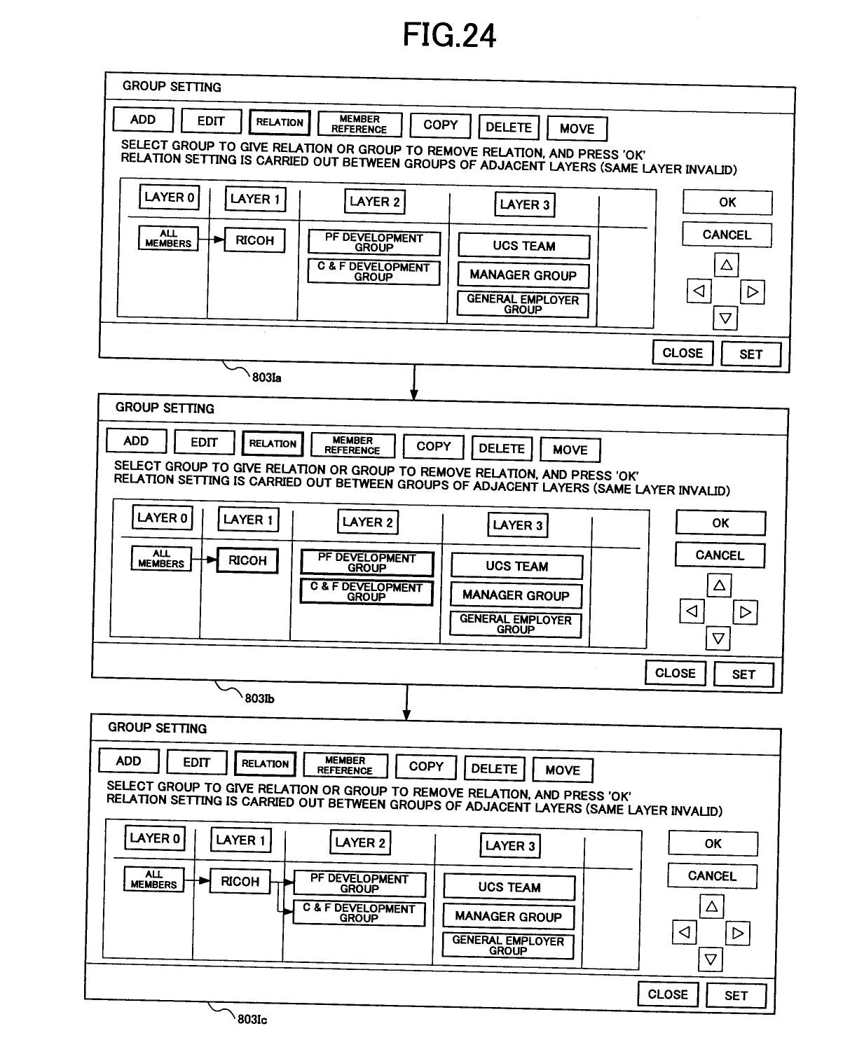

FIG. 22 shows a page of this group setting page 803. The group setting page 803G shown has buttons of add, edit, relation, member reference, copy, delete and move. The copy operation with the use of the copy button, the delete operation with the use of the delete button, the reference operation with the use of the member reference button are the same as those described above with reference to FIGS. 18, 19 and 20.

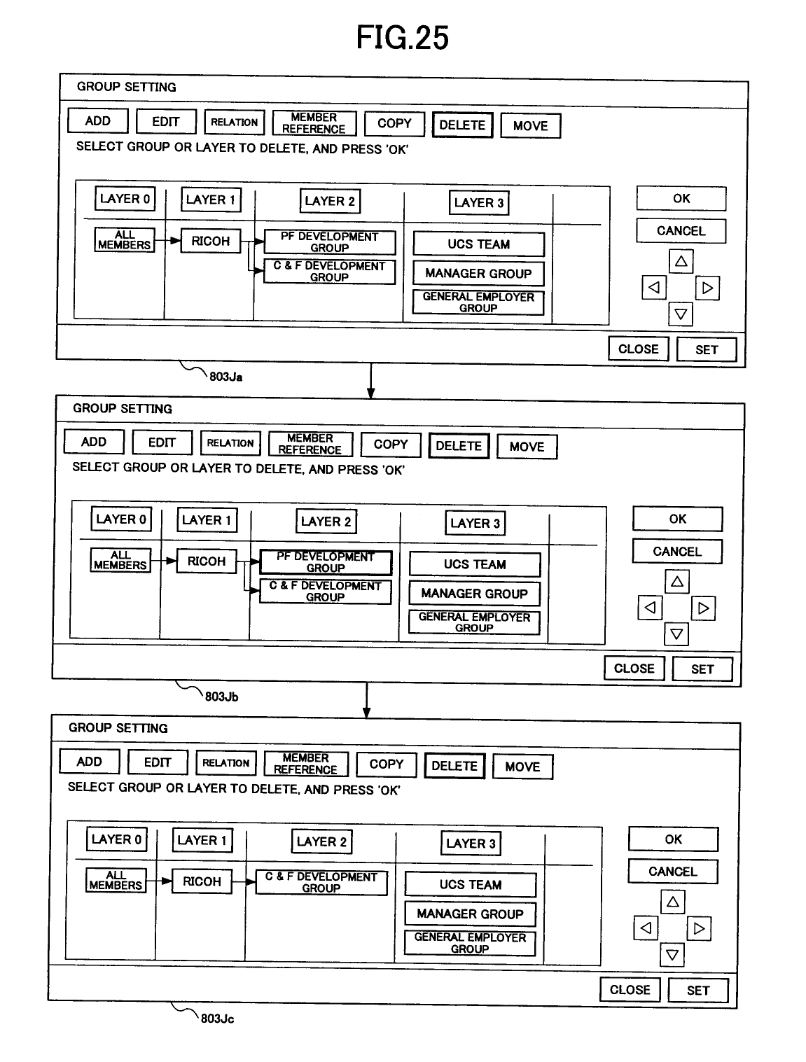

FIG. 23 shows a page transition diagram of the add operation. When the add button is touched on the group setting page 803G (FIG. 22), a layer button 861 and a group button 862 appear on the page as indicated in a group setting page 803Ha shown in FIG. 23. When a layer icon ‘layer 0’ is touched on the group setting page 803Ha, a group setting page 803Hb appears as a replacement. When an OK button is touched on the group setting page 803Hb, a layer icon ‘layer 1’ appears as shown on a group setting page 803Hc. When a group button 862 is touched on the group setting page 803Hc, a group setting page 803Hd appears. When a layer icon ‘layer 1’ is touched on the group setting page 803Hd, a group setting page 803He appears. The group setting page 803He is the same as the group setting page 803A shown in FIG. 17, and, with the use of the group setting page 803He, it is possible to set the requirement for defining a group as mentioned above. When a set button is touched on the group setting page 803He, a group icon ‘RICOH’ appears as shown in a group setting page 803Hf. This means that a group ‘RICOH’ is added to the layer ‘1’ which is lower than the layer ‘0’ in the hierarchical structure.

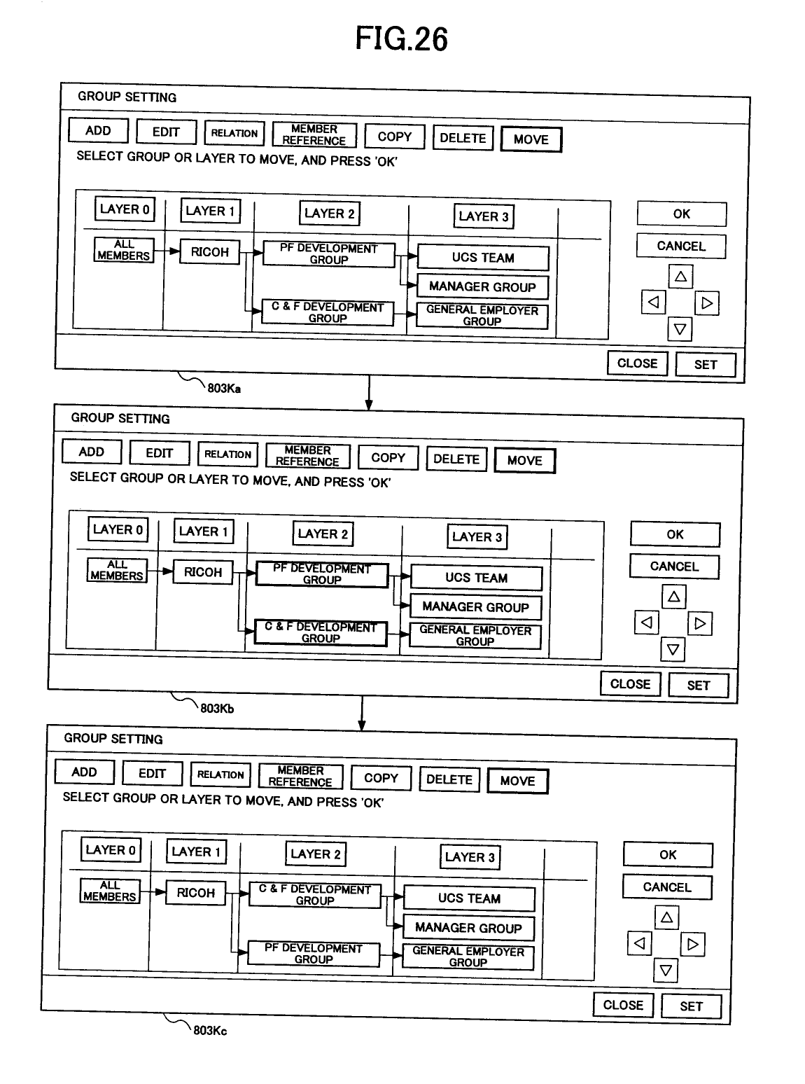

FIG. 24 shows a page transition diagram concerning relation operation. When a relation button of the group setting page 803G (FIG. 22) is touched, a group setting page 803Ia appears as a replacement. It is noted that, for the sake of simplification, it is assumed that various ones of add operation have been already carried out. When group icons ‘RICOH’, ‘PF development group’ and ‘C & F development group’ are touched, a group setting page 803Ib appears as a replacement. When an ‘OK’ button is touched on this page, as shown in a group setting page 803Ic, arrows connecting among the group icons ‘RICOH’, ‘PF development group’ and ‘C & F development group’ appear. This means that relation is given between the group ‘RICOH’ on the layer and each of the groups ‘PF development group’ and ‘C & F development group’ on the layer 2.

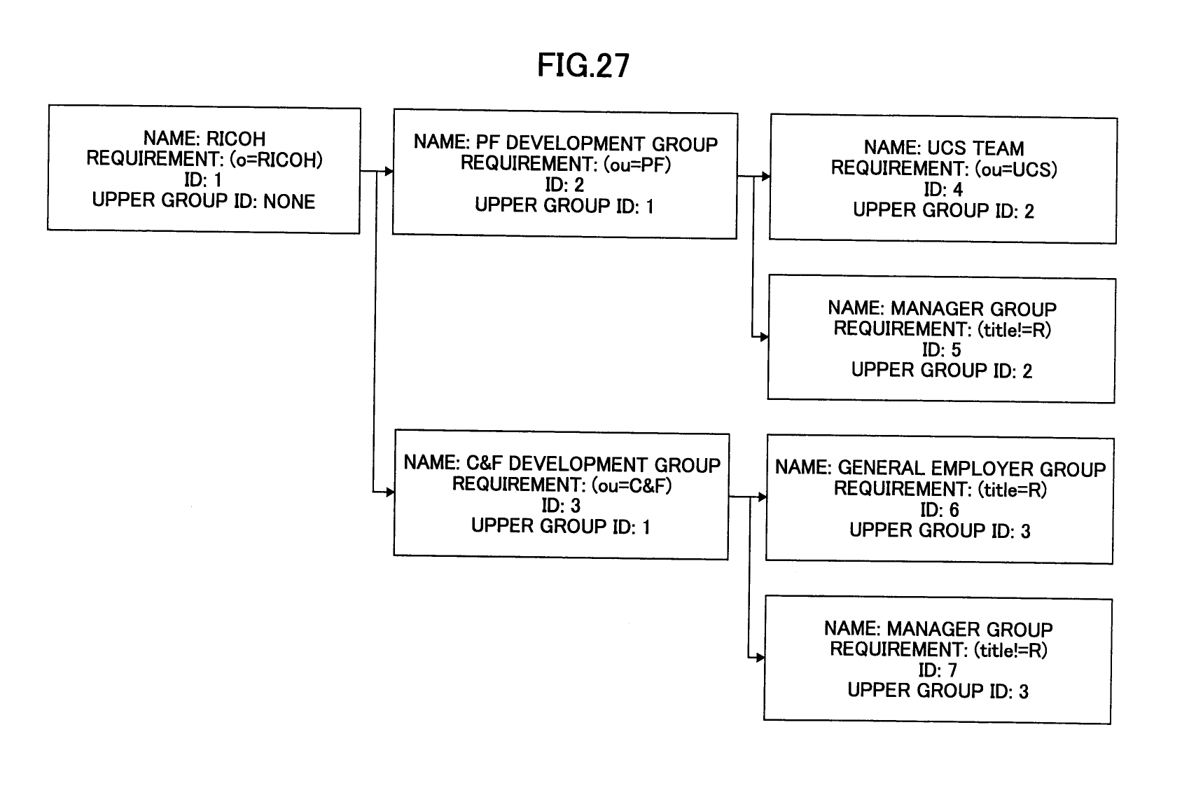

FIG. 25 shows a page transition diagram concerning delete operation. When a delete button is touched on the group setting page 803G (FIG. 22), a group setting page 803Ja appears as a replacement. It is noted that, for the sake of simplification, it is assumed that various one of add operations have been already carried out. When a group icon ‘PF development group’ is touched on the page, a group setting page 803Jb appears as a replacement. When an ‘OK’ button is touched on this page, as shown in a group setting page 803Jc, the group icon ‘PF development group’ disappears from the page. This means that the ‘PF development group’ is deleted from the layer 2. Simultaneously, an arrow concerning the group icon ‘PF devolvement group’ also disappears from the page. This means that a relation concerning the group ‘PF development group’ is deleted.

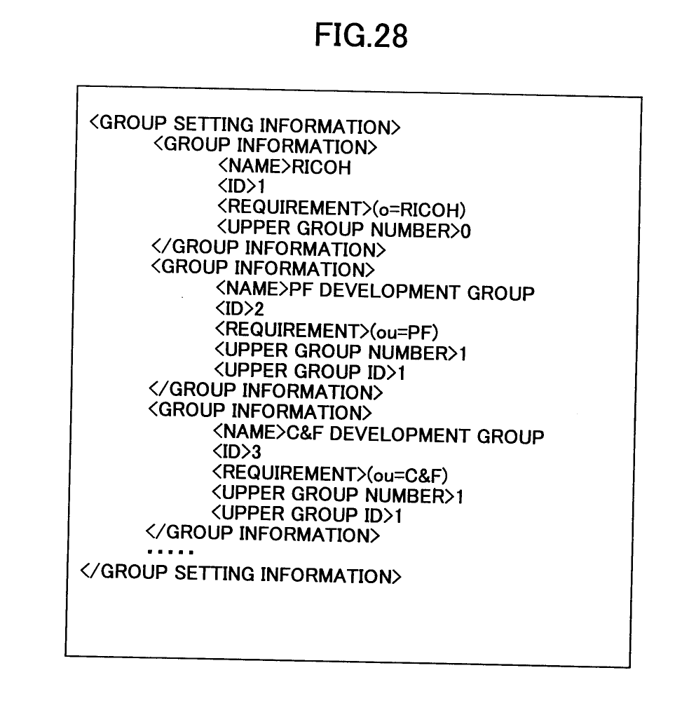

FIG. 26 shows a page transition diagram concerning move operation. When a move button is touched on the group setting page 803G (FIG. 22), a group setting page 803Ka appears as a replacement. It is noted that, for the sake of simplification, it is assumed that various ones of add operations have been already carried out. When group icons ‘PF development group’ and ‘C & F development group’ are touched on the page, a group setting page 803Kb appears as a replacement. When an ‘OK’ button is touched on this page, as shown in a group setting page 803Kc, positions of the group icons ‘PF development group’ and ‘C & F development group’ move or are exchanged therebetween on the page. On the other hand, arrows concerning the group icons ‘PF devolvement group’ and ‘C & F development group’ remain at the original positions.

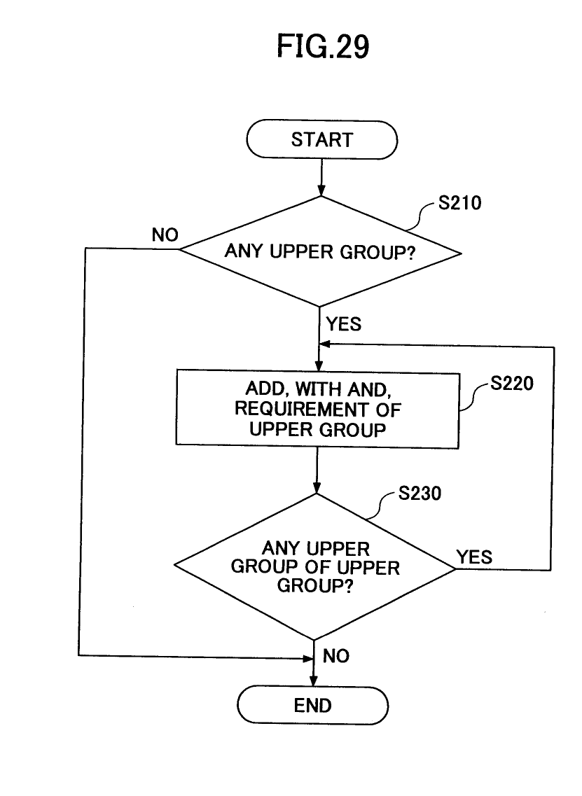

FIG. 27 shows the hierarchical structure of the groups set on the group setting page 803 shown in FIG. 22. Group icons (rectangles in the figure) represent respective groups, and arrows connecting among the group icons represent relation among the groups. When an arrow directed toward a group icon A from a group icon B exists, that is, when a relation directed toward the group A from the group B exists, the requirement defining the group A is taken over from by the group B as it is. For example, the requirement defining the group ‘PF development group’ takes over from the requirement defining the group ‘RICOH’ (& (o=RICOH) (ou=PF)). For example, the requirement defining a group ‘UCS team’ takes over from the requirement defining the group ‘RICOH’ and the requirement defining the group ‘PF development member’ (& (& (o=RICOH) (ou=PF) (ou=UCS)).

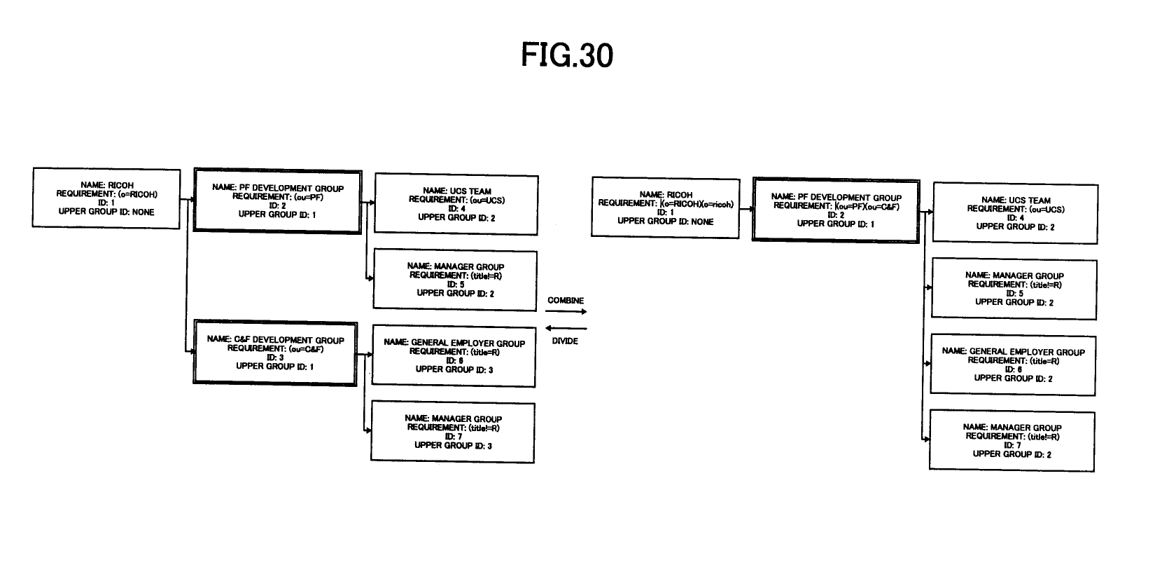

FIG. 28 shows XML (extensible markup language) data of the groups set on the group setting page 803 shown in FIG. 22. As shown, the group set on the group setting page 803 of FIG. 22 are thus set in the fusion machine 101 in a form thus described in XML. Set items of the group information are ‘group name’, ‘group requirement’, ‘group ID’, ‘upper group number’, ‘upper group ID, and so forth as shown.

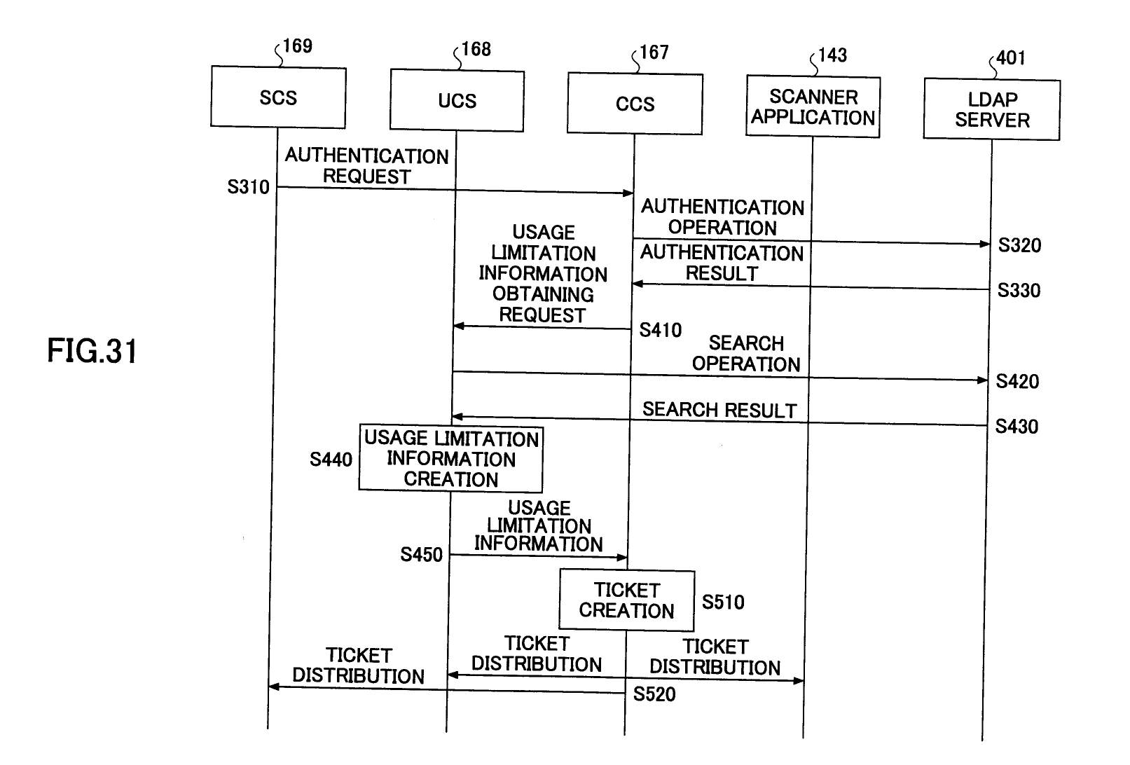

In the fusion machine 101, the UCS 168 executes ‘requirement creating processing’ for creating the requirements defining groups from the XML data. FIG. 29 shows a flow chart thereof. First, when an upper group exists above a requirement creating target group (S210), a requirement of the upper group is added to the requirement of the requirement creating target group with AND (S222). Further, when a further upper group exists above the above-mentioned upper group (S230), the requirement of the further upper group is added to the requirements of the requirement creating target group (S220). Such operation is repeated until no further upper group exists. It is noted that, when the only one upper group exists on the same rank, the requirement of the upper group is added with AND. However, when a plurality of upper groups exist on the same rank, the requirements including these upper groups connected with OR thereamong is then added with AND. Instead of thus adding the requirement of the upper group with AND, the requirement of a lower group may be added with OR to the requirement of the requirement creating target group.

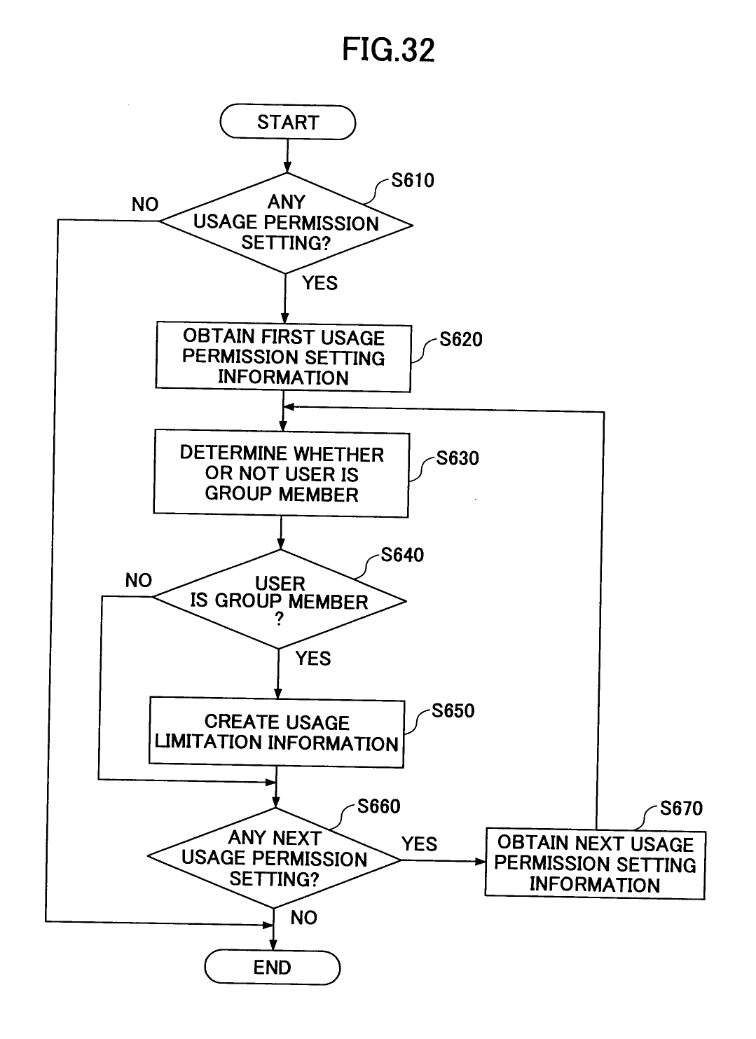

FIG. 30 illustrates combining operation combing a plurality of groups into one group, and dividing operation dividing one group into a plurality of groups. For example, on the group setting page shown in FIG. 22, groups may be combined together, with dragging operation of group icons. FIG. 30 illustrates a process of combining the ‘PF development group’ with the ‘C & F development group’ in view of group information. The requirement defining ‘PF development group’ is (ou=PF) before the combining. After the combining, the requirement of the group ‘C & F development group’ is taken therein, and thus, finally, the requirement of ‘PF development group becomes (|(ou=PF) (ou=C & F)). As shown in FIG. 30, reverse operation from the combining operation is the dividing operation.

By means of the setting operation shown in FIG. 15, in the fusion machine 101, the setting that the LDAP server 401 is caused to execute authentication of a user who uses the fusion machine 101 is made. By means of the setting operation shown in FIG. 16, in the fusion machine 101, the setting that usage permission is set for the PF development group in a lump. By means of the setting operation shown in FIG. 17, in the fusion machine 101, the PF development group is set such that whether or not a user belongs to the PF development group is determined by whether or not user information of the user managed by the LDAP server 401 meets the requirement ‘ou=PF’.

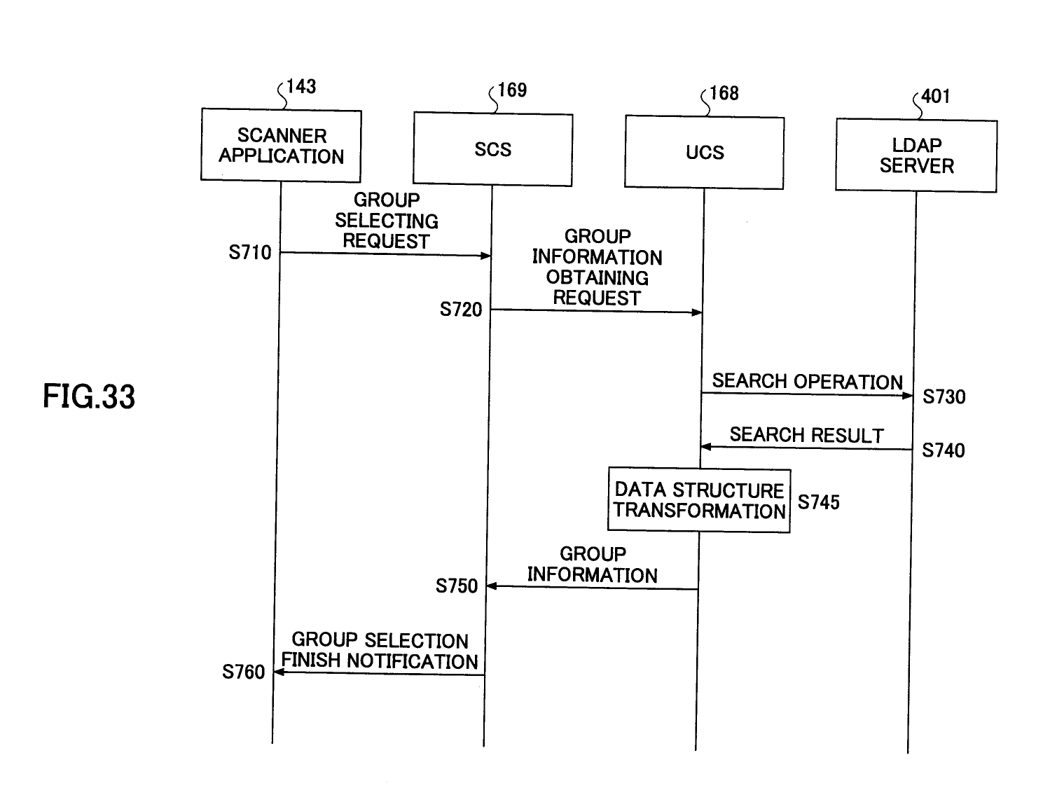

FIG. 31 shows a sequence diagram concerning the authentication processing and the usage limitation processing for a user who uses the fusion machine 101. When the user who uses the fusion machine 101 inputs authentication information for the purpose of logging-in in the fusion machine 101, an authentication request is transmitted to the CCS 167 from the SCS 169 (S310). In response thereto, the CCS 167 requests the LDAP server 401 to cause it to carry out authentication operation (S320). In response thereto, the LDAP server 401 returns an authentication result to the CCS 167 (S330). Then, the CCS 167 transmits a usage limitation information obtaining request to the UCS 168 (S410). In response thereto, the UCS 168 requests the LDAP server 401 to cause it to carry out user information search operation (S420). In response thereto, the LDAP server 401 returns a search result of the user information of the user, to the UCS 168 (S430). In response thereto, the UCS 168 creates usage limitation information indicating whether or not usage permission of each function of the fusion machine 101 is given to the user according to the thus-obtained user information (S440). In response thereto, the UCS 168 provides the thus-created usage limitation information to the CCS 167 (S450). In response thereto, the CCS 167 creates a ticket for each function of the fusion machine 101 (S510) and dispatches it (S520). The ticket indicates usage permission.

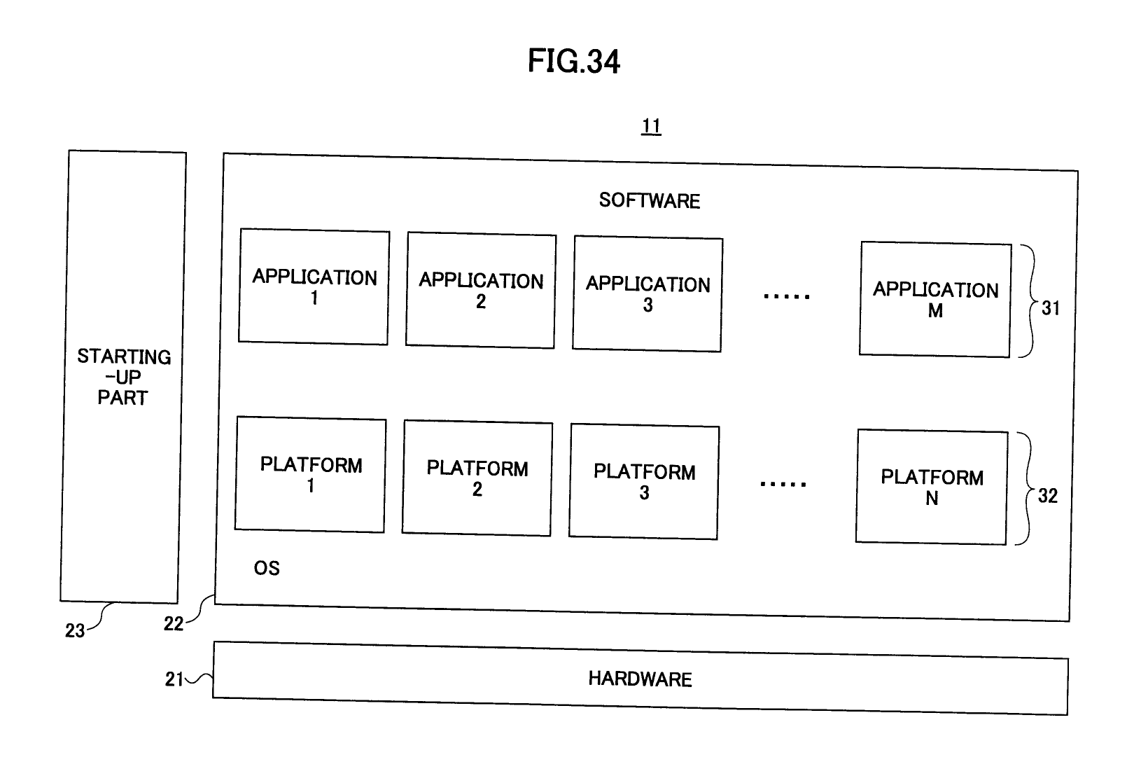

FIG. 32 shows a flow chart concerning the usage limitation information creating processing (S440) mentioned above. In the fusion machine 101, the setting of usage permission for each function of the fusion machine 101 is set for each group. The UCS 168 first obtains one item of usage permission setting information (S620) when the usage permission setting exists, and determines whether or not the above-mentioned user is the group member concerning the first item of usage permission (S630). When the user is the group member concerning the first item of usage permission setting (S640), the UCS 168 creates the usage limitation information according to the first item of usage permission setting information (S650). When a subsequent item of usage permission setting information (S660), the UCS 168 obtains it (S670), and repeats the same processing.

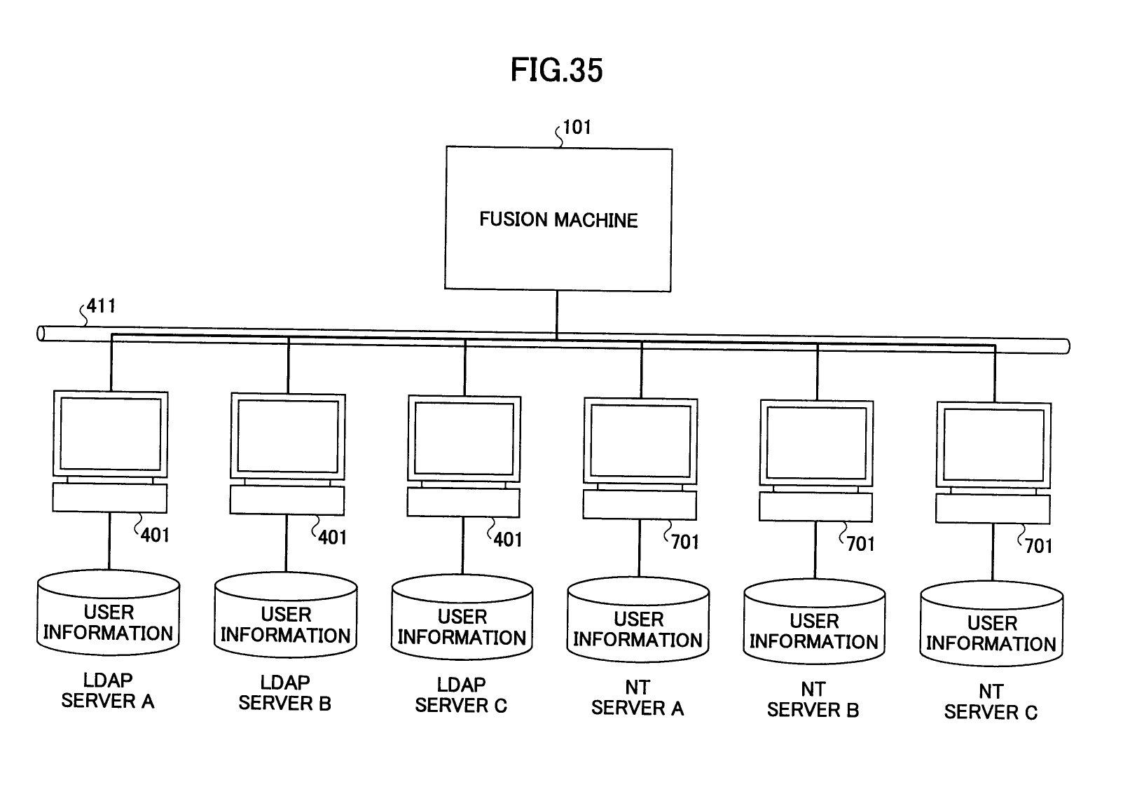

The groups set in the fusion machine 101 may also be applied as destinations such as electronic mail destinations, FAX destinations or such, in addition to applying them in the user authentication processing or the usage limitation processing as mentioned above. FIG. 33 shows a sequence diagram concerning processing in which the groups set in the fusion machine 101 are applied as the destinations. When a group set in the fusion machine 101 is selected as a destination, a group selecting request is transmitted to the SCS 169 from the scanner application 143 or such (S710). In response thereto, the SCS 169 transmits a group information obtaining request to the UCS 168 (S720). In response thereto, the UCS 168 requests the LDAP server 401 to cause it to carry out user information search processing for the users belonging to the group (S730). In response thereto, the LDAP server 401 returns a search result of the user information of the users belonging to the group to the UCS 168 (S740). In response thereto, the UCS 168 provides the group information to the SCS 169 (S750). In response thereto, the SCS 169 transmits a group selection finish notification to the scanner application 143 or such (S760). A data structure of the user information thus transmitted from the LDAP server 401 is, the same as in FIG. 8, transformed, between the processing of S740 and the processing of S750 (S745).

The fusion machine 101 shown in FIG. 1 corresponds to an information processing apparatus as one embodiment of the present invention, and information processing carried out by the fusion machine 101 of FIG. 1 corresponds to an information processing method as another embodiment of the present invention. A computer program for causing a computer to carry out the information processing corresponds to an information processing program in further another embodiment of the present invention. A CD-ROM in which the computer program is recorded corresponds to an information recording medium according to further another embodiment of the present invention.

A second embodiment according to the above-mentioned twenty-first through fiftieth aspects of the present invention is described next.

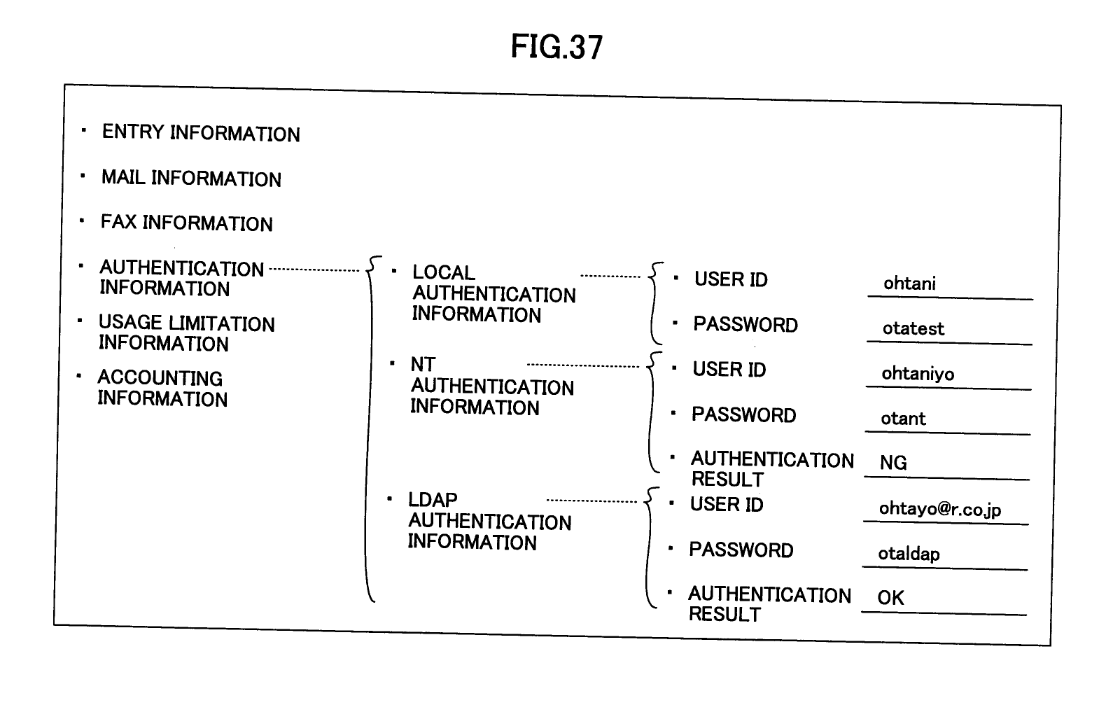

All the configurations and functions of the first embodiment described above with reference to FIGS. 1 through 13 are also applied to the second embodiment as they are, and the duplicated description is omitted. It is noted that, the configuration of the first embodiment of the present invention described above with reference to FIGS. 14 through 34 may be realized in a machine separate from a machine in which the configuration of the second embodiment of the present invention described next with reference to FIGS. 35 through 53. On the other hand, it is also possible that both the configuration of the first embodiment and the configuration of the second embodiment are included in a common machine where all the functions of the first and second embodiment of the present invention described with reference to FIGS. 1 through 53 are realized in the common machine in a combined manner or a fusion manner, while all the set of hardware configuration as shown in FIG. 2 of the fusion machine 101 may be applied in common therefor.

FIG. 35 shows a system configuration diagram concerning the fusion machine 101 according to the second embodiment. The fusion machine 101 shown in FIG. 1 is connected with three LDAP servers 401 (LDAP servers A, B and C) via a communication network 411, and acts as a client of the LDAP serves 401. The fusion machine 101 is in this case further connected with three NT servers 701 (NT serves A, B and C) also via the communication network 411, and act as a client thereof.

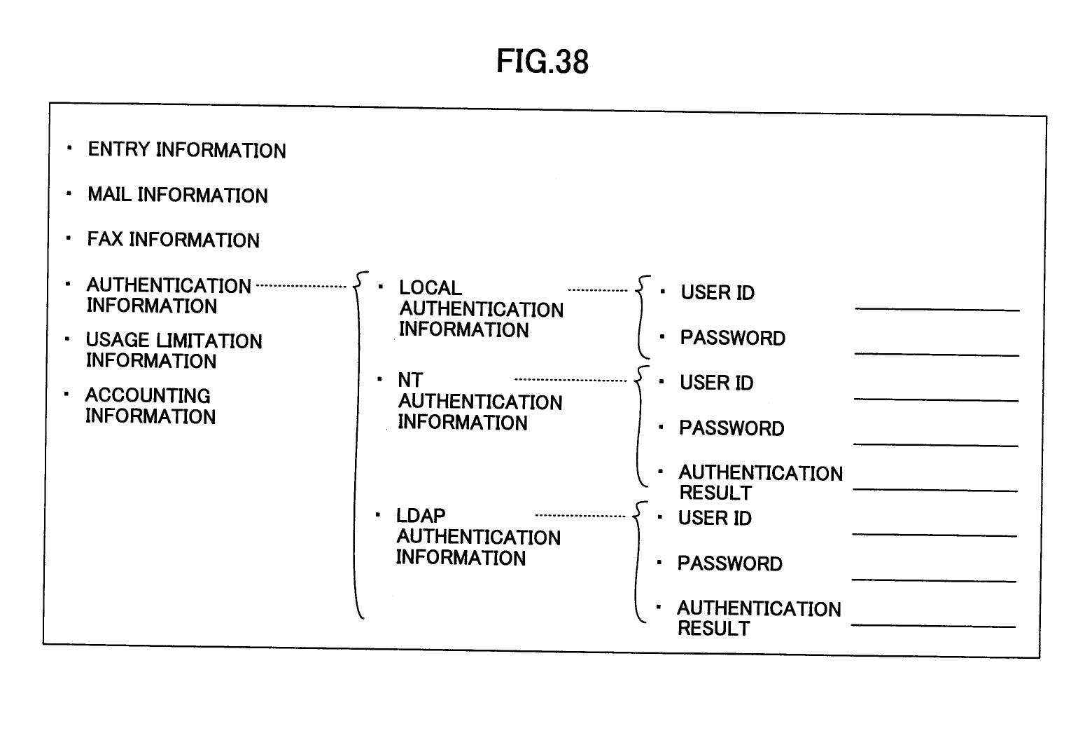

FIG. 36 shows one example of an authentication setting page 1801 according to the second embodiment. The authentication setting page 1801 is a setting page for making in the fusion machine 101 a setting concerning authentication processing of a user who uses the fusion machine 101. The SCS 169 carries out a function providing the authentication setting page 1801, and the CCS 167 carries out a function of managing a setting made with the use of the authentication setting page 1801. The authentication setting page is displayed on the touch panel 311, and setting operation to be carried out on the authentication setting page 1801 is achieved with finger touching operation made on the touch panel 311 by a user.

A button 1811 of FIG. 36 is a button for making a setting in the fusion machine 101 that authentication processing of a user who uses the fusion machine 101 is carried out by the fusion machine 101 itself. When the button 1811 is touched on this setting page, and a set button thereon is also touched, the setting that authentication processing of a user who uses the fusion machine 101 is carried out by the fusion machine 101 itself is made in the fusion machine 101.

A button 1812 is a button for making a setting in the fusion machine 101 that authentication processing of a user who uses the fusion machine 101 is carried out by the NT server 701. When the button 1812 is touched on this setting page, and a set button thereon is also touched, the setting that authentication processing of a user who uses the fusion machine is carried out by the NT server 701 is made in the fusion machine 101. Information indicating which of the NT servers 701 is caused to carry out the authentication information and sever information of the NT server 701 are previously set.

A button 1813 is a button for making a setting in the fusion machine 101 that authentication processing of a user who uses the fusion machine 101 is carried out by the LDAP server 401. When the button 1813 is touched on this setting page, and a set button thereon is also touched, the setting that authentication processing of a user who uses the fusion machine is carried out by the LDAP server 401 is made in the fusion machine 101. Information indicating which of the LDAP servers 401 is caused to carry out the authentication information and sever information of the LDAP server 401 are previously set.

Thus, the fusion machine 101 of FIG. 1 has functions of carrying out these three types of authentication methods, i.e., local authentication, NT authentication and LDAP authentication. Therefore, in authentication information of a user who uses the fusion machine 101, three types of authentication information, i.e., local authentication information, NT authentication information and LDAP authentication information are included. In the fusion machine 101, by a function of the UCS 168, these three types of authentication information for a user who uses the fusion machine 101 can be stored in a common single entry. Accordingly, it is possible to provide relationship between these types of authentication information for the same user, as a result of storing and managing the authentication information of the same user in a common single entry.

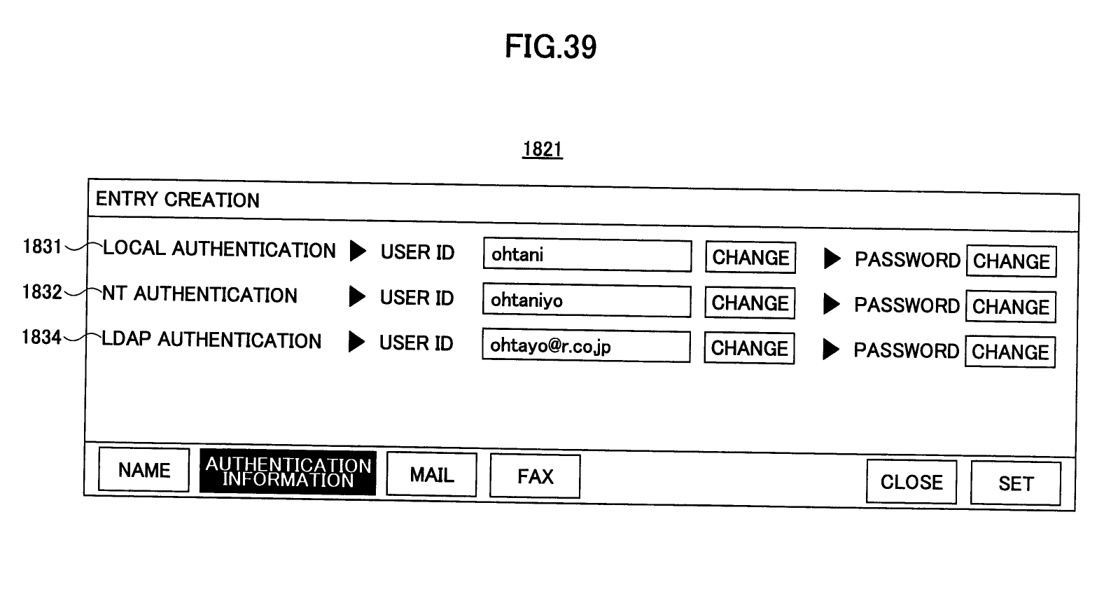

FIG. 37 shows a conceptual diagram of an entry according to the second embodiment storing therein the three types of authentication information for a user who uses the fusion machine 101 shown in FIG. 1. In the entry shown in FIG. 37, entry information of the relevant user, mail information, FAX information, authentication information, usage limitation information, accounting information and so forth are stored. In the entry shown in FIG. 37, authentication information (local authentication information) applied when authentication processing of the relevant user is executed by the fusion machine 101 itself (local authentication); authentication information (NT authentication information) applied when authentication processing of the relevant user is executed by the NT server 701 (NT authentication); and authentication information (LDAP authentication information) applied when authentication processing of the relevant user is executed by the LDAP server 401 (LDAP authentication) are stored.

Each of the local authentication information, the NT authentication information and the LDAP authentication information includes a user ID and a password, concerning the respective one of the local authentication, the NT authentication, and the LDAP authentication. Also in the entry of FIG. 37, authentication results obtained from carrying out with the use of the NT authentication information or the LDAP authentication information are stored as well as the NT authentication information and the LDAP authentication information themselves.

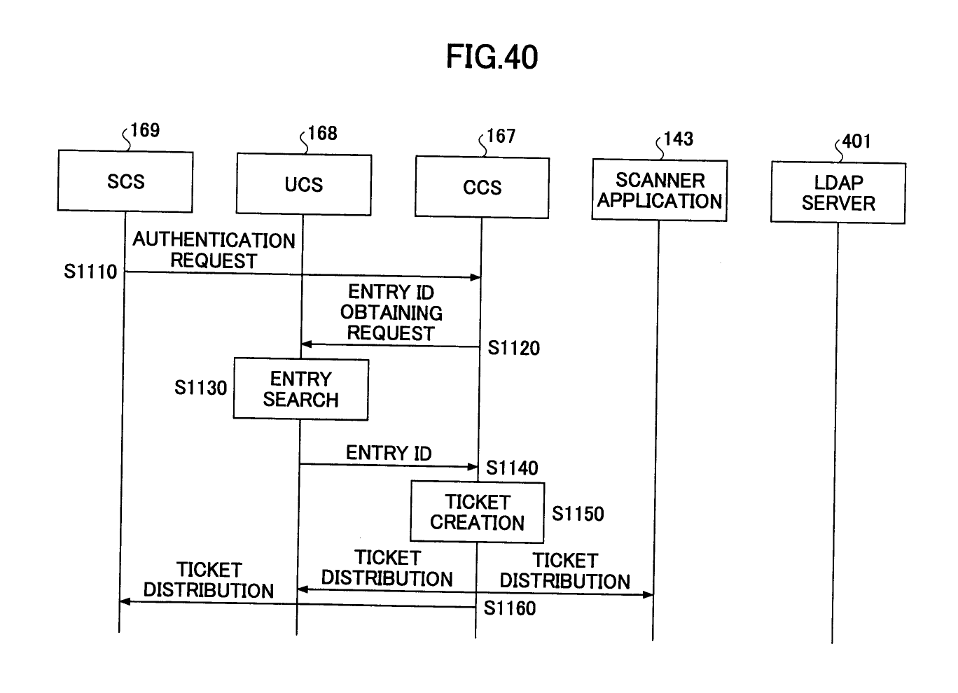

FIG. 38 shows a conceptual diagram of an entry according to the second embodiment for storing therein the three types of authentication information who uses the fusion machine 101 shown in FIG. 1. In the entry shown in FIG. 38, entry information of the relevant user, mail information, FAX information, authentication information, usage limitation information, accounting information and so forth can be stored. In the entry shown in FIG. 38, authentication information (local authentication information) applied when authentication processing of the relevant user is executed by the fusion machine 101 itself (local authentication); authentication information (NT authentication information) applied when authentication processing of the relevant user is executed by the NT server 701 (NT authentication); and authentication information (LDAP authentication information) applied when authentication processing of the relevant user is executed by the LDAP server 401 (LDAP authentication) can be stored.

Each of the local authentication information, the NT authentication information and the LDAP authentication information includes a user ID and a password, concerning the respective one of the local authentication, the NT authentication, and the LDAP authentication. Also in the entry of FIG. 38, authentication results obtained from carrying out with the use of the NT authentication information or the LDAP authentication information can be stored as well as the NT authentication information and the LDAP authentication information themselves.

A first entry creating page according to the second embodiment of the present invention is described next.

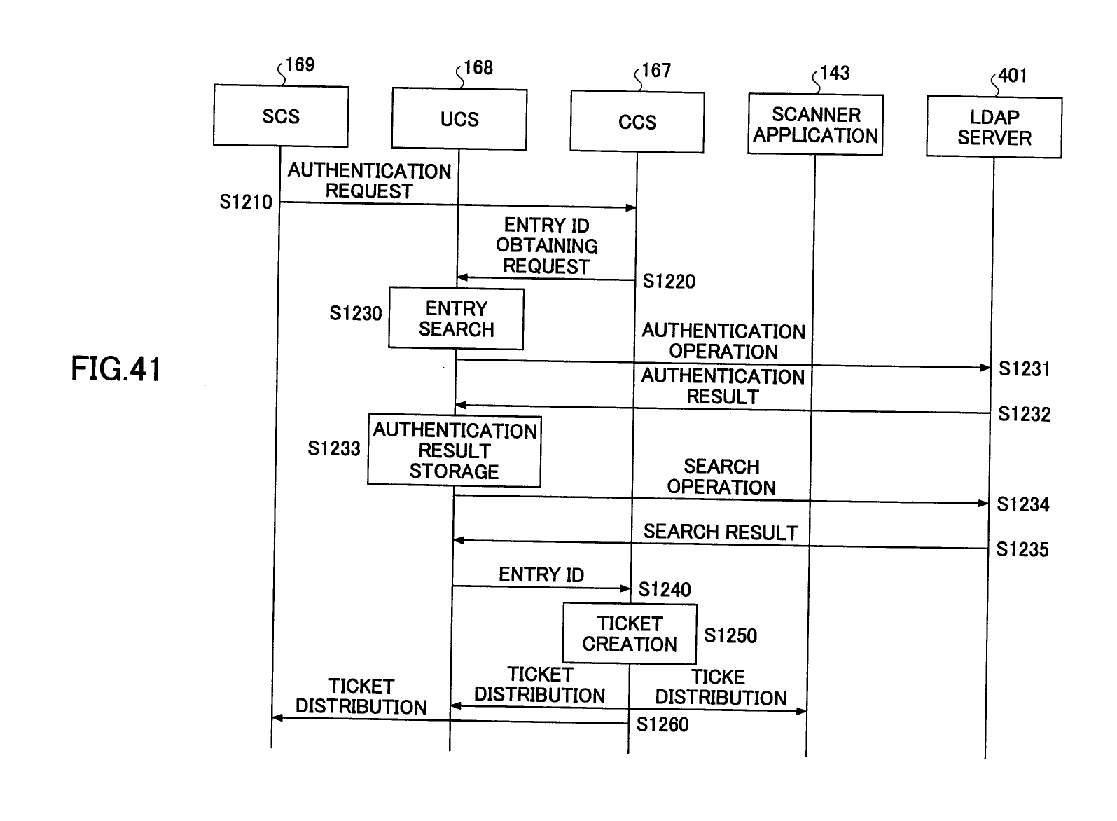

FIG. 39 shows an entry creating page 1821 for creating the entry shown in FIG. 37. With the use the entry creating page 1821, it is possible to designate a plurality of types of authentication information for a user who uses the fusion machine 101, for creating the entry in which the plurality of types of authentication information for the user who uses the fusion machine 101 are stored. The SCS 169 has a function of providing the entry creating page 1821, and the UCS 168 has a function of creating the entry in which a plurality of types of authentication information for a user who uses the fusion machine 101 are stored. The entry creating page 1821 is displayed on the touch panel 311, and setting operation with the use of the entry creating page 821 is achieved by finger touch operation or such by a user.

On the entry creating page of FIG. 39, a designating line 1831 shown is a designating line for designating local authentication information for a user who uses the fusion machine 101. A designating line 1832 shown is a designating line for designating NT authentication information for a user who uses the fusion machine 101. A designating line 1833 shown is a designating line for designating LDAP authentication information for a user who uses the fusion machine 101. When a set button is touched on this page after the local authentication information, the NT authentication information and the LDAP authentication information are designated on these designating lines 1831, 1832 and 1833, respectively, an entry is created in the fusion machine 101 as an entry in which authentication information for a user who uses the fusion machine 101, in which the local authentication information, the NT authentication information and the LDAP authentication information designated on these designating lines 1831, 1832 and 1833, respectively, on the entry creating page 1821 shown in FIG. 39 are stored.

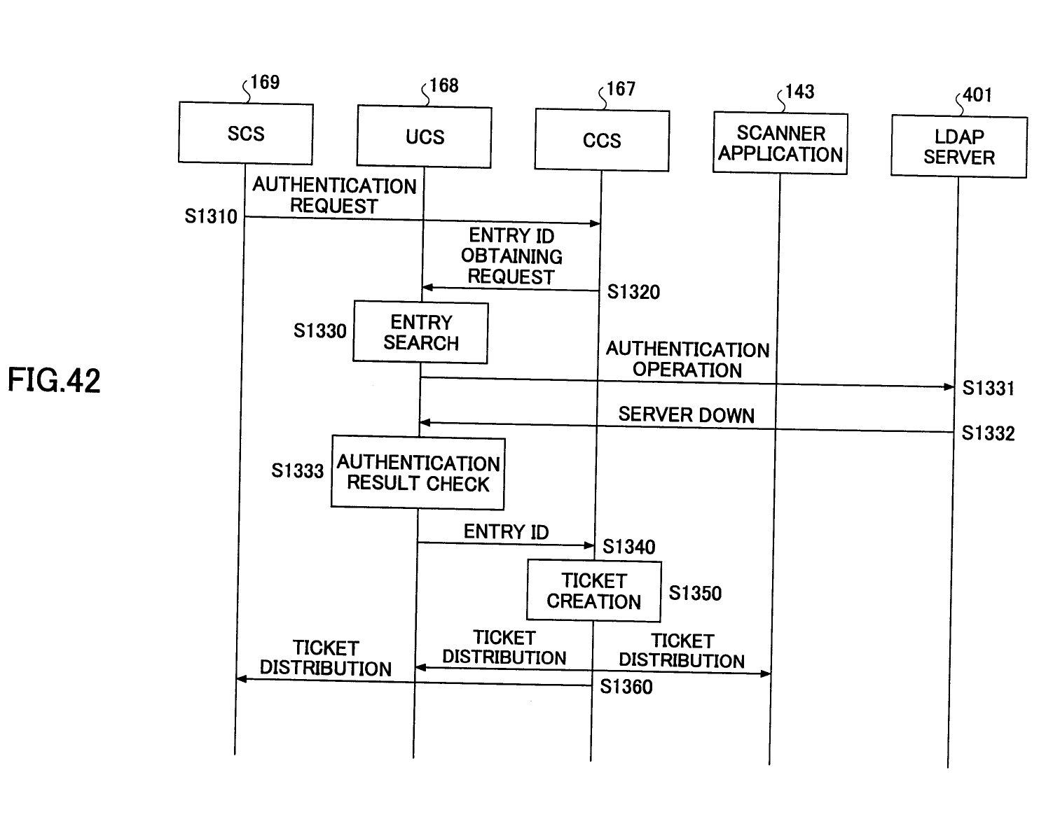

FIG. 40 shows a sequence diagram of authentication processing for a user who uses the fusion machine 101. There, it is assumed that a setting carried out on the authentication setting page 1801 shown in FIG. 36 is as a setting for the local authentication.

When a user who uses the fusion machine 101 inputs local authentication information in the fusion machine 101 for the purpose of logging-in in the fusion machine 101, the SCS 169 transmits an authentication request to the SCS 169 (S1110). In response thereto, the CCS 167 transmits an entry ID obtaining request to the UCS 168 (S1120). In response thereto, the UCS 168 caries out entry search for obtaining the entry ID in which the local authentication information is stored (S1130). Then, after carrying out authentication processing with the use of the thus-obtained local authentication information, the UCS 168 provides the entry ID to the CCS 167 (S1140) when the authentication is passed. In response thereto, the CCS 167 creates a ticket for each function and dispatches it (S1150 and S1160).

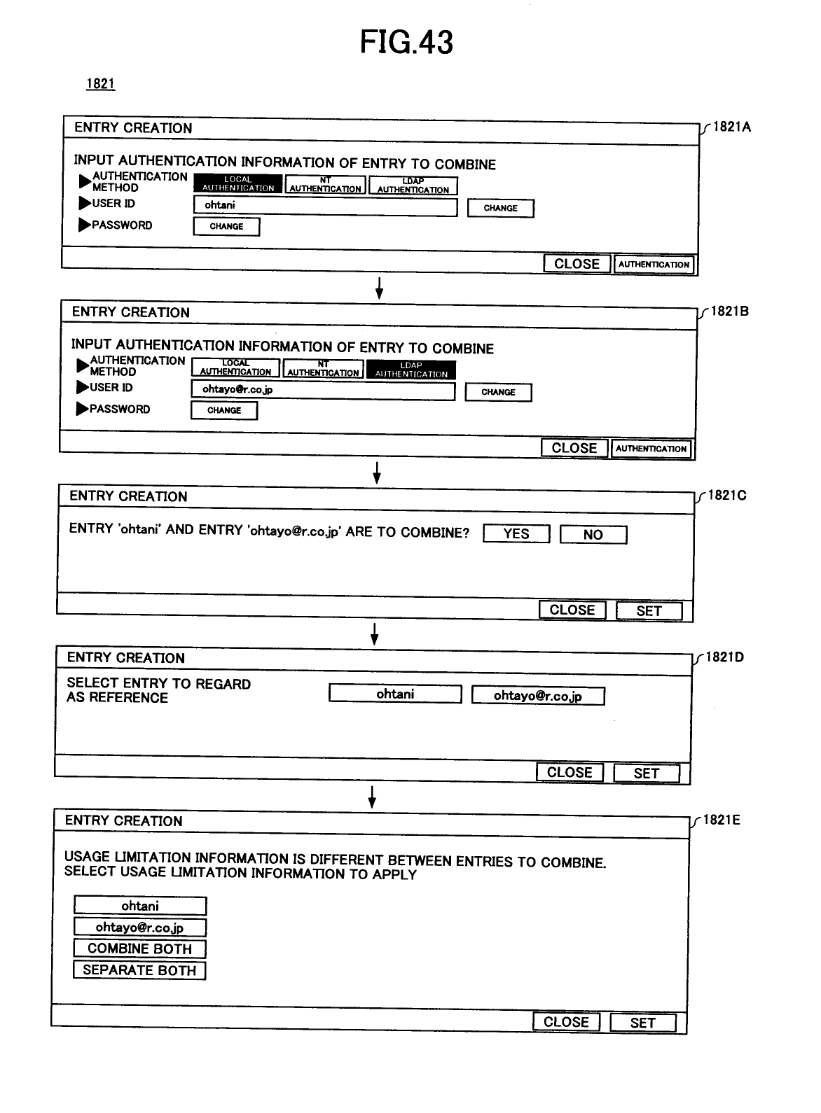

FIG. 41 shows a sequence diagram of authentication processing for a user who uses the fusion machine 101 in another example. There, it is assumed that a setting carried out on the authentication setting page 1801 shown in FIG. 36 is a setting for the LDAP authentication with the use of the relevant LDAP authentication information managed by the LDAP server 401, in this case. However, it is also assumed that authentication information which should be input to the fusion machine 101 when a user who uses the fusion machine 101 logs-in in the fusion machine 101 is local authentication information.

When a user who uses the fusion machine 101 inputs local authentication information in the fusion machine 101 for the purpose of logging-in in the fusion machine 101, the SCS 169 transmits an authentication request to the SCS 169 (S1210). In response thereto, the CCS 167 transmits an entry ID obtaining request to the UCS 168 (S1220). In response thereto, the UCS 168 carries out entry search for obtaining the entry ID in which the local authentication information is stored for obtaining the LDAP authentication information (S1230). As mentioned above, according to the second embodiment of the present invention, both the local authentication information and the LDAP authentication information are stored in the common single entry. Accordingly, by obtaining the entry ID of the entry storing the thus-input local authentication information, it is possible to obtain the LDAP authentication information for the same user therefrom.

Then, the UCS 168 requests the LDAP server 401 to cause it to carry out authentication processing with the use of the LDAP authentication which is thus obtainable from the relevant entry managed by the LDAP server 401 (S1231). In response thereto, the LDAP server 401 returns an authentication result of the thus-carried out authentication processing with the use of the LDAP authentication information (S1232). In response thereto, the UCS 168 stores this authentication result in the above-mentioned entry of the same user (S1233). Then, when the authentication result indicates that the authentication is passed, the UCS 168 requests the LDAP server 401 to cause it to carry out a search operation for the user information (S1234). In response thereto, the LDAP server 401 returns a search result to the UCS 168. In response thereto, the UCS 168 refers to the thus-obtained user information, and provides the entry ID to the CCS 167 (S2240). In response thereto, the CCS 168 creates a ticket for each function of the fusion machine 101, and dispatches it (S1250, S1260).

Thus, according to the second embodiment, logging-in setting of the fusion machine 101 is such that, when a user who uses the fusion machine 101 logs-in, the local authentication information should be input without regard to actually which of the local authentication, the NT authentication and the LDAP authentication is applied in the authentication setting of the fusion machine 101. Thus, a so-called ‘single sign-on’ way is achieved in a pseudo manner. Thereby, authentication information to be input to the fusion machine 101 when a user who uses the fusion machine 101, is limited to the local authentication information. As a result, it is possible to reduce an authentication information managing load of the user.

FIG. 42 shows a sequence diagram concerning user authentication processing for a user who uses the fusion machine 101 in further another example. Here, the setting made on the authentication setting page shown in FIG. 36 is a setting for the LDAP authentication information. However, it is also assumed in this case that the LDAP server 401 is accidentally shut down and thus, the LDAP authentication which should be carried out by the LDAP server 401 can not be executed.

When local authentication information is input to the fusion machine 101 for the purpose that a user who uses the fusion machine 101 should log-in in the fusion machine 101, the SCS 169 transmits an authentication request to the CCS 167 (S1310). In response thereto, the CCS 167 transmits an entry ID obtaining request to the UCS 168 (S1320). In response thereto, the UCS 168 carries out entry search operation for obtaining an entry ID storing the local authentication information for obtaining the LDAP authentication information (S1330). Then, the UCS 168 requests the LDAP server 401 to cause it to carry out authentication processing with the use of the LDAP authentication information (S1331) same as in the above-mentioned case of FIG. 41. Thereby, the UCS 168 recognizes that the LDAP server 401 is shut down (S1332). In this case, the UCS 168 determines whether or not the authentication of the user should be passed, based whether or not an authentication result of the LDAP authentication obtained at the previous occasion for the same user stored in the above-mentioned entry (S1333). Then, the UCS 168 provides the entry ID to the CCS 167 (S1340) when the authentication result at the previous occasion indicates that the authentication is passed. In response thereto, the CCS 167 creates a ticket for each function of the fusion machine 101, and dispatch it (S1350, S1360). It is noted that, although the user information managed by the LDAP server 401 cannot be obtained from the LDAP 401 since the LDAP server is shut down in this case, the fusion machine 101 may have a copy of the same entry previously, or the side of the fusion machine 101 may hold the entry rather than the LDAP server 401.

Thus, even when user authentication processing to be carried out with the use of the NT authentication information or the LDAP authentication information cannot be actually executed, authentication of the user can be passed based on an authentication result of authentication processing carried out at the previous occasion for the same user with the use of the NT authentication information or the LDAP authentication information.

In the fusion machine 101 according to the second embodiment, it is possible to store local authentication information, NT authentication information as LDAP authentication information for the same user in the same entry, and manage there. Thereby, user information of the same user can be referred to from the same entry without regard to which of local authentication, NT authentication and LDAP authentication is authentication resting of the fusion machine 101.

A second entry creating page according to the second embodiment of the present invention is described next.

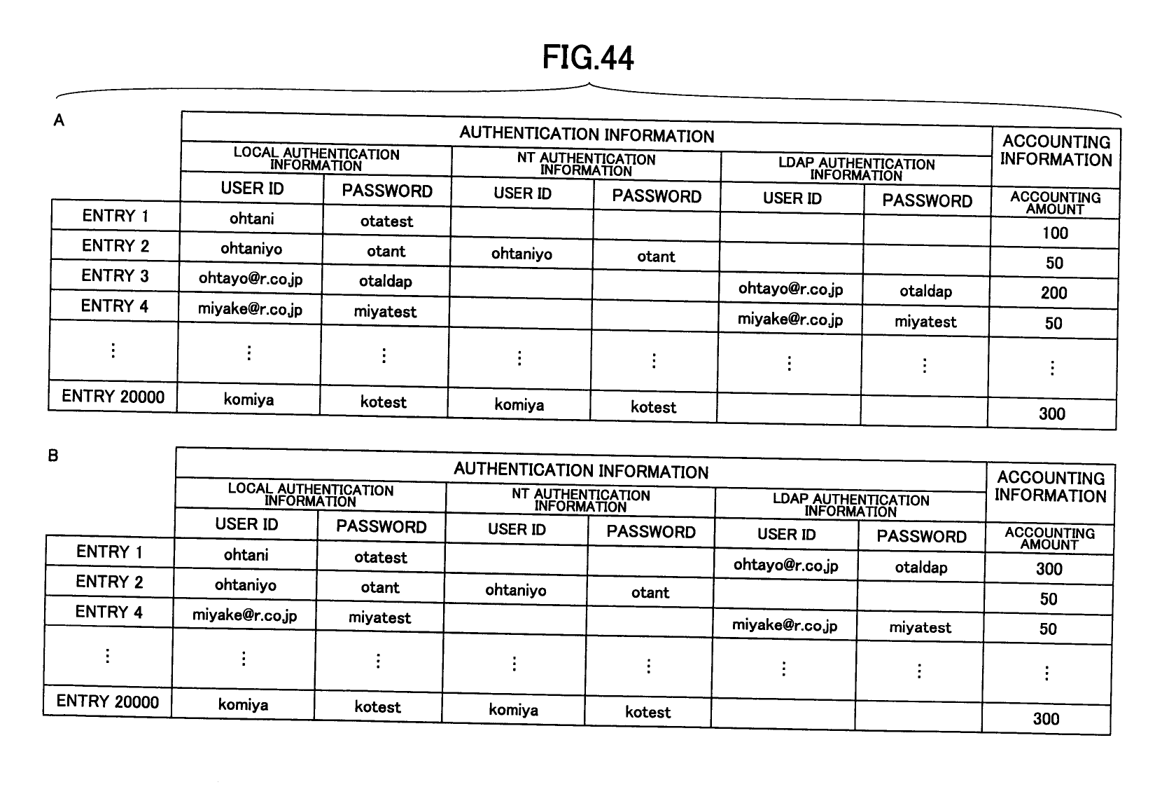

FIG. 43 shows another entry creating page 1821 for creating the entry shown in FIG. 37. With the use of the entry creating page 1821, it is possible to designate a plurality of entries in which a plurality of types of authentication information for a user who uses the fusion machine 101 of FIG. 1, for the purpose of creating an entry in which the plurality of types of authentication information are stored. The SCS 169 has a function of providing the entry creating page 1821 for creating an entry for storing therein a plurality of types of authentication information for a user who uses the fusion machine 101 and the UCS 168 has a function of creating the entry storing the plurality of types of authentication information for the user who uses the fusion machine 101. The entry creating page 1821 is displayed on the touch panel 311, and setting operation with the use of the entry creating page 1821 is achieved with finger touch operation on the touch panel 311 or such.

An entry setting page 1821A of FIG. 43 shows a state in which local authentication information is designated for the purpose that an entry storing therein the local authentication information for a user who uses the fusion machine 101. When an authentication button is touched on this page, an entry creating page 1821B appears as a replacement.

In this entry creating page 1821B, a state is shown in which LDAP authentication information is designated for the purpose that an entry storing therein the LDAP authentication information for a user who uses the fusion machine 101 is to be designated. When an authentication button is touched on this page, an entry creating page 1821C appears as a replacement.

This entry creating page 1821c is an inputting page on which instructions are input by a user as to whether or not the entry designated on the entry creating page 1821A and the entry designated on the entry creating page 1821B should be combined together. The entry designated on the entry creating page 1821A is the entry in which the local authentication information ‘obtain’ is stored. The entry designated on the entry creating page 1821B is the entry in which the LDAP authentication information ‘ohtayo@r.co.jp’ is stored. When a ‘Yes’ button is touched on the entry creating page 1821C, and also, a ‘set’ button is touched on the page, an entry creating page 1821D appears as a replacement.

This entry creating page 1821D is a designating page on which, which of the entry already designated on the entry creating page 1821A and the entry already designated on the entry creating page 1821B should be regarded as a base when the entries are combined. When a set button is touched on this page, an entry creating page 1821E appear as a replacement.

This entry creating page 1821E is a designating page on which a designation is made as to which of usage limitation information, which each of the relevant entries originally has, is applied when the entry designated on the entry creating page 1821A and the entry designated on the entry creating page 1821B are combined. This page is displayed when the usage limitation information of the entry designated on the entry creating page 1821A is different from usage limiting information the entry designated on the entry creating page 1821B. When a set button is touched on this page, the entry creating page 1821 finishes.

Thereby, the entry designated on the entry creating page 1821A and the entry designated on the entry creating page 1821B are combined, and then, as an entry storing therein authentication information for a user who uses the fusion machine 101 of FIG. 1, the entry is created in the fusion machine 101 storing therein the local authentication information of the former entry and the LDAP authentication information of the latter entry. It is noted that the entry designated on the entry creating page 1821D is applied as a base of the thus-created entry, and the usage limitation information designated on the entry creating page 1821E is applied as the usage limitation information of the newly created entry.

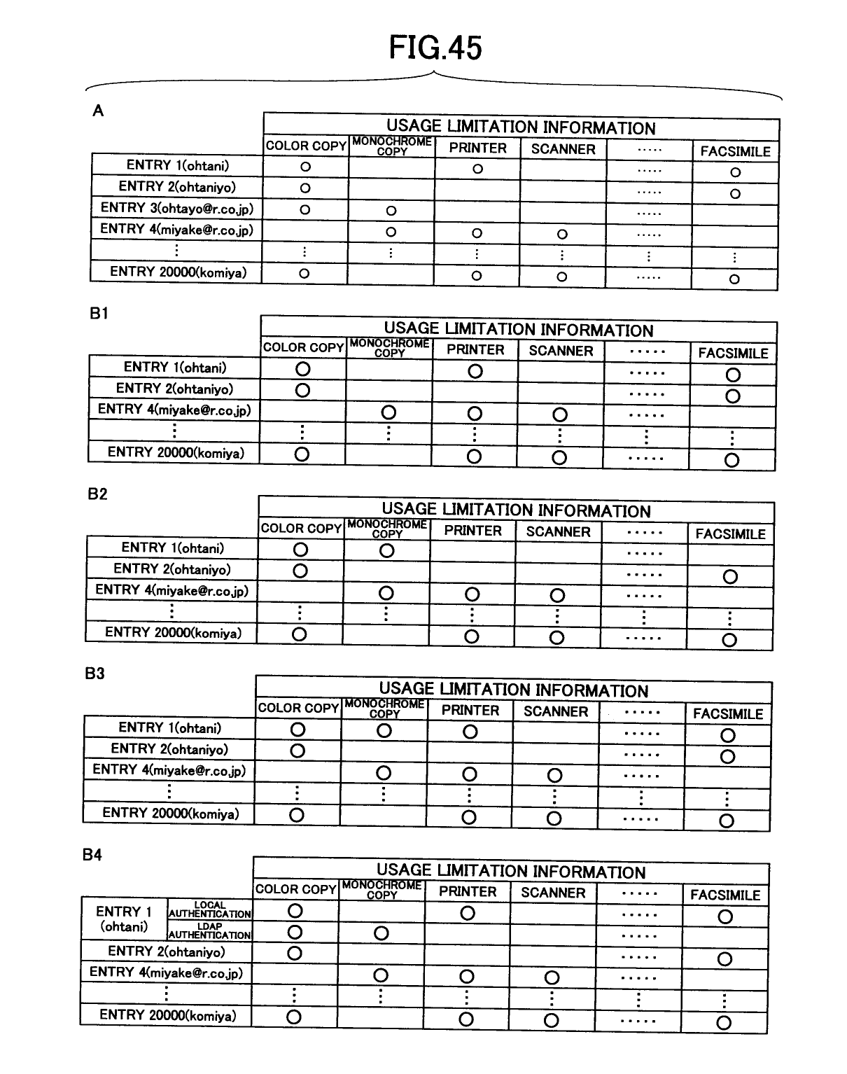

FIG. 44 shows lists of entries in the fusion machine 101. FIG. 44, A shows a list of entries before the combining processing described above with reference FIG. 43 is carried out, and a list of FIG. 44, B is a list after the combining operation is carried out. An entry 1 shown in FIG. 44, A corresponds to the entry designated on the entry creating page 1821A, while an entry 3 shown in FIG. 44, A corresponds to the entry designated on the entry creating page 1821B. An entry 1 shown in FIG. 44, B corresponds to the newly created entry. In this example of FIG. 44, it is assumed that the entry 1 of FIG. 44, A is designated on the entry creating page 1821D, and as a result, the newly created entry has the same name ‘entry 1’ in FIG. 44, B. An accounting amount ‘300’ in the entry 1 of FIG. 44, B is one obtained as a result of an accounting amount ‘100’ in the entry 1 of FIG. 44, A and an accounting amount ‘200’ in the entry 3 of FIG. 44, A being added together. The same as in this example, an accounting amount of a newly created entry becomes one obtained as a result of accounting amounts of respective ones of a plurality entries designated on the entry creating page 1821 of FIG. 43 being added together.

FIG. 45 shows lists of entries in the fusion machine 101 in another example. FIG. 45, A shows a list of entries before the combining processing described above with reference FIG. 43 is carried out, and respective lists of FIG. 45, B1, B2, B3 and B4 are those after the combining operation is carried out. An entry 1 shown in FIG. 45, A corresponds to the entry designated on the entry creating page 1821A, while an entry 3 shown in FIG. 45, A corresponds to the entry designated on the entry creating page 1821B. An entry 1 shown in each of FIG. 45, B1, B2, B3 and B4 corresponds to the newly created entry. In FIG. 45, when ◯ is given for a certain function of the fusion machine 101, this means that a usage right is given for the function, and when ◯ is not given for a certain function of the fusion machine 101, this means that no usage right is given for the function.

FIG. 45, B1 corresponds to a list obtained when ‘ohtani’ is designated on the entry creating page 1821E. The usage limitation information of the entry 1 of FIG. 45, B1 thus takes over from the usage limitation information of the entry 1 of FIG. 45, A, i.e., ‘ohtani’ as it is.

FIG. 45, B2 corresponds to a list obtained when ‘ohtayo@r.co.jp’ is designated on the entry creating page 1821E. The usage limitation information of the entry 1 of FIG. 45, B2 thus takes over from the usage limitation information of the entry 3 of FIG. 45, A, i.e., the entry of ‘ohtayo@r.co.jp’.

FIG. 45, B3 corresponds to a list obtained when ‘combine both’ is designated on the entry creating page 1821E. The usage limitation information of the entry 1 of FIG. 45, B3 thus takes over from the usage limitation information of both the entry 1 of FIG. 45, A, i.e., the entry of ‘ohtani’ and the usage limitation information of the entry 3 of FIG. 45, A, i.e., the entry of ‘ohtayo@r.co.jp’, in a combined manner.

FIG. 45, B4 corresponds to a list obtained when ‘separate both’ is designated on the entry creating page 1821E. The usage limitation information of the entry 1 of FIG. 45, B3 thus takes over from the usage limitation information of both the entry 1 of FIG. 45, A, i.e., ‘ohtani’ and the usage limitation information of the entry 3 of FIG. 45, A, i.e., ‘ohtayo@r.co.jp’, in a separate manner in this case as shown. That is, in this case, the usage limitation information of each of the entries still exists in the original state.

A third entry creating page according to the second embodiment of the present invention is described next.

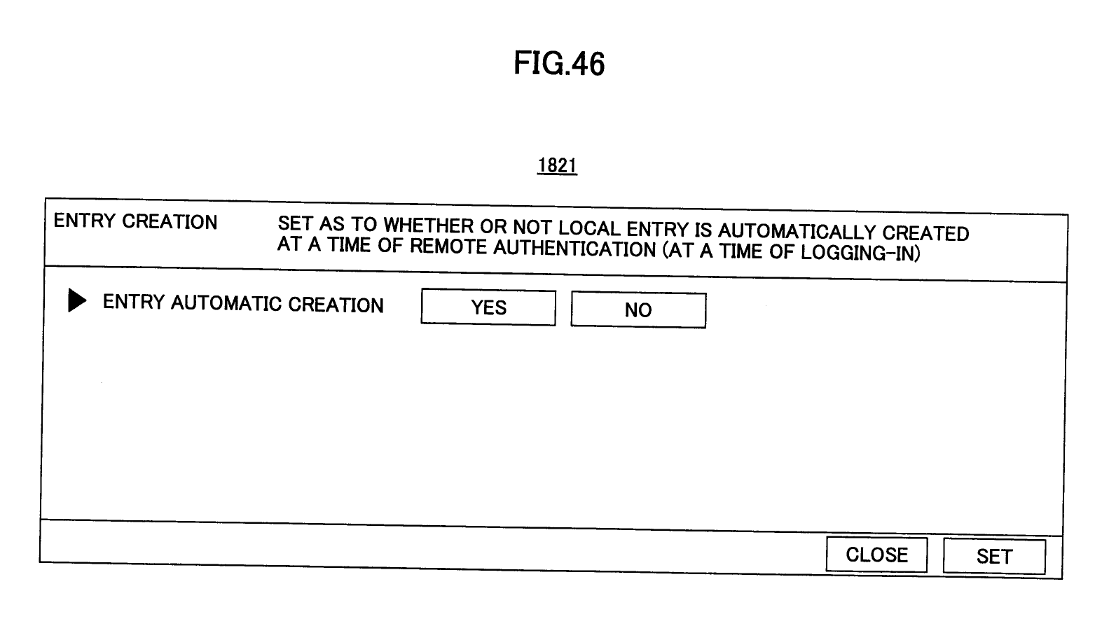

FIG. 46 shows an entry creating page 1821 for creating an entry (empty entry) of FIG. 38. With the use of the entry creating page 1821 of FIG. 46, a setting that an entry in which a plurality of types or authentication information are stored is automatically created is made, for the purpose of automatically creating the entry for storing a plurality of types of authentication information for a user who uses the fusion machine 101 together. The SCS 169 has a function of providing the entry creating page 1821, and the UCS 168 has a function of creating the entry itself for storing the plurality of types of authentication information for a user who uses the fusion machine 101. The entry creating page 1821 shown in FIG. 46 is displayed on the touch panel 311, and setting operation with the use of this page is achieved with finger touch operation on the touch panel 311 or such.

The entry creating page 1821 of FIG. 46 is an inputting page on which inputting is made as to whether or not an entry for storing authentication information for a user who uses the fusion machine 101 should be automatically created. When a ‘Yes’ button is touched on this page, and also, a ‘set’ button is touched on the page, a setting that an entry for storing authentication information for a user who uses the fusion machine 101 is automatically created is registered in the fusion machine 101.

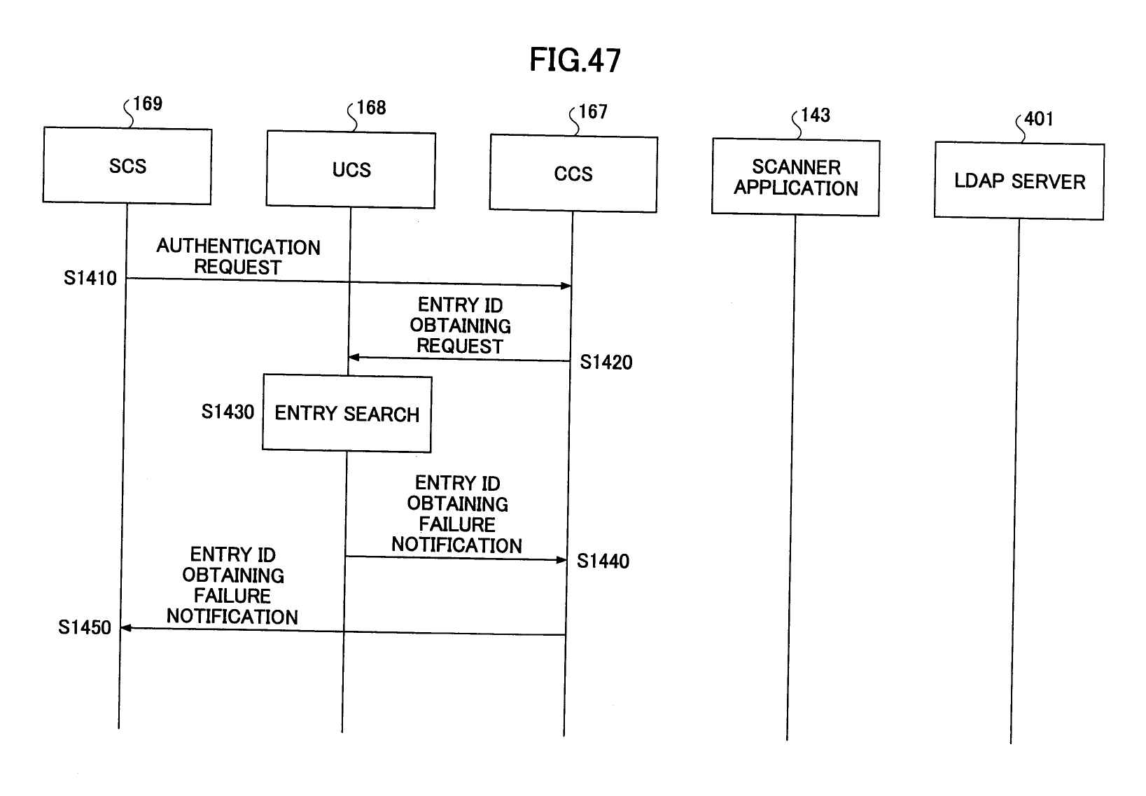

FIG. 47 shows a sequence diagram concerning authentication processing for a user who uses the fusion machine 101 in a further another example. Here, it is assumed that the setting on the authentication setting page 1801 of FIG. 36 is a setting for the local authentication.

When a user who uses the fusion machine 101 inputs local authentication information in the fusion machine 101 for the purpose to log-in in the fusion machine 101, an authentication request is transmitted to the CCS 167 from the SCS 169 (S1410). In response thereto, the CCS 167 transmits an entry ID obtaining request to the UCS 168 (S1420). In response thereto, the UCS 168 carries out entry search for obtaining an entry ID of an entry storing the local authentication information (S1430). Here, it is assumed that the entry storing the local authentication information is not held in the fusion machine 101. As a result, an entry ID obtaining failure notification is transmitted from the UCS 168 to the CCS 167 (S1440). In response thereto, the CCS 167 transmits an entry ID obtaining failure notification to the SCS 169 (S1450).

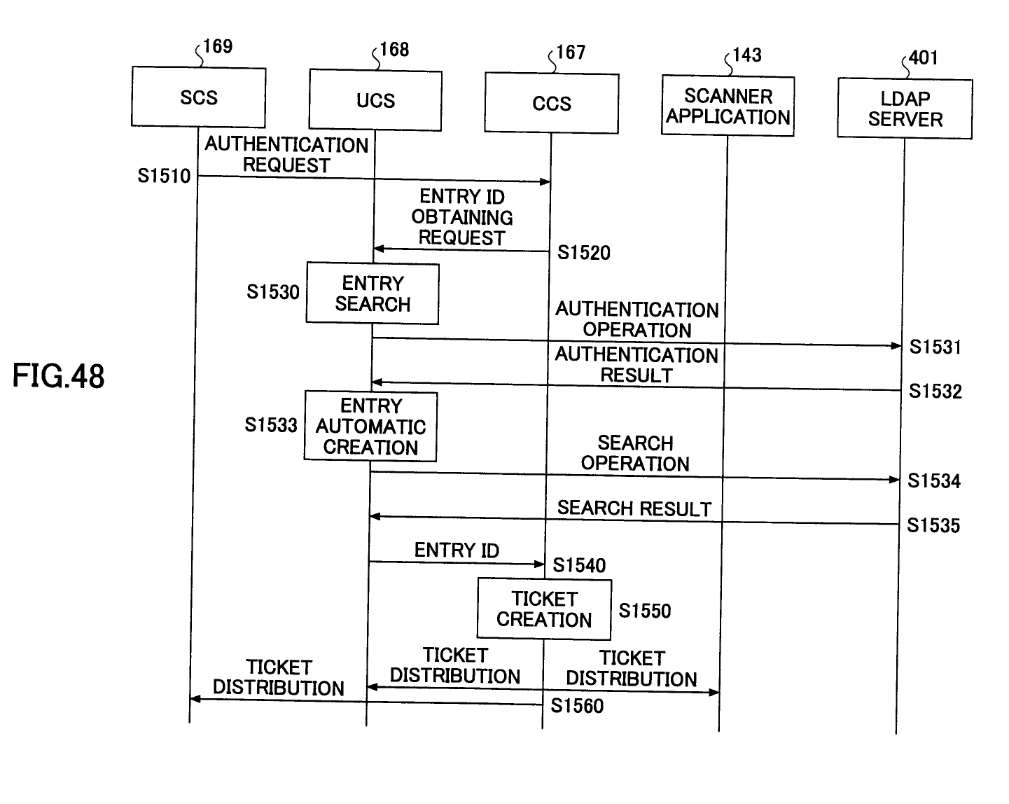

FIG. 48 shows a sequence diagram concerning authentication processing for a user who uses the fusion machine 101 in a further another example. Here, it is assumed that the setting on the authentication setting page 1801 of FIG. 36 is a setting for the LDAP authentication.

When a user input LDAP authentication information in the fusion machine 101 for the purpose of logging-in in the fusion machine 101, the SCS 169 transmits an authentication request to the CCS 167 (S1510). In response thereto, the CCS 167 transmits an entry ID obtaining request to the UCS 168 (S1520). In response thereto, the UCS 168 carries out entry search for obtaining an entry ID of an entry storing the local authentication information which is the same as the LDAP authentication information (S1530). Here, it is assumed that an entry storing the local authentication information the same as the LDAP authentication information is not held in the fusion machine 101. In this case, the UCS 168 requests the LDAP server 401 to cause it to carry out authentication operation with the use of the LDAP authentication information (S1531). In response thereto, the LDAP server 401 returns an authentications result concerning the LDAP authentication information (S1532). In this case, based on the setting registered on the entry creating page 1821 of FIG. 46 mentioned above, the UCS 168 automatically creates an entry for storing a plurality of types of authentication information for the user (S1533). Then, the UCS 168 requests the LDAP server 401 to cause it to carry out search operation (S1534). In response thereto, the LDAP server 401 returns a search result to the UCS 168 (S1535). In response thereto, the UCS 168 stores the thus-obtained authentication information in the thus-created entry, and then, provides an entry ID to the CCS 167 (S1540) when the authentication result thus obtained indicates that the authentication is passed. In response thereto, the CCS creates a ticket for each function of the fusion machine 101, and dispatch it (S1550 and S1560).

Thus, in the fusion machine 101, upon NT authentication or LDAP authentication (upon logging-in), an entry is automatically created based on a setting registered on the entry creating page 1821 of FIG. 46. In the thus-automatically-created entry, NT authentication information or LDAP authentication information is stored. However, in this entry, mail information, usage limitation information, accounting information and so forth are left in a not stored state. In the automatically-created entry, the NT authentication information or the LDAP authentication information is stored not only as NT authentication information or LDAP authentication information but also as local authentication information. Thereby, local authentication for the user is allowed to be carried out.

FIG. 49 shows a sequence diagram concerning authentication processing for a user who uses the fusion machine 101 in further another example. Here, it is assumed that the setting on the authentication setting page 1801 of FIG. 36 is a setting for the LDAP authentication.

When a user inputs LDAP authentication information in the fusion machine 101 for the purpose of logging-in in the fusion machine 101, the SCS 169 transmits an authentication request to the CCS 167 (S1610). In response thereto, the CCS 167 transmits an entry ID obtaining request to the UCS 168 (S1620). In response thereto, the UCS 168 carries out entry search for obtaining an entry ID of an entry storing local authentication information the same as the LDAP authentication information (S1630). Here, it is assumed that the local authentication information the same as the LDAP authentication information is held in the fusion machine 101 in this case. In this case, the UCS 168 requests the LDAP server 401 to cause it to carry out authentication operation concerning the LDAP authentication information (S1631). In response thereto, the LDAP server 401 returns an authentication result concerning the LDAP authentication information (S1632). In this case, the UCS 168 does not carry out automatic entry creation since the local authentication information the same as the LDAP authentication information is held in the fusion machine 101 as mentioned above. Then, the UCS 168 requests the LDAP server 401 to cause it to carry out search operation (S1634). In response thereto, the LDAP server 401 returns a search result to the UCS 168 (S1635). In response thereto, the UCS 168 provides an entry ID to the CCS 167 when the authentication result indicates that the authentication is passed (S1640). In response thereto, the CCS creates a ticket for each function of the fusion machine 101, and dispatch it (S1650 and S1660).

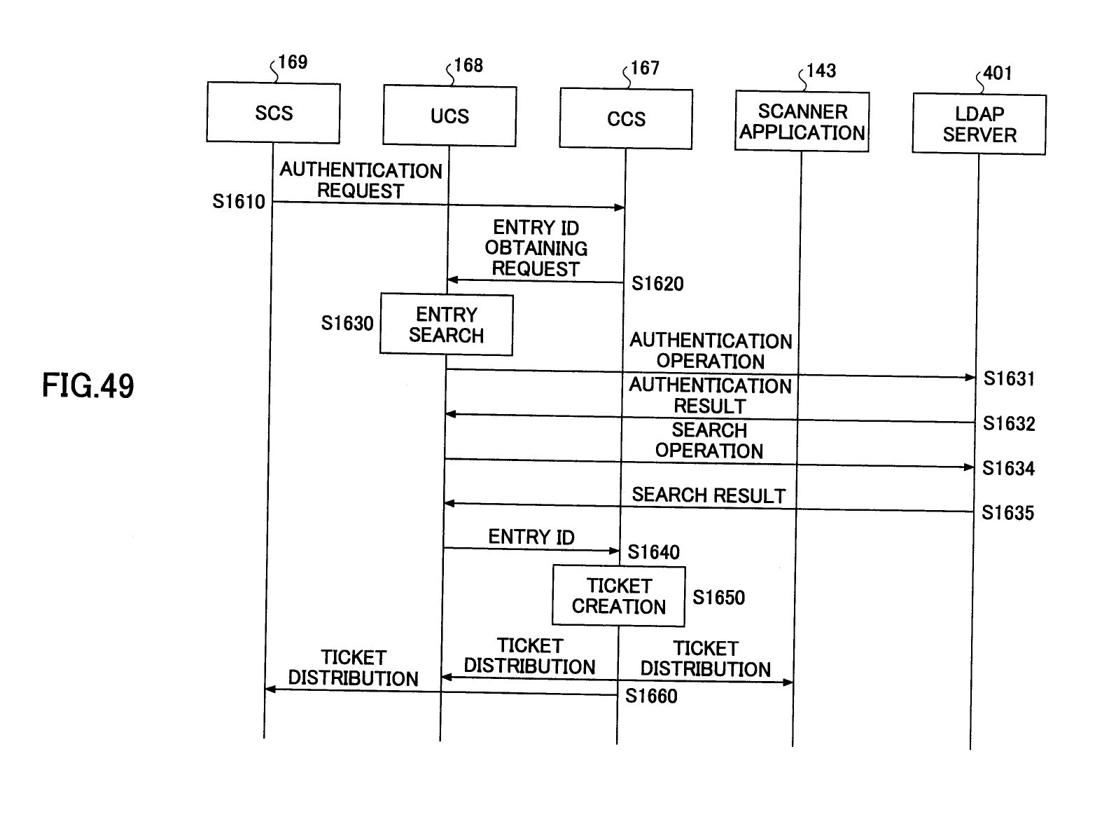

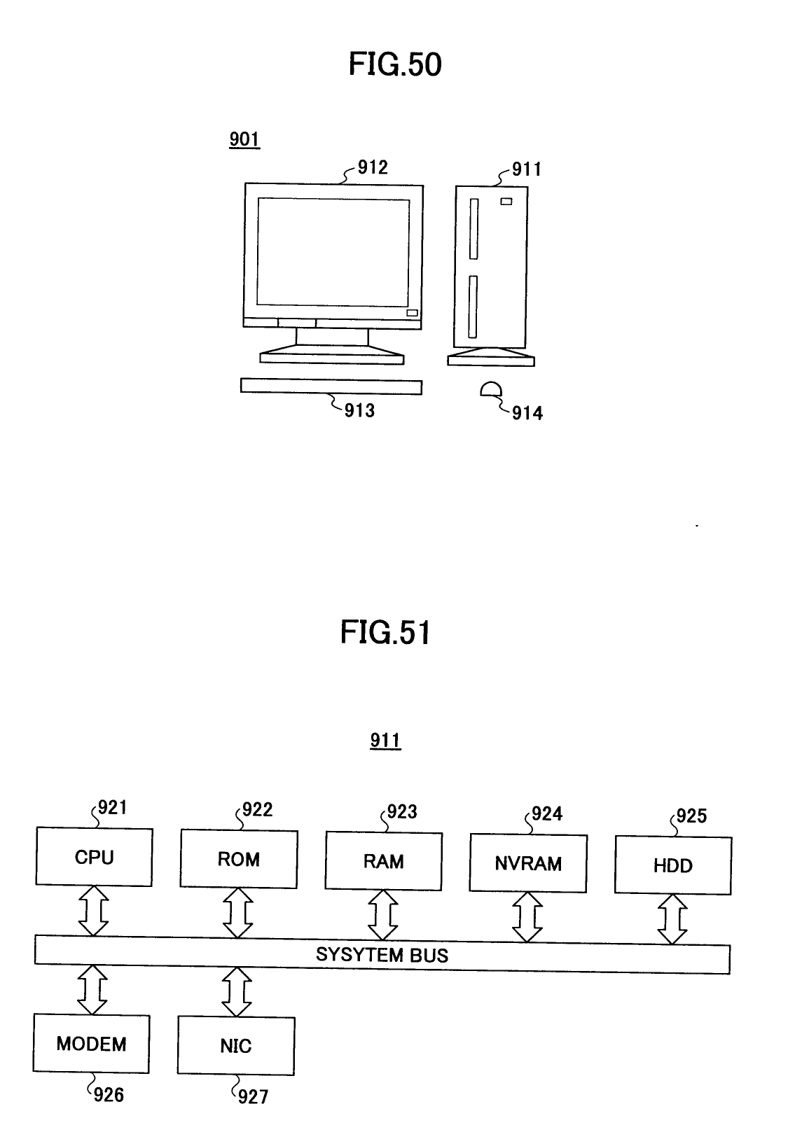

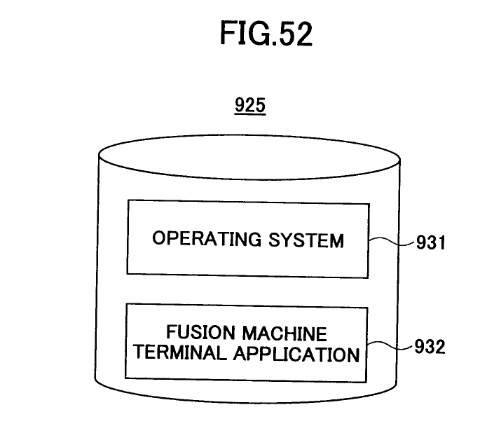

FIG. 50 shows a PC (personal computer) 901 according to an embodiment of the present invention. This PC 901 includes a PC body 911, a display device 912, a keyboard 913, a mouse 914 and so forth. The PC body 911 includes, as shown in FIG. 51, a CPU 921, a ROM 922, a RAM 923, an NVRAM 924, an HDD 925, a MODEM 926, a NIC 927 and so forth. In the HDD 925, as shown in FIG. 52, an operating system 931 and a fusion machine terminal application 232 and so forth are installed.

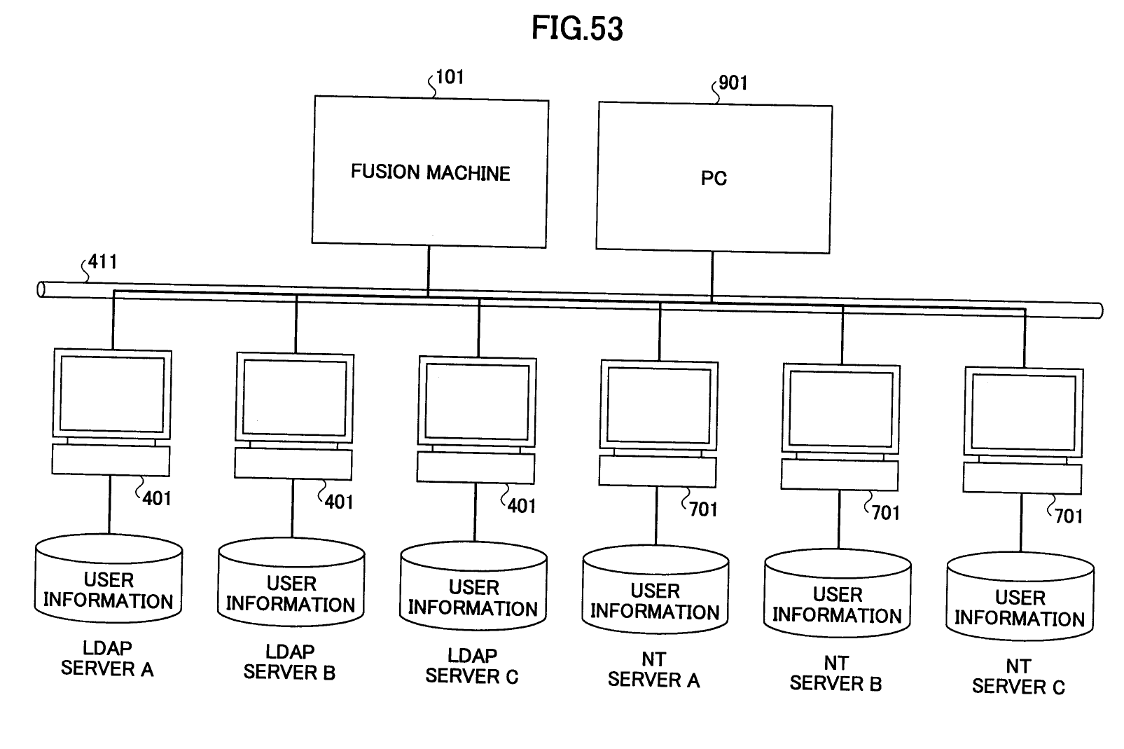

As shown in FIG. 53, the fusion machine 101 of FIG. 1 and the PC 901 of FIG. 50 are connected with three LDAP servers (LDAP servers A, B and C) via a communication network 411, and act as clients (LDAP clients) thereof. Similarly, the fusion machine 101 and the PC 901 of FIG. 50 are connected with three NT servers (NT servers A, B and C) via a communication network 411, and act as clients (NT clients) thereof, as shown. Also the fusion machine 101 of FIG. 1 and the PC 901 of FIG. 50 are mutually connected via the communication network 411.

Based on the above-mentioned description, the fusion machine terminal application 932 is described. The fusion machine terminal application 932 is an application for causing the PC 901 to act as a terminal of the fusion machine 101, and acts as the SCS 169 of the fusion machine 101. That is, the application 932 provides functions of providing the authentication setting page 1801 of FIG. 36, and the entry creating pages 1821 shown in FIGS. 39, 43 and 46. The authentication setting page 1801 or the entry creating pages 1821 are displayed on the display device 912, and setting operations on the authentication setting page 1801 or the entry creating pages 1821 are achieved with the mouse 914 or the keyboard 913.

In the PC 901 shown in FIG. 50, when the button 1811 is clicked and the set button is clicked on the authentication setting page 1801 of FIG. 36, a setting that authentication of a user who uses the fusion machine 101 is carried out by the fusion machine 101 itself, is made in the fusion machine 101.

Similarly, in the PC 901 shown in FIG. 50, when the button 1812 is clicked and the set button is clicked on the authentication setting page 1801 of FIG. 36, a setting that authentication of a user who uses the fusion machine 101 is caused to be carried out by the NT server 701 is made in the fusion machine 101.

Similarly, in the PC 901 shown in FIG. 50, when the button 1813 is clicked and the set button is clicked on the authentication setting page 1801 of FIG. 36, a setting that authentication of a user who uses the fusion machine 101 is caused to be carried out by the LDAP server 401 is made in the fusion machine 101.

When local authentication information, NT attention information and LDAP authentication information are designated on the designating lines 1831, 1832 and 1833 of the entry creating page 1821 of FIG. 39, respectively, and the set button is clicked thereon in the PC 901 of FIG. 50, an entry in which the local authentication information, the NT authentication information and the LDAP authentication information thus designated are stored on the respective lines 1831, 1832 and 1833 is created.

When, entries are designed on the entry creating page 1821A and the entry creating page 1821B of FIG. 43 respectively, and then, the set button on the entry creating page 1821E of FIG. 43 is clicked in the PC 901 of FIG. 50, the entries thus designed on the entry creating page 1821A and the entry creating page 1821B of FIG. 43 respectively are combined together, and an entry in which local authentication information of the former entry and the LDAP authentication information of the latter entry are stored is created in the fusion machine 101.

When the Yes button is clicked and the set button is clicked on the entry creating page 1821 of FIG. 46 in the PC 901 of FIG. 50, a setting that an entry is automatically created for storing user authentication information for a user who uses the fusion machine 101 is registered in the fusion machine 101.

Also concerning the present invention according to the twenty-first through the fiftieth aspects of the present invention, the fusion machine 101 shown in FIG. 1 corresponds to an information processing apparatus as one embodiment of the present invention, and information processing carried out by the fusion machine 101 of FIG. 1 corresponds to an information processing method as another embodiment of the present invention. A computer program for causing a computer to carry out the information processing corresponds to an information processing program in further another embodiment of the present invention. A CD-ROM in which the computer program is recorded corresponds to an information recording medium according to further another embodiment of the present invention.

Similarly, the PC 901 of FIG. 50 corresponds to an information processing apparatus as one embodiment of the present invention, and information processing carried out by the PC 901 corresponds to an information processing method as another embodiment of the present invention. The fusion machine terminal application 932 of FIG. 52 corresponds to an information processing program in further another embodiment of the present invention. A CD-ROM in which the fusion machine terminal application 932 is recorded corresponds to an information recording medium according to further another embodiment of the present invention.

Further, the present invention is not limited to the above-described embodiments, and variations and modifications may be made without departing from the basic concept of the present invention claimed below.

What is claimed is:

1. An information processing apparatus comprising:
a registration page providing part providing a registration page for registering a setting such as to automatically create an entry for storing therein a plurality of types of authentication information for a user who uses said information processing apparatus; and
an entry creating part automatically creating the entry for storing therein the plurality of types of authentication information for the user who uses said information processing apparatus, based on the setting registered on said registration page.

2. The information processing apparatus as claimed in claim 1, wherein:
in the entry created by said entry creating part, accounting information of said user is stored.

3. The information processing apparatus as claimed in claim 1, wherein:
in the entry created by said entry creating part, usage limitation information for said user is stored.

4. The information processing apparatus as claimed in claim 1, wherein:
in the entry created by said entry creating part, an authentication result for said user obtained as a result of authentication processing being carried out based on said authentication information is stored.

5. The information processing apparatus as claimed in claim 4, wherein:
when execution of authentication processing for said user to be carried out based on the authentication information is not allowed, it is determined whether or not authentication of the user is passed, based on authentication result of authentication processing having been carried out for the user.

6. The information processing apparatus as claimed in claim 1, wherein:
a configuration is provided such that, when the user who uses said information processing apparatus logs-in in the apparatus, a specific one from among the plurality of types of authentication information stored in the entry concerning said user should be input to said information processing apparatus without regard to which one of the plurality of authentication information stored in the entry concerning the user is applied for authentication processing for the user.

7. The information processing apparatus as claimed in claim 1, wherein:
in the entry created by said entry creating part, as the plurality of types of authentication information, at least authentication information applied when said information processing apparatus carries out authentication processing for the user and authentication information applied when said information processing apparatus causes a server to carry out authentication processing for the user are stored.

8. The information processing apparatus as claimed in claim 1, wherein:
in the entry created by said entry creating part, as the plurality of types of authentication information, at least authentication information applied when said information processing apparatus causes a first server to carry out authentication processing for the user and authentication information applied when said information processing apparatus causes a second server different from said first server to carry out authentication processing for the user are stored.

9. The information processing apparatus as claimed in claim 1, comprising an image forming apparatus.

10. An information processing method comprising:
a registration page providing step of providing a registration page for registering a setting such as to automatically create an entry for storing therein a plurality of types of authentication information for a user who uses said information processing apparatus; and
an entry creating step of automatically creating the entry for storing therein the plurality of types of authentication information for the user who uses said information processing apparatus, based on the setting registered in said registration page.

11. The information processing method as claimed in claim 10, wherein:
when the user who uses said information processing apparatus logs-in in the apparatus, a specific one from among the plurality of types of authentication information stored in the entry concerning said user should be input to said information processing apparatus without regard to which one of the plurality of authentication information stored in the entry concerning the user is applied for authentication processing for the user.

12. The information processing method as claimed in claim 10, wherein:
said information processing apparatus comprises an image forming apparatus.

13. An information processing program comprising instructions for causing a computer to execute the respective steps of the information processing method claimed in claim 10.

14. A computer readable information recording medium storing therein the information processing program claimed in claim 13.

15. A terminal apparatus acting as terminal of an information processing apparatus comprising:
a registration page providing part providing a registration page for registering a setting such as to automatically create an entry for storing therein a plurality of types of authentication information for a user who uses said information processing apparatus, wherein:
said terminal apparatus causes the entry to be automatically created in said information processing apparatus, for storing therein the plurality of types of authentication information for the user who uses said information processing apparatus, based on the setting registered in said registration page.

16. The terminal apparatus as claimed in claim 15, wherein:
said information processing apparatus comprises an image forming apparatus.

17. An information processing method execute by a terminal apparatus acting as terminal of an information processing apparatus, comprising:
a registration page providing step of providing a registration page for registering a setting such as to automatically create an entry for storing therein a plurality of types of authentication information for a user who uses said information processing apparatus, wherein:
said terminal apparatus causes the entry to be automatically created in said information processing apparatus, for storing therein the plurality of types of authentication information for the user who uses said information processing apparatus, based on the setting registered in said registration page.

18. The information processing method as claimed in claim 17, wherein:
said information processing apparatus comprises an image forming apparatus.

19. An information processing program comprising instructions for causing a computer to execute the respective steps of the information processing method claimed in claim 17.

20. A computer readable information recording medium storing therein the information processing program claimed in claim 19.
